(19) United States
(12) Patent Application Publication
(10) Pub. No.: US 2013/0185147 A1
(43) Pub. Date: Jul. 18, 2013

(54) Inferred Dynamic Offers Subject To Mobile Device Holder Location

(71) Applicants: Claudia Violeta Letca, Redmond, WA (US); Simona Predescu, Sammamish, WA (US)

(72) Inventors: Claudia Violeta Letca, Redmond, WA (US); Simona Predescu, Sammamish, WA (US)

(21) Appl. No.: 13/728,999

(22) Filed: Dec. 27, 2012

Related U.S. Application Data
(60) Provisional application No. 61/582,250, filed on Dec. 31, 2011.

(51) Int. Cl. G06Q 30/02

(52) U.S. Cl. CPC G06Q 30/0241
USPC 705/14.47; 705/14.4

(57) ABSTRACT

Systems, apparatus and methods that give selling actors the abilities and means to sell products and services by providing inferred dynamic offers to buying actors subject to buying actors locations.

Systems, apparatus and methods that give selling actors the abilities and means to acquire information from the environment in the proximity of mobile device holders and use this information to generate inferred dynamic offers.

Systems, apparatus and methods that give selling actors the abilities to infer dynamic offers subject of information received from mobile device holders and location.

### CROSS-REFERENCE TO RELATED APPLICATIONS

This application claims the benefit of U.S. Patent Provisional Application Ser. No. 61/582,250 filed 00:18:19 Eastern Time on 2011 Dec. 31 by present inventors, which is incorporated herein by reference.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The present invention is in the technical field of information technology. More particularly, the present invention is in the technical field of e-commerce. More particularly, the present invention is in the technical field of mobile e-commerce.

### BRIEF SUMMARY OF THE INVENTION

A computer implemented method that gives selling actors the ability to sell products and services by providing dynamic offers to buying actors subject to buying actors locations. The computer implemented method of present invention gives selling actors the ability to acquire information from the environment in the proximity of mobile device holders and use this information.

A server that has the means to sell products and services by providing dynamic offers to buying actors subject to buying actors locations and buying actors interests. A server that has the means to acquire information from the environment in the proximity of mobile device holders.

It should be appreciated that the above-described subject matter may be implemented as a computer-controlled apparatus, a computer process, a computing system, or as an article of manufacture such as a computer-readable medium. Those and various other features will be apparent from reading the following “Detailed Description Of The Invention” and a review of the associated drawings.

This “Summary Of The Invention” is provided to introduce a selection of concepts in a simplified form that are further described below in the “Detailed Description Of The Invention”. This “Summary Of The Invention” is not intended to identify key features or essential features of the claimed subject matter, nor is it intended that this “Summary Of The Invention” be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

In the order that the manner in which the features and advantages of the invention are obtained, a more particular description of the invention will be rendered by reference to specific embodiments thereof which are illustrated in the appended drawings.

Understanding that the drawings depict only typical embodiments of the invention and are not therefore to be considered limiting of its scope, the invention will be described with additional specificity and detail through the use of the accompanying drawings in which:

FIG. 1 is a schematic view illustrating aspects of an exemplary process of interaction between a buying actor and a selling actor of the present invention;

FIG. 2 is a schematic view illustrating aspects of an exemplary process of configuring the selling actor of the present invention;

FIG. 3 is a schematic view illustrating aspects of an exemplary process of generating dynamic offers of present invention;

FIG. 4 is a schematic view illustrating aspects of an exemplary process of presenting dynamic offers of present invention;

FIG. 5 is a schematic view illustrating aspects of an exemplary process of calculating analytics of present invention;

FIG. 6 is a schematic view illustrating aspects of an exemplary process of ranking dynamic offers of present invention;

FIG. 7 is a schematic view illustrating aspects of an exemplary process of completing transactions online of present invention;

FIG. 8 is a schematic view illustrating aspects of an exemplary process of selling products and services part of direct dynamic offers of present invention;

FIG. 9 is a schematic view illustrating aspects of an exemplary process of acquiring proximity acquired information of present invention;

FIG. 10 is a schematic view illustrating aspects of an exemplary process of calculating a trust score for proximity acquired information of present invention;

FIG. 11 is a schematic view illustrating aspects of an exemplary process of asking for digital proof of present invention;

FIG. 12 is a schematic view illustrating aspects of an exemplary process of validating proximity acquired information of present invention;

FIG. 13 is a schematic view illustrating aspects of an exemplary process of selling products and services part of direct notification dynamic offers of present invention;

FIG. 14 is a schematic view illustrating aspects of an exemplary process of selling products and services part of indirect dynamic offers of present invention;

FIG. 15 is a schematic view illustrating aspects of an exemplary process of selling products and services part of indirect notification dynamic offers of present invention;

FIG. 16 is a schematic view illustrating aspects of an exemplary process of selling products and services part of inferred dynamic offers of present invention;

FIG. 17 is a schematic view illustrating aspects of an exemplary process of a selling actor interfacing with 3^{rd} party selling actors of present invention;

FIG. 18 is a schematic view illustrating aspects of an exemplary process of a selling actor interfacing with 3^{rd} party selling actors of present invention;

FIG. 19 is a schematic view illustrating aspects of an exemplary process of completing transactions offline of present invention;

FIG. 20 depicts aspects of an exemplary function used to determine price associated with dynamic offers of present invention;

FIG. 21 is a schematic view illustrating aspects of an exemplary process of a selling actor interfacing with 3^{rd} party selling actors of present invention;

FIG. 22 depicts aspects of an exemplary topology of subsystems used by a selling actor of present invention;

FIG. 23 is a schematic view illustrating aspects of an exemplary process of interaction between a buying actor and multiple selling actors;

FIG. 24 is a schematic view illustrating aspects of an exemplary selling actor server of present invention;

FIG. 25 is a flow diagram depicting an exemplary process of generating dynamic offers.

### DETAILED DESCRIPTION OF THE INVENTION

### I. Definitions

The following definitions are used in this document:

Mobile device holder is defined herein as an entity in possession of a mobile device. Mobile devices holder acquires, and transmits and receives information using hardware and software components running on its mobile device.

Buying actor is defined herein as a mobile device holder, interested in buying products, or services.

Selling actor is defined herein as an entity interested in selling information, products or services.

Examples of selling actors include:
wholesale stores;
retail stores;
online stores;
service providers;
entities selling information, data, analytics about locations, mobile device holders, products, services, buying actors, selling actors or byproducts of such information, data and analytics;
entities acquiring information for the purpose of subsequently leveraging it;
entities selling services to buying actors;
entities selling services to other selling actors;
intermediate entities representing directly or indirectly, for example through the means of proxies or other intermediate entities, one or more selling actors
a group of selling actors.

Channeling actor is defined herein as an entity running a computer implemented system that interfaces with buying actors and with one or multiple selling actors. Channeling actor may have the ability to act as a selling actor itself.

The computer implemented system of present invention contains hardware and software components that run on:
Mobile device holder mobile device, referred herein as mobile device holder computer implemented system;
Buying actor system, referred herein as buying actor computer implemented system;
Channeling actor system, referred herein as channeling actor computer implemented system, or as server;
Selling actor system, referred herein as selling actor computer implemented system, or as server.

The terminology “mobile device holder” or “mobile actor” may be used to refer herein to mobile device holder mobile device.

The terminology “buying actor” may be used to refer herein to the buying actor mobile device.

The terminology “selling actor” may be used to refer herein to selling actor computer implemented system, or server.

The terminology “channeling actor” may be used to refer herein to channeling actor computer implemented system, or server.

A buying actor expresses direct interest by contacting a selling actor about a product or service that the buying actor is considering for purchase. The buying actor transmits a set of data comprising: one or more parameters related to products or services, and one or more parameters related to location. This will be referred as buying actor direct interest.

A buying actor expresses indirect interest by predefining conditions used by selling actors to match products or services provided by the selling actors. The buying actor transmits a set of data comprising one or more parameters related to location. This will be referred as buying actor indirect interest.

A buying actor expresses interest to be notified by a selling actor by predefining a set of conditions used by a selling actor to notify the buying actor. This will be referred as buying actor interest to be notified.

Buying actor interest is defined herein as one of the following:
buying actor direct interest;
buying actor's indirect interest;
buying actor interest to be notified.

A selling actor expresses interest by configuring a computer implemented system to present to a buying actor offers to sell products or services. This will be referred herein as selling actor interest.

A basic proximity offer comprises a set of data related to one or more selling actors offers to sell products or services to a buying actor, wherein the set of data comprises information related to price. A basic proximity offer may be generated by taking into consideration information comprising: selling actors interest; buying actor location.

An analytical proximity offer is defined herein as a basic proximity offer that may be generated by taking into consideration information comprising analytics about any subset of the following: buying actors, selling actors, locations, products, services, time.

A proximity offer is defined herein as one of the following:
basic proximity offer;
analytical proximity offer.

A direct dynamic offer is defined herein as a proximity offer that is generated by taking into consideration information comprising: buying actor direct interest, price transmitted by the buying actor.

An inferred dynamic offer is defined herein as a proximity offer that is generated by taking into consideration information comprising buying actor direct interest, where a selling actor may have the ability to infer the product or service price.

An indirect dynamic offer is defined herein as a proximity offer that is generated by taking into consideration information comprising buying actor indirect interest.

A direct notification dynamic offer is herein defined as a proximity offer that is generated by taking into consideration information comprising: buying actor direct interest, buying actor interest to be notified.

An indirect notification dynamic offer is herein defined as a proximity offer that is generated by taking into consideration information comprising: buying actor indirect interest, buying actor interest to be notified.

A dynamic offer is defined herein as one of the following:
direct dynamic offer;
indirect dynamic offer;
inferred dynamic offer;
direct notification dynamic offer;
indirect notification dynamic offer.

Proximity acquired information is defined herein as information acquired by a mobile device holder. In a typical scenario proximity acquired information may be acquired using the mobile device, may be transmitted to a selling actor computer implemented system using the mobile device, and may comprise location and any subset of the following:
buying actor interest, expressed at specified location;
product or service information for a product or service, available at specified location;
pricing information for a product or service, available at specified location;
discounts associated with a product or service, available at specified location;
coupons associated with a product or service, available at specified location;
bundles associated with a product or service, available at specified location;
special offers associated with a product or service, available at specified location;
warranty information associated with a product or service, available at specified location;
shipping information associated with a product or service, available at specified location;
tax information associated with a product or service, available at specified location;
expiration time associated with a product or service or offer, available at specified location;
inventory associated with a product or service, available at specified location;
picture, video or sound recording describing a product, service, available at specified location;
picture or video recording containing image of price sticker describing a product, service, or offer, available at specified location;
information resulted from communication between the mobile device and a chip or device associated with a product or service, at specified location;
availability of a product or service, at specified location.

Basic differentiating factors are defined herein as attributes of dynamic offers determined by selling actor computer implemented system as being different between the dynamic offer and a reference dynamic offer or a reference product or service.

Enhanced factors are defined herein as attributes of a dynamic offer added, deleted or modified by a selling actor computer implemented system.

Differentiating factors are defined herein as a subset of the union of basic differentiating factors and enhanced factors, determined by selling actor computer implemented system.

Analytical differentiating factors are defined herein as a subset of the union of basic differentiating factors and enhanced factors, determined by selling actor computer implemented system using analytics.

Key differentiating factors are defined herein as a subset of the union of differentiating factors and analytical differentiating factors.

### II. Overview

Embodiments in the invention relate to systems, apparatus and methods for using mobile devices to acquire proximity acquired information or to sell products and services through the means of dynamic offers.

Embodiments in the invention relate to systems, apparatus and methods for: transmitting from a device coupled to a communication network to a server: product or service information, price for a product or service, and location; receiving on the device from the server a set of dynamic offers, comprising price information.

Embodiments in the invention relate to systems, apparatus and methods for: predefining conditions to be notified on a mobile device coupled to a communication network; receiving on the mobile device notifications from the server for dynamic offers.

Embodiments in the invention relate to systems, apparatus and methods for: predefining conditions for matching products or services; transmitting from a mobile device coupled to a communication network to a server the location of the mobile device; receiving on the mobile device from the server dynamic offers matching the predefined conditions.

Embodiments in the invention relate to systems, apparatus and methods for: predefining conditions to be notified on a mobile device coupled to a communication network; predefining conditions for matching products or services; receiving on the mobile device notifications from the server for dynamic offers matching the predefined conditions.

Embodiments in the invention relate to systems, apparatus and methods for: transmitting from a mobile device coupled to a communication network to a server: product or service information and location; inferring the price; receiving on the mobile device from the server dynamic offers.

Embodiments in the invention relate to systems, apparatus and methods for: acquiring on a server proximity acquired information from mobile devices coupled to a communication network in exchange to dynamic offers or incentives.

Embodiments in the invention relate to systems, apparatus and methods that give selling actors the abilities and means to adjust dynamically prices for products and services, subject to location, buying actor, time.

Embodiments in the invention relate to systems, apparatus and methods that give selling actors the abilities and means to act on behalf of one or more other selling actors and to interact with one or more selling actors computer implemented systems for the purpose of generating dynamic offers and selling products and services.

In operation, the invention enables a multitude of mobile devices holders to provide proximity acquired information to a server. In operation, the invention enables a multitude of mobile device holders to receive incentives and financial benefits for providing proximity acquired information. In operation, the invention enables a multitude of buying actors using mobile devices to receive dynamic offers. In operation the invention enables one or more selling actors to acquire information about: a multitude of buying actors, a multitude of products and services, a multitude of locations, zero or more competitors. In operation the invention enables one or more selling actors to provide dynamic offers to a multitude of buying actors. In operation the invention enables one or more selling actors to sell products and services to a multitude of buying actors using pricing policies subject to location of buying actors. In operation the invention enables zero or more selling actors acting as channeling actors to channel sales for products of services provided by zero or more selling actors to a multitude of buying actors.

The mobile device holder may have the ability to acquire product or service information: by automatically using its mobile device sensors, hardware and software components; or by manually entering the information into buying actor computer implemented system.

The selling actor computer implemented systems, the channeling actor computer implemented system, as well as any subsystem used by selling actors or channeling actors of present invention could be hosted and run on data centers and infrastructure on owner premises or could be hosted on the data centers, on infrastructure, or in the cloud operated by a 3rd party hosting provider, or any combination of the above mentioned hosting options.

In the spirit of present invention, the buying actors, the selling actors, the channeling actors, the 3^{rd} party selling actors, the internal and external subsystems, may represent themselves directly in their interactions, or may be represented in their interactions by intermediate entities, actors, computer implemented systems and subsystems such as, but not limited to: proxies, gateways, portals, adapter interfaces.

The invention may be practiced in conjunction with a wireless communication network such as a wireless cellular telephone network that includes a plurality of mobile devices, such are wireless telephones that are suitably equipped to establish a connection to and communicate with the network.

It should also be understood that the systems, apparatus, methods, processes, and other arrangements described herein are set forth for purposes of example only, and other arrangements and elements (e.g. machines, interfaces, functions, orders of elements, etc.) can be added or used instead and some elements may be omitted altogether. Further, those skilled in the art will appreciate that many of the elements described herein are functional entities that may be implemented as discrete components or in conjunction with other components, in any suitable combination and location, and by software, firmware or hardware.

Reference will now be made to the drawings to describe various aspects of exemplary embodiments of the invention. It should be understood that the drawings are diagrammatic and schematic representations of such embodiments and, accordingly, are not limiting of the scope of the present invention, nor are the drawings necessarily drawn to scale.

### III. Exemplary Actors and Interactions

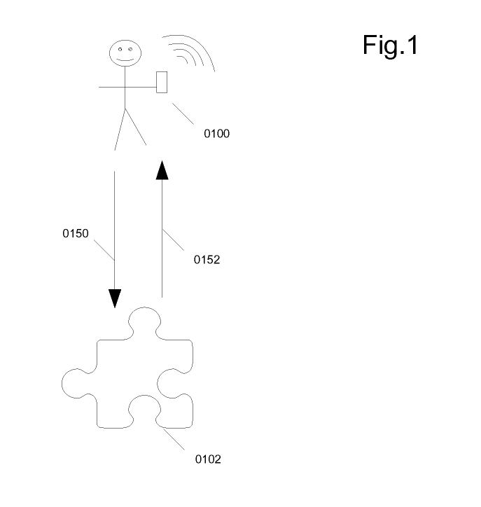

Referring now to the invention in more detail, in FIG. 1 there is shown a view of the exemplary interaction between a selling actor 0102 and a buying actor 0100 of the present invention. The buying actor 0100 transmits 0150 to the selling actor 0102 a set of data comprising one or more parameters related to products or services, one or more parameters related to the products or services price, one or more parameters related to the location. The selling actor 0102 uses the set of data transmitted 0150 by the buying actor 0100 to generate a set of dynamic offers. The buying actor 0100 receives 0152 the set of dynamic offers from the selling actor 0102.

In more detail, still referring to the invention of FIG. 1, the buying actor 0100 computer implemented system running on buying actor 0100 mobile device may have the ability to acquire proximity acquired information and transmit 0150 it to selling actor 0102 computer implemented system. The selling actor 0102 computer implemented system may have the ability to receive the information transmitted 0150 by the buying actor 0100. The price information transmitted 0150 may be related to the price of the products or services in the proximity of the buying actor 0100, or it may be related with the price that the buying actor 0100 is willing to pay. The selling actor 0102 may have the ability to use internal or external subsystems to process the information, and generate a set of dynamic offers. The set of dynamic offers are received 0152 by the buying actor 0100 computer implemented system running on the mobile device. Dynamic offers received 0152 by the buying actor 0100 may comprise information about the exact products or services transmitted 0150 by the buying actor 0100. Dynamic offers received 0152 by the buying actor 0100 may comprise information about products or services related to information transmitted 0150 by the buying actor 0100. Dynamic offers received 0152 by the buying actor 0100 may comprise a mix of dynamic offers comprising information about the exact product or service and dynamic offers comprising information about related products or services.

In further detail, still referring to the invention of FIG. 1, the selling actor 0102 may have the ability to interact with one or more buying actors and the buying actor 0100 may have the ability to interact with one or more selling actors. The selling actor 0102 may have the ability to interact with zero or more selling actors and exchange information. Selling actors may interact with each other in any suitable topology such as a single node, a tree or a connected graph. The selling actor 0102 may use the information exchanged with other selling actors together with information transmitted 0150 by one or more buying actors to generate one or more dynamic offers. The buying actor 0100 may use software or hardware components running on its mobile device to transmit 0150 the data set to the selling actor 0102 and to receive 0152 the dynamic offer from selling actor 0102. The selling actor 0102 may use software or hardware components to: receive the transmitted 0150 information, generate the dynamic offers and transmit to the buying actor 0100 the dynamic offers. Components of the selling actor 0102 computer implemented system may run on any suitable hosting platforms such as selling actor premises, private cloud, data centers, public cloud providers, 3rd party hosted platforms or a mix of such platforms. Each component may run on a different hosting platform.

As an example, still referring to the invention of FIG. 1, the selling actor 0102 computer implemented subsystems could be but are not restricted to cloud services, web services, functions, methods, procedures, services, database, entities, and program components. The components and subsystems of the selling actor computer implemented system may run as user mode or kernel software on any suitable operating system or platform, or any mix of suitable operating systems, or platforms, such as: Windows, Linux, Unix, VMS, iOS, Windows Azure, Amazon Cloud EC2, App Engine, RightScale, Force.com, Heroku, including virtualized operating systems and any suitable platforms and operating systems developed in future. Examples of buying actor 0100 mobile devices could be, but are not restricted to, smart-phones, tablets, laptops, slates, telephony-enabled personal digital assistants (PDA), electronic readers, portable game devices or consoles, wireless devices, wireless telephones, cellular telephones, pagers, portable PCs, portable media players, dedicated hardware chips or devices, wireless enabled photo cameras or camcorders, wireless car systems, intelligent cars, smart wristwatches, GPS devices, marine radio devices, two-way radios coupled to a communication network, and any other suitable devices, including those that will be developed in the future, having ability to couple with a communication network. Buying actor 0100 mobile device may permit execution of software such as an operating system and applications. A variety of operating systems known in the art, such as Symbian, iOS, Android, Windows Mobile, Windows Phone, Meego, webOS, KindleOS, or any other suitable operating system may reside on the mobile device. Typical buying actor 0100 mobile devices include transmitter and receiver, display device, power supply. Selling actor 0102 computer implemented system may communicate with multiple buying actors at the same time, for example by using a client server computing model well known in the art, with the selling actor 0102 computer implemented system acting as a server, and the buying actors' computer implemented systems as clients. Any other architecture that is suitable for the communication between the selling actor 0102 and the buying actor 0100 can be used, for example a web service architecture well known in the art can be used on any of the known styles, such as: remote procedure calls (RPC), service oriented architecture (SOA), or representational state transfer (REST).

Still referring to the invention of FIG. 1, an example of communication networks on which buying actor 0100 computer implemented systems are coupled could be, but are not restricted to, cell phone Data Connections, Radio, RF, CDMA, GSM, UMTS, TDMA, WCDMA, GPRS, WiFi, 802.11, any other suitable communication networks, including those that will be developed in the future. The methods of this invention could be used in conjunction with a packet data network, with a circuit-switched network or both. The transport protocol could be IP based, or any other transport available to the buying actor, such as Short Message Service (SMS), or Short Data Burst services that are well known in the art. There is no requirement that all nodes in the network are wireless. It should be noted that in some embodiments the methods of the invention may be implemented using network nodes other than wireless devices, including wire line devices or hardwired devices, where same data is exchanged between the actors.

In further detail, still referring to the invention of FIG. 1, for example, the buying actor 0100 computer implemented system, may have the ability to automatically acquire or transmit proximity acquired information, such as product or service information using sensors, hardware, firmware and software components: for location detection, such as, but not limited to, components supporting GPS, A-GPS; for image capturing, such as, but not limited to, photo camera, camcorder; for audio capturing; for short distance communication to devices and chips in the environment, such as, but not limited to: NFC chip, Bluetooth, WiFi, Data wireless, communication components; for long distance communication; such as, but not limited to, components supporting: Data Connection, Radio, RF, CDMA, GSM, UMTS, TDMA, WCDMA, GPRS, WiFi, 802.11; or using any other suitable sensors, hardware, firmware and software components including those that will be developed in the future.

In further detail, still referring to the invention of FIG. 1, while the schematic view illustrates aspects of an exemplary process of the present invention in which the selling actor 0102 generates a direct dynamic offer that the buying actor 0100 receives 0152, the selling actor 0102 is not restricted to generating direct dynamic offers, and buying actor is not restricted to receive 0152 direct dynamic offers. The selling actor may have the ability to generate the entire set or any subset of the following types of dynamic offers: direct dynamic offers, direct notification dynamic offers, indirect dynamic offers, indirect notification dynamic offers, inferred dynamic offers. The selling actor 0102 may also have the ability to acquire proximity acquired information from mobile device holders, and the selling actor 0102 may have the ability to use proximity acquired information in the process of generating dynamic offers.

In further detail, still referring to the invention of FIG. 1, the information transmitted 0150 by the buying actor 0100 to the selling actor 0102 and the information received 0152 by the buying actor 0100 from the selling actor 0102, may be transferred between the actors using any suitable methodology or technology, including push technology, pull technology, and the communication may be initiated by any of the actors. The ability to use any suitable methodology or technology, such as pull and push technology, may apply to communication between any actors, between any subsystems, and between any actors and subsystems of present invention.

In further detail, still referring to the invention of FIG. 1, the selling actor 0102 may have the ability to sell products, the selling actor 0102 may have the ability to sell services, the selling actor may have the ability to sell both products and services. The products or services that the selling actor 0102 might sell, may be sold on its own behalf or on behalf of 3^{rd} party selling actors that may interface directly or indirectly with the selling actor 0102.

In further detail, still referring to the invention of FIG. 1, the information received 0152 may comprise one or more attributes related to price, such as exact price, a set of prices, recurring payment information, discount percentage, instructions from the selling actor 0102 to the buying actor 0100 on how to construct a price, a code allowing the buying actor 0100 to receive price related information. In some exemplary embodiments the one or more attributes related to price may be the only information received by the buying actor 0100, and the buying actor may be able to infer the rest of the dynamic offer attributes. In some exemplary embodiments the buying actor 0100 may receive 0152 multiple dynamic offers, and each dynamic offer may be associated with one or more attributes related to price and one or more attributes not related to price, such as product color, product size, product brand, service duration. In some embodiments the buying actor 0100 may receive 0152 multiple pricing options associated with a dynamic offer, and the buying actor 0100 may have the ability to choose the most suitable one, for example one time payment, or multiple micro-payments, or recurring payments.

In further detail, still referring to the invention of FIG. 1, in some embodiments, the buying actor 0100 may have the ability to receive 0152 the dynamic offer from a 3^{rd} party selling actor, for example in a topology in which the selling actor 0102 interfaces directly or indirectly with the 3^{rd} party selling actor, or in a scenario in which the selling actor 0102 generated a dynamic offer on behalf of the 3^{rd} party selling actor.

In further detail, still referring to the invention of FIG. 1, examples of mobile devices used by the buying actor 0100 may be smartphone such as iPhone, Windows Phone 7, Windows Phone 8, Samsung Galaxy, Motorola Droid, smart TVs such as Samsung, LG, tablets such as iPad, Surface, Asus Transformer, Nook, Kindle, notebooks, laptops, ultrabooks, radio enabled GPS, smart-car or smart-vehicle computer device, or any other suitable device or computer implemented system.

In further detail, still referring to the invention of FIG. 1, the communication between the selling actor 0102 and the buying actor 0100 can use for example a web service architecture well known in the art leveraging SOA architecture, REST, ODATA, Web API, mobile services and cloud services.

### IV. Exemplary Channeling Topology

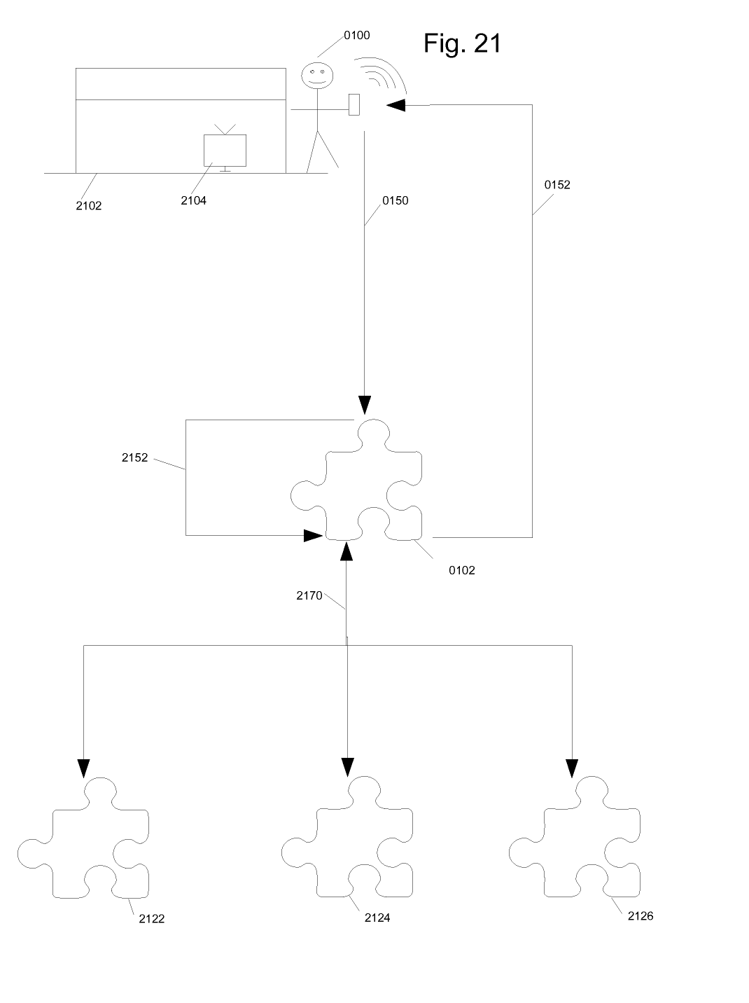

Referring now to the invention in more detail, in FIG. 21 there is shown an exemplary view of the interaction between the selling actor 0102 acting as channeling actor for 3^{rd} party selling actors 2122 2124 2126, and a buying actor 0100. The buying actor 0100 is located in the proximity of a selling actor physical shop 2102. The buying actor 0100 expresses direct interest in a product or service 2104 offered by the selling actor physical shop 2102 by acquiring information about the product or service 2104 with its mobile device and transmitting it 0150 to the selling actor 0102. The selling actor 0102 acting as channeling actor receives the information about the product or service 2104, including the product or service 2104 price, as well as information about the location of the buying actor 0100 or location of the product or service 2104. The selling actor 0102 acting as channeling actor may have the ability to generate 2152 a set of dynamic offers that buying actor 0100 may receive 0152. The entire set or a subset of the set of dynamic offers generated 2152 by the selling actor 0102 acting as channeling actor may be the result of interfacing 2170 between the selling actor 0102 acting as channeling actor and the 3^{rd} party selling actors 2122 2124 2126.

In more detail, still referring to the invention of FIG. 21, the buying actor 0100 computer implemented system running on buying actor 0100 mobile device may have the ability to acquire proximity acquired information and transmit 0150 it to selling actor 0102 computer implemented system through a communication network. The selling actor 0102 computer implemented system may have the ability to receive the information transmitted 0150 by the buying actor 0100. The selling actor 0102 acting as channeling actor may have the ability to use internal or external subsystems, functions, methods, procedures, services, database or entities to transform the information transmitted 0150 by the buying actor 0100, to generate 2152 a set of dynamic offers, and to modify the set of dynamic offers. The buying actor 0100 may receive 0152 the entire set or a subset of generated dynamic offers.

In further detail, still referring to the invention of FIG. 21, the buying actor 0100 computer implemented system may have the ability to automatically acquire proximity information such as location of buying actor 0100, product or service 2104 information, product or service 2104 pricing. In the process of generating 2152 the set of dynamic offers, the selling actor 0102 may use zero or more subsystems. The selling actor 0102 computer implemented system may have the ability to use subsystems or services that will map the buying actor 0100 location to the location of the selling actor physical shop 2102. The selling actor 0102 computer implemented system may have the ability to use subsystems or services that will assign a trust score to the information transmitted 0150 by the buying actor 0100. The selling actor 0102 computer implemented system may have the ability to use subsystems or services that identify and provide details about the product or service 2104 that the buying actor 0100 expressed interest in. The selling actor 0102 computer implemented system may have the ability to use subsystems or services that may return products or services related with the product or service 2104 that the buying actor 0100 expressed interest on. The selling actor 0102 computer implemented system may have the ability to use subsystems and services that provide analytical information about the buying actor 0100, about the buying actor 0100 location, about the selling actor physical shop 2102, about the product or service 2104 that the buying actor 0100 expressed direct interest on. The selling actor 0102 acting as channeling actor may have the ability to act as a selling actor itself and based on its existing configuration may allow buying actor 0100 to receive 0154 a set with any number or dynamic offers generated on its own behalf. The set of dynamic offers received 0154 by the buying actor 0100 may contain additional metadata, such as ranking information, information used to highlight key differentiating factors, tokens that would allow the buying actor 0100 or the selling actor 0102 to identify the dynamic offers, time frames and expiration deadlines. For each of the dynamic offers in the set the buying actor 0100 or the selling actor 0102 may also identify properties describing the abilities to close transactions associated with the dynamic offers in online or offline mode.

As an example, still referring to invention of FIG. 21, a selling actor physical shop 2102 “ACME TV SHOP”, offers for sale a product or service 2104 “ABCTV 299 $”. A buying actor 0100 located in the selling actor 0102 physical shop 2102, express direct interest in the product or service 2104 by transmitting 0150 to the selling actor 0102 acting as channeling actor information such as, buying actor 0100 location “45 N 23 E”, product or service 2104 information “ABCTV”, including product or service 2104 price “299 $”. The selling actor 0102 acting as channeling actor, converts and transforms the information by using internal and external subsystems, services, functions, procedures, methods, mappings and databases, and obtains additional knowledge. For example such knowledge may be: “Location: at ACME TV SHOP” or “Buying actor estimated motivation: value driven”, “Related products or service: ZFG TV, DFG TV”. The selling actor 0102 acting as channeling actor accesses configuration provided by 3^{rd} party selling actor 2122 though a configuration based interfacing 2170 between 3^{rd} party selling actor 2122 and the selling actor 0102 acting as channeling actor to generate 2152 a subset of dynamic offers that may match buying actor 0100 directly expressed interest. The selling actor 0102 acting as channeling actor interfaces 2170 dynamically with other 3^{rd} party selling actors 2124 2126 to generate 2152 another subset of the dynamic offers that match buying actor 0100 directly expressed interest. The selling actor 0102 acting as channeling actor, modifies, ranks and filters the dynamic offers that may match buying actor 0100 directly expressed interest and computes a set of dynamic offers “ABCTV 299$ w/extra warranty, ABCTV 275$, ZFG TV 350$ w/picture in picture, DFG TV 260 $, Sound System Extension for ABCTV 99$” that the buying actor 0100 receives 0154.

Continuing to referring to the invention of FIG. 21, there is shown a view of the exemplary interfacing 2170 between the selling actor 0102 acting as channeling actor and 3^{rd} party selling actors 2122 2124 2126. The 3^{rd} party selling actors 2122 2124 2126 have the ability to register with the selling actor 0102 acting as channeling actor. Subsequently the selling actors 2102 2204 2206 have the ability to interface 2170 with the selling actor 0102 acting as channeling actor and dynamically respond to selling opportunities. There are no restrictions with regard to the number of 3rd party selling actors 2122 2124 2126 that can interface 2170 with the selling actor 0102 acting as channeling actor. Since the selling actor 0102 acting as channeling actor may have the ability to act as a selling actor itself, the method and process of present invention may allow the selling actor 0102 acting as channeling actor to interface 2170 with zero or more 3^{rd} party selling actors 2122 2124 2126.

In more detail, referring to the invention of FIG. 21, the 3^{rd} party selling actors 2122 2124 2126 may have the ability to configure their own computer implemented system or the selling actor 0102 computer implemented system to generate dynamic offers on their behalf by defining templates, defining policies, implementing interfaces, such as, but not restricted to: cloud applications, web services, TCPIP based protocols. The selling actor 0102 acting as channeling actor may have also the ability to generate dynamic offers by interfacing 2170 dynamically as result of the buying actor 0100 expressed interest with 3^{rd} party selling actors 2122 2124 2126, through the means of interfaces such as cloud applications, web services, TCPIP based protocols. Such interfaces maybe used by the selling actor 0102 acting as channeling actor to delegate parts of the process of generating dynamic offers and selling products and services to the 3^{rd} party selling actors.

In further detail, referring to the invention of FIG. 21, for example, the selling actor 0102 acting as channeling actor may have the ability to use existing configuration provided by zero or more 3^{rd} party selling actors 2122 2124 2126 to generate a subset of the dynamic offers on behalf of 3^{rd} party selling actors, and may have the ability to communicate dynamically through one or more interfaces with zero or more 3^{rd} party selling actors 2122 2124 2126 and delegate to them part of the process to generate another subset of dynamic offers in response to the buying actor 0100 transmitted 0150 information. The selling actor 0102 channeling actor may also generate a subset of dynamic offers on its own behalf. The selling actor 0102 acting as channeling actor may have also the ability to modify this set of generated dynamic offers before the buying actor 0100 receives 0152 the set of dynamic offers, for example by adding and removing dynamic offers from the set, or by adding, removing and altering attributes and price information associated with the dynamic offers.

In further detail, referring to the invention of FIG. 21, the templates, policies, and implementation for the interfaces used by the 3^{rd} party selling actors 2122 2124 2126 to interface 2170 with the selling actor 0102 acting as channeling actor are not restricted to be hosted by a particular computer implemented system. For example the templates, policies and implementation for the interfaces used to interface 2170 between 3^{rd} party selling actors 2122 2124 2126 and selling actor 0102 acting as channeling actor can be part of 3^{rd} party selling actor 2122 2124 2126 computer implemented systems, or may be hosted by selling actor 0102 acting as channeling actor own selling actor computer implemented system, or may be part of any data center including 3^{rd} party selling actors 2122 2124 2126 own data centers, or may be part of selling actor 0102 data center, or may be part of an external party data center or computer implemented system, or may be hosted in a cloud, or may be software implemented, or may be part of a database, or may be implemented using dedicated hardware, or may be part of any other suitable computer implemented system.

In further detail, still referring to the invention of FIG. 21, the selling actor 0102 acting as channeling actor may interface 2170 with the 3^{rd} party selling actors 2122 2124 2126 directly or through intermediate proxy systems. The interfacing 2170 between the selling actor 0102 acting as channeling actor and 3^{rd} party selling actors 2122 2124 2126 is not limited to exemplary configuration method and to the exemplary delegation method. Other suitable methods of interfacing may be used, such as, but not restricted to: selling actor 0102 discovering information published by 3^{rd} party selling actors, selling actor and 3^{rd} party selling actors accessing a shared information service, gateway or portal, or interfacing through intermediate non-selling actor entities. In the exemplary embodiment described by the FIG. 21, the selling actor 0102 acting as a channeling actor and the 3^{rd} party selling actors 2122 2124 2126 are shown in a tree topology or star topology, this example should not be limiting the invention, as its spirit allows any suitable topology to be used, including single node, graph, ring, fully connected graphs, mesh, point to point, line, bus, extended star, snowflake, daisy chain, hybrid, or any other topology that would connect selling actors allowing them to generate dynamic offers on behalf of other selling actors. In some embodiments and topologies multiple selling actors may have the means and abilities to directly connect to buying actors and to act as channeling actors for other selling actors. In some embodiments the selling actor 0102 acting as a channeling actor and the 3^{rd} party selling actors may interface 2170 directly with each other or may interface through intermediate entities such as proxy services, interface adapter services, gateways, portals, or any other suitable mechanisms In some embodiments the buying actor 0100 may transmit 0150 to the selling actor 0102 the information indirectly through intermediate entities, such as proxy services, interface adapter services, gateways, portals, or any other suitable mechanisms. In some embodiments the buying actor 0100 may receive 0152 from the selling actor 0102 dynamic offers indirectly through intermediate entities, such as proxy services, interface adapter services, gateways, portals, or any other suitable mechanisms.

In further detail, still referring to the invention of FIG. 21, the interfacing 2170 may be manual, automatic, or a mix of those modes. For example a 3^{rd} party selling actor 2122 may manually configure parts of the process of generating dynamic offers of selling actor 0102 acting as channeling actor and may automatically configure other parts of the selling actor 0102 acting as channeling actor processes. The 3^{rd} party selling actor 2122 may automatically be delegated by the selling actor 0102 acting as channeling actor for executing parts of the process of generating dynamic offers. The manual interfacing 2170 may be implemented for example through paper and legal contracts without any need for physical network connections, or through a portal or a web site provided by the selling actor 0102 acting as channeling actor that the 3^{rd} party selling actors 2122 2124 2126 may use. The automatic interfacing 2170 may be implemented though a communication network, such as LAN, WAN, internet, coupled to the selling actor 0102 computer implemented systems and coupled to the 3^{rd} party selling actors 2122 2124 2126 computer implemented systems. The interfacing 2170 between the selling actor 0102 acting as channeling actor and the 3^{rd} party selling actors 2122 2124 2126 may be implemented directly or indirectly through any number or proxies, including for example proxy computer implemented systems such as configuration portals, proxy entities representing selling actor 0102 acting as channeling actor or representing 3^{rd} party selling actors 2122 2124 2126 such as companies providing generic configuration services. The steps of transmitting 0150 information and receiving 0152 dynamic offers may occur directly between buying actor 0100 and selling actor 0102, or may occur indirectly, for example through intermediate services that may provide the buying actor 0100 with additional services such as anonymity service, or intermediate services that adapt the interfaces required by the buying actor 0100 to transmit information to the selling actor 0100, or portal or gateway services that act as a hub and may provide load balancing or partitioning for the buying actor 0100 interactions across one or more selling actors, or any other suitable entity that can intermediate the communication between buying actor 0100 and selling actor 0102.

Still referring to the invention of FIG. 21, the following scenario may be used as an example to understand the interaction between buying actor 0100, the selling actor 0102 acting as a channeling actor, 3^{rd} party selling actors 2122 2124 2126, telling actor physical shop 2102:
A buying actor 0100 arrives in proximity of a selling actor physical shop 2102, for example ACME TV SHOP.
The selling actor physical shop 2102 offers for sale products or services 2104 at that particular location, for example ABC TV bundled with a MOVIOFLIX subscription for a price of 299 $.
The buying actor 0100 uses a mobile device and gathers information such as but not restricted to, location, product info, product code, information from pricing sticker for the product or service 2104 that selling actor physical shop 2102 is offering for sale.
The buying actor 0100 uses mobile device to contact the selling actor 0102 acting as channeling actor, transmitting 0150 the info acquired with the mobile device.
The selling actor 0102 computer implemented system or process receives the information transmitted 0150 by the buying actor 0100.
The selling actor 0102 acting as channeling actor interfaces 2170 in an automated fashion with 3^{rd} party selling actors 2122 2124 2126
The selling actor 0102 computer implemented system may generate 2152 a set of dynamic offers based on the information transmitted 0150 by the buying actor 0100 mobile device, as well as based on information about products or services offered by 3^{rd} party selling actors 2122 2124 2126. For example a 3rd party selling actor 2122 MY-e-TV-SHOP that interfaces 2170 with the selling actor 0102 acting as channeling actor may have defined templates, or policies, or implemented interfaces that allow the selling actor 2122 to offer TVs in the area covering buying actor 0100 location. Hence the set of dynamic offers that may be received 0152 by the buying actor 0100 may eventually include TV-s that the 3^{rd} party selling actor 2122 MY-e-TV-SHOP offers to sell.
The content of the set of dynamic offers, the ranking of dynamic offers within the set, as well as specifics of each dynamic offer in the set may be dynamically generated 2152 by the selling actor 0102 acting as channeling actor based on its internal algorithms and strategies as well as based on the templates and policies set by 3rd party selling actors 2122 2124 2126 that interface 2170 with the selling actor 0102 acting as channeling actor.
The set of the dynamic offers is received 0152 by the buying actor 0100 from the selling actor 0102 acting as channeling actor and presented on the buying actor 0100 mobile device. For example, the set of dynamic offers received 0152 by the buying actor 0100 may contain multiple dynamic offers: “ABC TV, price 299 $ with extra warranty”, “ABC TV, price 275 $”, “ZFG TV, price 350 $, with picture in picture”, “DFG TV, price 260 $”, “10% off any PG13 sci-fi movie”, “ABC TV, price 299 $ bundled with 12 month discounted MOVIEOFLIX subscription), “Sound System Extension for ABC TV-s, price 99 $”
The buying actor 0100 evaluates the set of dynamic offers and may have the ability to select offers that are compelling from the received 0152 dynamic offers.
The buying actor 0100 may have the ability to purchase the products or services associated with the dynamic offer, either immediately interacting via its mobile device with the selling actor 0102 computer implemented system. The buying actor 0100 also may have the ability to obtain a token or coupon that would allow him to purchase the products or services associated with the dynamic offers within a specified time frame. The buying actor 0100 may have the ability to use the token or coupon to purchase the products or services either by directly interacting with selling actor 0102 computer implemented system. The buying actor 0100 may have the ability to use the token or coupon to purchase the products and services associated with a dynamic offer in the physical location associated with a selling actor 2122 2124 2126 or with the selling actor 0102 acting as channeling actor. For example the buying actor 0100 may to use the token or coupon to purchase a product or service at the location of a physical shop associated with one of the 3^{rd} party selling actors 2122 2124 2126.

In further detail, still referring to the invention of FIG. 21, the pricing information associated by the selling actor 0102 with a dynamic offer may be associated with a one-time payment, or with a reoccurring payment, such as a monthly payment, or may be different if the buying actor 0100 closes the transaction online, or may be different if the buying actor 0100 closes the transaction offline, or may be function of various parameters associated with the purchase, or may be expressed in a currency, or it may be expressed in terms of discounts, or may be fixed, or may be variable, or may be function of the timeframe on which the buying actor 0100 closes the transaction. The price information related to the received 0152 dynamic offers may be expressed in terms of one time payment, micro-payments multiple recurring payments, loyalty points, virtual currency, discounts, functions or instructions that would allow a price to be constructed, codes that would allow a price to be retrieved at a subsequent time, or any other suitable means. The group of selling actors 0102 2122 2124 2126 may be a selling actor itself, and the buying actor may perceive the group as one selling actor.

In further detail, still referring to the invention of FIG. 21, a selling actor, such as the selling actor 0102, providing directly or indirectly services to other selling actors may receive from other the selling actors financial benefits in exchange for the services provided. The financial benefits, such as, but not restricted to flat payments, percentage of sale price, percentage of profit, subscription fees, etc, may be used by the selling actors regardless of the services provided, regardless of the way selling actors interact with each other (direct or indirect, automatic or manual), and regardless of the topology that includes the selling actors.

### V. Exemplary Embodiment for Channeling Topology

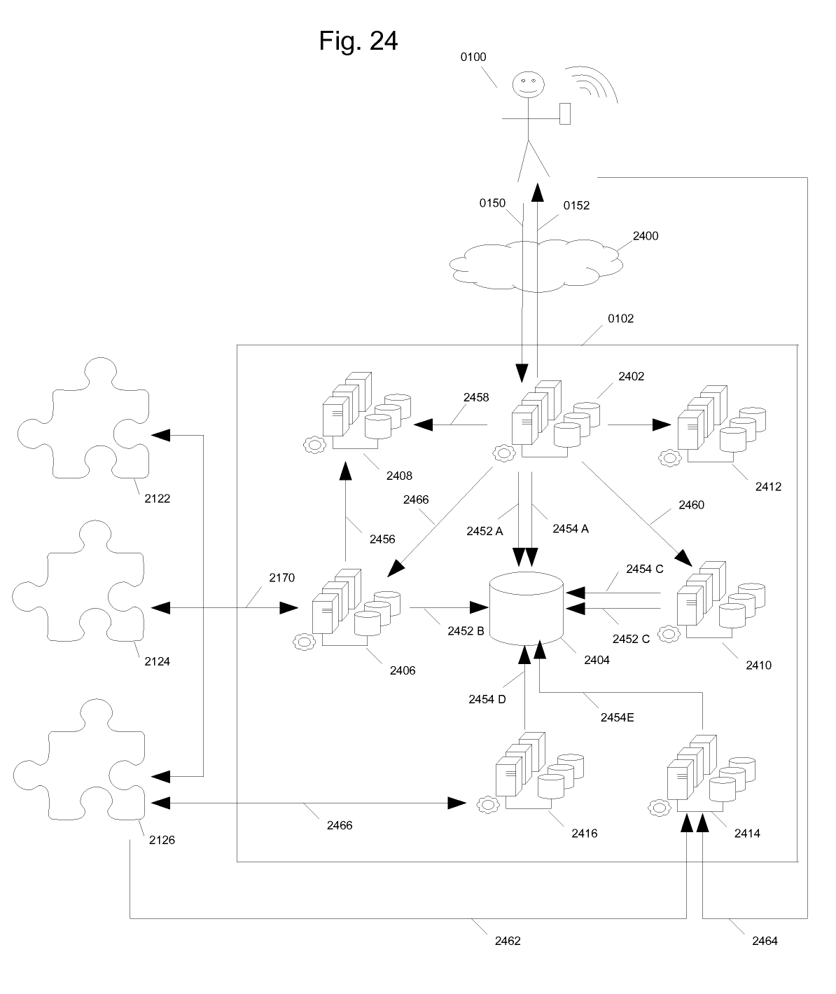

Referring now to the invention in more detail, in FIG. 24, as an exemplary embodiment, the buying actor 0100 has the means to acquire proximity acquired information by using a buying actor computer implemented system comprising a device such as a smartphone mobile device. In the exemplary embodiment, the smartphone mobile device has the means to acquire proximity acquired information by having a suitable general purpose operating system and suitable hardware sensors. In the exemplary embodiment, the buying actor 0100 acquires proximity acquired information, such as location, product identification, product price, by the means of a mobile software application running on the mobile device general purpose operating system, and accessing services provided by the general purpose operating system that abstract the hardware and provide information such as GPS and virtual keyboard input. In the exemplary embodiment the buying actor is using a smartphone mobile device, however other embodiments may use any other suitable device that has the ability to couple with a communication network 2400. Example of suitable general purpose operating systems that may be used by the device are Symbian, iOS, Android, WP7, known in the art, however the invention is not limited to those operating systems, and in some embodiments the device may implement the invention by using preconfigured hardware or firmware, and may be implemented without using an application layer or an operating system.

In more detail, still referring to the invention of FIG. 24, in the exemplary embodiment, the buying actor 0100 has the means to transmit 0150 the proximity acquired information to a server by having the smartphone mobile device coupled to a communications network 2400, such as a CDMA, whereas the invention can be practiced with other wireless networks, including Global System for Mobile Communications (GSM), Universal Mobile Telecommunications System (UMTS), Time Division Multiple Access (TDMA), Wideband Code Division Multiple Access (WCDMA), General Packet Radio Service (GPRS) networks as well as hardwired networks such as LAN, WAN, Ethernet, or any mix of such networks. More specifically in the exemplary embodiment, the communication network 2400 includes a radio frequency (RF) network that provides radio connectivity and session management for circuit-switched and packet data technology-based communication. In the exemplary embodiment, the smartphone mobile device has the means of transmitting 0150 proximity acquired information, using the communications network 2400 and a transport protocol such as Internet Protocol (IP), while other embodiments may use other transport protocols such as short message service (SMS), HTTP, or Short Data Burst known in the art.

In further detail, still referring to the invention of FIG. 24, in the exemplary embodiment, a server, representing a selling actor 0102 has the means to use web services and cloud services hosted in any suitable cloud environment, such as Windows Azure, EC2, Google Apps, which are well known in the art. The server, representing the selling actor 0102, has the means to use web services by being implemented as a set of computer hardware running on a general purpose operating system such as Windows, Linux, OSX, Windows Azure, and configuring a general processor part of the computer hardware to execute software instructions, such as instructions part of network protocol stack, that result in transmitting and receiving information over a communication network.

In further detail, still referring to the invention of FIG. 24, in the exemplary embodiment, a server, representing a selling actor 0102 and being part of selling actor 0102 computer implemented system, coupled directly or indirectly to the communication network 2400 has the means to receive the proximity acquired information transmitted 0150 by the buying actor 0100, by running for example on a general purpose computer hardware or on a virtual machine, hosted on a general purpose computer hardware, a general purpose operating system that has the means to use a transport protocol such as Internet Protocol (IP) being used by the operating system through the means of an Ethernet card. In the exemplary embodiment, the buying actor 0100 computer implemented system running on the smartphone mobile device has the means for communicating with the server representing the selling actor 0102 at an application level layer, for example by transmitting 0150 the proximity acquired information to the selling actor 0102 server through a web service, Dynamic Offer Generator Web Service (DOGWS 2402), method of communication, well know in the art. The process of physically transmitting 0150 the set of data happens in the exemplary embodiment, on the mobile actor 0100 smartphone mobile device, through the means of transmitter and receiver hardware components associated with the smartphone's radio hardware. The process of physically receiving the set of data transmitted 0150 happens in the exemplary embodiment, on the selling actor 0102 computer implemented system, through the means of an Ethernet card, part of selling actor 0102 computer implemented system hardware, coupled to the communication network. While the exemplary embodiment of the invention uses a web service DOGWS 2402 as method of communication, the methods of the invention may be implemented using any other suitable method of communication. While the exemplary embodiment of the invention uses a general purpose operating system and a general purpose computer hardware, the methods of the invention may be implemented using different embodiments, including distributed platform using a data center with multiple computer hardware systems and a mix of multiple operating systems. In our exemplary embodiment, the web service may run as an application using non-virtualized hardware and Windows operating system well known in the art, however any other suitable operating systems may be used such as, Windows Azure, Unix, Linux.

In further detail, still referring to the invention of FIG. 24, in the exemplary embodiment, the server representing the selling actor 0102, has the means to receive through the web service DOGWS 2402 interface, the proximity acquired information, transmitted 0150 by the buying actor 0100 mobile device. At a physical layer, in the exemplary embodiment, the information transmitted 0150 by the mobile actor 0100, is received by the selling actor 0102 computer implemented system though a physical Ethernet card, coupled directly or indirectly with the communication network 2400. In different embodiments, the selling actor 0102 may use any other suitable physical means for receiving the set of data transmitted 0150 by the buying actor 0100, such as WiFi cards or Radio hardware. In the exemplary embodiment, the web service DOGWS 2402 used by the selling actor 0102 server provides the selling actor 0102 server means to communicate with one or more mobile devices coupled to the communication network 2400. In the exemplary embodiment, the web service DOGWS 2402 used by the selling actor 0102 server to communicate with the buying actor 0100 mobile device has the means to use the proximity acquired information, including the location, product identification, product price to generate 2152 dynamic offers, for example by having the web service DOGWS 2402 configure through software instructions a general purpose microprocessor, parts of selling actor 0102 server hardware, to generate 2152 dynamic offers. In the exemplary embodiment, in order to generate the dynamic offers, the exemplary web service DOGWS 2402 may use configuration, analytics and may have the ability to delegate part of the execution to 3^{rd} party selling actors computer implemented systems. However the exemplary embodiment should not be used to limit this invention, as for example other embodiments may use a different means. An example of different means may be a TCPIP or PHP server known in the art using SSL protocol, running on a Linux operating system and using a simple implementation that configures a general purpose microprocessor to: check an inventory database such as MySQL for availability and reference pricing of products and services; to compare the price transmitted 0150 by the buying actor 0100 with a reference price; to generate a dynamic offer with the price equal with the average of the buying actor transmitted 0150 price and the reference price, to return a dynamic web page that allows the buying actor 0100 to receive 0152 the dynamic offer if the buying actor 0100 is located in in proximity of a reference location.

In further detail, still referring to the invention of FIG. 24, in the exemplary embodiment, the web service DOGWS 2402 used by the selling actor 0102 server, to generate 2152 dynamic offers, has the means to generate any type of dynamic offers, including direct dynamic offers, indirect dynamic offers, direct notification dynamic offers, indirect notification dynamic offers, inferred dynamic offers, for example by giving access to the general purpose microprocessor to memory stored variables that contain information specific to the dynamic offer such as proximity acquired information or configuration information, which was previously communicated by the buying actor 0100 to the selling actor 0102 server though the communication network 2400. Note that in some embodiments, the configuration information may have been communicated by the buying actor 0100 to the selling actor 0102 though the communication network 2400, using the buying actor 0100 mobile device, or through a different method, such as the buying actor using a desktop computer to setup the configuration prior to the moment when the buying actor 0100 transmitted 0150 information to the selling actor 0102.

In further detail, still referring to the invention of FIG. 24, in the exemplary embodiment, the selling actor 0102 server, has the means to store 2452A and access 2454A stored information previously communicated by buying actors, such as configuration information, by having the web service DOGWS 2402 use subsystems, such as functions, modules, database systems or other web services, that can access a persistent storage 2404 such as a hard drive, SAN drive or solid state disk drive, which are well known in the art. In the exemplary embodiment, the operations to store 2452A 2452B 2452C and access 2454A 2454C 2454D the persistent storage 2404 may be implemented by using a database management system (DBMS) such as Oracle, SQL Server, DB2, MongoDB, MySQL, well known in the art, but different embodiments may use different storage and access methods, such as a dedicated web service that talks with a persistent storage layer or direct file access using operating system or platform API such as Win32, NTFS, UNIX file descriptors, java.io API, .NET isolated storage, Hadoop HDFS API, Windows Azure Storage Services REST API.

In further detail, still referring to the invention of FIG. 24, in the exemplary embodiment, the selling actor 0102 server has means of configuring the method of generating the dynamic offers, by exposing for example through a web service, Seller Interoperability Web Service (SIWS 2406), an interface that 3^{rd} party selling actors 2122 2124 2126 computer implemented systems may call and may provide configuration parameters. The selling actor 0102 server has the means of storing 2452B the configuration parameters received from the 3^{rd} party selling actors 2122 2124 2126 for example by having the SIWS 2406 web service use subsystems, such as functions, modules, database systems known in the art or other web services, that can store 2452B data in the persistent storage 2404. In the exemplary embodiment, the selling actor 0102 server has means of automatically using the configuration to provide dynamic offers, by having the DOGWS 2402 web service that generates 2152 the dynamic offers access 2454A the configuration stored 2452B on the persistent storage 2404, and by having the DOGWS 2402 web service configure a general microprocessor to execute software instructions that take consideration the information stored 2452A 2452B 2452C on the persistent storage 2404. In the exemplary embodiment the DOGWS 2402 web service may access 2454A, the persistent storage 2404 templates stored 2452B by the 3^{rd} party selling actors, via the SIWS 2406 web service. The information associated with the stored 2452B templates may containing XML data describing conditions for generating dynamic offers, such as minimum price, bundles available for a product, geographic area where dynamic offers are valid. Different embodiments may use different means for configuring the selling actor 0102 server and for using the configuration in the process to generate dynamic offers, for example, a different embodiment may register a dedicated dynamic library that the process in charge with generating the dynamic offers, such as DOGWS 2402 web service, may call into during the process of generating dynamic offers. Other embodiments may register an IP address and a service port, that the process in charge with generating the dynamic offers may call using a custom protocol to obtain a set of dynamic offers.

In further detail, still referring to the invention of FIG. 24, in the exemplary embodiment, the selling actor 0102 server has the means to be configured through a configuration that is based on templates for example:
by providing 3^{rd} party selling actors 2122 2124 2126 schema definitions for generic templates using an XML based format known in the art,
and by having the 3^{rd} party selling actors 2122 2124 2126 manually or automatically using the interfaces exposed by the SIWS 2406 web service,
and by having the 3^{rd} party selling actors 2122 2124 2126 describing their configuration using XML files containing data that respects the schema definitions.

In further detail, still referring to the invention of FIG. 24, the selling actor 0102 server has the means to be configured by having a subsystem such as in the exemplary embodiment, the DOGWS 2402 web service configuring a general purpose microprocessor to interpret the content of the XML files containing configuration. In the exemplary embodiment, the DOGWS 2402 web service may use DOM, SAX API, to access the information stored into XML based templates. The DOGWS 2402 web service may use transforms such as XSLT, or custom code, for example C# based, to generate dynamic offers. In different embodiments, the templates may use a custom format, such as a binary format, that can be interpreted by a dedicated subsystem such as SIWS 2406 and the selling actor 0102 may provide dedicated tools, including desktop applications or web based interfaces and dedicated API to 3^{rd} party selling actors 2122 2124 2126 to aid them in the process of authoring the templates.

In further detail, still referring to the invention of FIG. 24, in the exemplary embodiment, the selling actor 0102 server has the means to be configured through a configuration that is based on policies, for example:
by using a rule engine 2408 subsystem, such as the rule engine available in Windows Workflow Foundation (WF) or Java Rule Engine (JSR 94) known in the art;
by having the 3^{rd} party selling actors 2122 2124 2126 define the rules and rules modeling as in the exemplary embodiment via the SIWS 2406 web service;
by having the selling actor 0102 server use the rule engine 2408 subsystem to evaluate dynamically the rules in the process of generating dynamic offers, as in the exemplary embodiment, by having the DOGWS 2402 call dynamically the rule engine 2408 subsystem in the process of generating dynamic offers.

In further detail, still referring to the invention of FIG. 24, in different embodiments, the selling actor 0102 has the means to use a deterministic rule engine 2408 based on a domain specific language to describe and execute the policies set by 3^{rd} party selling actors 2122 2124 2126. In different embodiments, the selling actor 0102 has the means to use a business rule engine, an event driven rules engine or Web Services Business Process Execution Language (WS-BPEL) known in the art.

In further detail, still referring to the invention of FIG. 24, in the exemplary embodiment, the selling actor 0102 server has the means to be configured through a configuration that is based on interfaces, for example by allowing 3^{rd} party selling actors 2122 2124 2126:
to use a configuration web service, such as SIWS 2406,
to register a dynamic library or a web service interface (e.g. SOAP or WSDL) that exposes an interface comprising functions that have the ability to generate dynamic offers

In further detail, still referring to the invention of FIG. 24, in the exemplary embodiment, the selling actor 0102 server has the means to be configured by having the selling actor 0102 server subsystems, for example the DOGWS 2402 web service, call into the interface part of the registered dynamic library used by the process of generating dynamic offers. In different embodiments, the selling actor 0102 server may be configured to use a discovery API, such as .NET or Java reflection API, to locate and invoke during the process of generating dynamic offers, for example from the DOGWS 2402 web service, the interfaces exposed by 3^{rd} party selling actors 2122 2124 2126.

In further detail, still referring to the invention of FIG. 24, in the exemplary embodiment, the selling actor 0102 server has the means to interface 2170 with one or more selling actor computer implemented systems, associated with one or more 3^{rd} party selling actors 2122 2124 2126, for example
by having selling actor 0102 server allowing through the configuration web service SIWS 2406 the 3^{rd} party selling actors 2122 2124 2126 to register their own 3^{rd} party web services that have the ability to generate dynamic offers, such as an equivalent version of the DOGWS 2402 web service implemented by the 3^{rd} party selling actors 2122 2124 2126,
or by having the selling actor 0102 server web service DOGWS 2402 that communicates with the buying actor 0100 calling dynamically into the 3^{rd} party web services during the process of generating dynamic offers, and using the results from the 3^{rd} party web services to construct the set of dynamic offers that will be received 0152 by the buying actor 0100.

In further detail, still referring to the invention of FIG. 24, while in the exemplary embodiment the 3^{rd} party selling actors implement for the purpose of generating dynamic offers web services that are similar with DOGWS 2402, in other embodiments the 3^{rd} party selling actors 2122 2124 2126 may implement different web services, with interfaces dedicated for delegation, or may implement support for generating dynamic offers using different interfacing, potentially without using web services, such as a simple HTTPS base protocol. In some embodiments it is also possible that the selling actor 0102 and the 3^{rd} party selling actors 2122 2124 2126 use mixed API that differs from selling actor to selling actor.

In further detail, still referring to the invention of FIG. 24, in the exemplary embodiment, the selling actor 0102 server has the means to act as a proxy for one or more selling actor 2122 2124 2126 computer implemented systems:
by being coupled with the buying actor 0100 through a communication network 2400,
and being coupled with the 3^{rd} party selling actors through the same or a different communication network.

In further detail, still referring to the invention of FIG. 24, in an exemplary embodiment the DOGWS 2402 web service that receives the information transmitted 0150 by buying actor 0100, may forward it to the 3^{rd} party selling actors 2122 2124 2126, may aggregate or modify the results received from the 3^{rd} party selling actors 2122 2124 2126 and subsequently may return the dynamic offers to the buying actor 0100 that will receive 0152 them. In some embodiments the 3^{rd} party selling actors 2122 2124 2126 may expose same interfaces as the interfaces exposed by the selling actor 0102 server through the DOGWS 2402 web service. However in other embodiments the interfaces exposed by the 3^{rd} party selling actors 2122 2124 2126 may be different and the selling actor 0102 server may need to act as an adapter which is a design pattern known in the art.

In further detail, still referring to the invention of FIG. 24, in the exemplary embodiment, the selling actor 0102 server has the means to modify key differentiating factors for generated dynamic offers modifying one or more key differentiating factors, for example
by having the DOGWS 2402 web service configure a general purpose microprocessor to compare attributes of dynamic offers,
and by having DOGWS 2402 access the key differentiating factors using an analytics subsystem 2410 coupled 2460 with the DOGWS 2402 web service, such as for example an OLAP server know in the art,
and by having DOGWS 2402 configure a general purpose microprocessor to modify attributes of dynamic offers.

In further detail, still referring to the invention of FIG. 24, example of analytics subsystems 2410 may be SQL Server Analysis Services, Mondrian OLAP server, Essbase, SAS OLAP Server or MicroStrategy Intelligence Server. The results of the analytics subsystem 2410 may be obtained by the DOGWS 2402 through API such as XML for Analysis (XMLA), OLEDB for OLAP, MDX, .NET or Java Stored procedure, SQL. Different embodiments may use different analytical subsystems, including Microsoft Analysis Services data mining software, SAS Enterprise Miner, STATISTICA, SPSS Modeler, cloud hosted data mining services, spacial data mining systems, pattern mining systems, custom mathematical and statistical functions, custom algorithms, and custom data mining or OLAP systems, big data processing, Map-Reduce based algorithms, data analysis systems, decision support systems, predictive analytics, web mining systems.

In further detail, still referring to the invention of FIG. 24, in the exemplary embodiment, the selling actor 0102 server has the means to optimize dimensions of dynamic offers:
by having DOGWS 2402 web service access and use analytics from an analytics subsystem 2410, such as an OLAP server or a data mining server,
and by configuring a general purpose microprocessor to generate dynamic offers by taking into consideration information obtained from the analytics subsystem 2410, for example by having DOGWS 2402 web service coupled with the analytics subsystem 2410 use information returned by a predictive analysis algorithm or information such as an analytical Key Performance Indicator (KPI) known in the art, in the process of generating dynamic offers.

In further detail, still referring to the invention of FIG. 24, in the exemplary embodiment, the selling actor 0102 server has the means to complete transactions for dynamic offers online, for example:
by being coupled to a communication network,
and by having DOGWS 2402 web service use a Payment Web Service (PWS 2412) subsystem able to configure a general purpose microprocessor to use a payment API, such as PayPal SOAP API or VISA API.

In further detail, still referring to the invention of FIG. 24, in other embodiments the DOGWS 2402, or a PHP or ASP.NET based web application that interfaces with the buying actor 0102 may directly use the payment API. When completing the transaction, the DOGWS 2402 in the exemplary embodiment, may update an internal sales database, such as a relational database subsystem well known in the art to track the transaction by storing 2452A information related with the sale into the persistent storage 2404. The relational database subsystem may have the ability to store 2452A records into the persistent storage 2404, and is coupled to the DOGWS 2402 web service. Different embodiments may use different means for storing the information associated with the transaction, such as calling into an external web service that updates external sales and inventory databases.

In further detail, still referring to the invention of FIG. 24, in the exemplary embodiment, the selling actor 0102 server has the means to adjust prices associated with dynamic offers, for example:
by having DOGWS 2402 web service use a general purpose database system coupled with a persistent storage 2404 to store 2452A information about buying actors, such as customer loyalty information,
and by having DOGWS 2402 configure a general purpose microprocessor to modify the price related attributes of dynamic offers for the buying actor 0100 based on information retrieved from the general purpose database regarding the buying actor 0100, for example by having DOGWS 2402 use database API to access 2454A the persistent storage 2404.

In further detail, still referring to the invention of FIG. 24, other embodiments may have different means to adjust prices associated with dynamic offers, for example by having the DOGWS 2402 web service or PHP script that generates the dynamic offers always add a commission to the dynamic offers generated on behalf of 3^{rd} party selling actors 2122 2124 2126.

In further detail, still referring to the invention of FIG. 24, in the exemplary embodiment, the selling actor 0102 server has the means to calculate a ranking score for dynamic offers, for example by having DOGWS 2402 configure a general purpose microprocessor to calculate for a dynamic offer a value returned by a function that takes as input information regarding attributes of the dynamic offer, such as brand, price, distance between buying actor 0100 and a physical shop associated with the selling actor on behalf of which the dynamic offer was generated. Alternate ranking scores could be computed, by the DOGWS 2402 or a subsystem used in the process of generating dynamic offers, for example by using a function associated with the likelihood for the buying actor 0100 to accept the dynamic offer, or using a function associated with the potential profit for a dynamic offer.

In further detail, still referring to the invention of FIG. 24, in the exemplary embodiment, the selling actor 0102 server has the means to calculate analytics for dynamic offers, for example:
by having DOGWS 2402 web service use the coupled 2460 analytics subsystem 2410,
and by manually or automatically configuring the analytics subsystem 2410 to construct an analytical model for the dynamic offers,
and by having analytics subsystem 2410 to access 2454C information available in the persistent storage 2404 regarding buying actors and dynamic offers.

In further detail, still referring to the invention of FIG. 24, different embodiments may use different sources of information, including external information exposed by 3^{rd} party selling actors through custom API or web service interfaces. Different embodiments may use different methods of calculating analytics, including custom analytical and statistical functions, cloud hosted analytical services, Map-Reduce algorithms, etc. In the exemplary embodiment the analytical subsystem uses SQL Server Analysis Services that may be manually configured to build a MOLAP, ROLAP, HOLAP, or Tabular Model, and may automatically process data from a relational server such as a DBMS accessing the persistent storage 2404 and calculate analytics.

In further detail, still referring to the invention of FIG. 24, in the exemplary embodiment, the selling actor 0102 server has the means for calculating analytics based on information about buying actor 0100 historical response, for example:
by having DOGWS 2402 web service store 2452A buying actor responses into a general purpose database system coupled with the persistent storage 2404,
and by providing access 2454C to information stored 2452A 2452B 2452C in the general purpose database system to an analytics subsystem 2410, such as a general purpose OLAP server configured to model analytics regarding buying actor responses.

In further detail, still referring to the invention of FIG. 24, exemplary methods of calculating analytics about historical data include usage of data mining algorithms such as Times Series Algorithms known in the art and that are part of the data mining algorithms available in the exemplary analytics subsystem 2410 based on SQL Server Analysis Services. Different embodiments may use different means of calculating analytics about historical data, including predictive analytics such as ARIMA algorithms, SPSS models, exponential smoothing for short term predictions, custom statistical and mathematical algorithms such as a simple algorithm that takes into consideration the count of dynamic offers accepted by buying actor 0100, the count of dynamic offers rejected by buying actor 0100, the average discount associated with dynamic offers. Such algorithms may be used for example in predicting trends of data and in detecting patterns in data.

In further detail, still referring to the invention of FIG. 24, in the exemplary embodiment, the selling actor 0102 server has the means to provide incentives to mobile device holders coupled to a communication network 2400:
by having DOGWS 2402 web service access 2454A a general purpose database system that uses the information in the persistent storage 2404 regarding incentives, such as a relational DBMS,
and by having DOGWS 2402 web service configure a general purpose microprocessor to grant mobile device holders access to the incentives stored in the general purpose database system. In the exemplary embodiment the buying actor 0100 can act also as a mobile device holder and receive incentives such as dynamic offers.

In further detail, still referring to the invention of FIG. 24, different exemplary embodiments may use different incentives, such as flat payments for mobile device holders, and different methods of determining the incentives, such as preconfigured payment amounts.

In further detail, still referring to the invention of FIG. 24, in the exemplary embodiment, the selling actor 0102 server has the means for storing 2452A proximity acquired information in a persistent storage 2404, for example by having DOGWS 2402 web service use a general purpose database system, such as a Database Management System (DBMS). Different embodiments may use different means for storing data, including direct file access API, distributed file systems, XML databases, object oriented databases, document oriented NoSQL database systems, etc.

In further detail, still referring to the invention of FIG. 24, in the exemplary embodiment, the selling actor 0102 server has the means to calculate a trust score for proximity acquired information, for example:
by having DOGWS 2402 use a general purpose database system for storing 2452A in a persistent storage 2404 previously acquired proximity acquired information,
and by having DOGWS 2402 using a general purpose microprocessor to compare different instances of proximity acquired information.

In further detail, still referring to the invention of FIG. 24, alternate embodiments may use a dedicated subsystem that DOGWS 2402 may call into, such as a web service specialized in validating information which internally may use a mathematical or statistical model, or a statistical tool such as SPSS, known in the art, used to detect outliers. Different embodiments may use a simple function invoked by DOGWS 2402 web service as means to calculate a boolean trust score that compares the proximity acquired information with reference information computed by calculating average on a subset of data consisting on previously stored 2454A proximity acquired information. In different embodiments the process of calculating a trust score may happen offline, in over the night batch jobs, using Map-Reduce algorithms, or outside of the process of generating dynamic offers.

In further detail, still referring to the invention of FIG. 24, in the exemplary embodiment, the selling actor 0102 server has the means to request digital proof for proximity acquired information, for example:
by having DOGWS 2402 web service configure a general purpose microprocessor to compare a trust score associated with proximity acquired information with a threshold,
and by having a subsystem of the selling actor 0102 server such as the DOGWS web service coupled to a communication network 2400
and by having a subsystem of the selling actor 0102 server such as the DOGWS web service requesting digital proof information from the buying actor 0100.

In further detail, still referring to the invention of FIG. 24, in the exemplary embodiment, the selling actor 0102 server has the means to allow the buying actor 0100 to purchase dynamic offers within a specified time frame, for example:
by having DOGWS 2402 web service store 2452A the details of a dynamic offer together with an expiration date into a general purpose database system, such as a relational DBMS, which uses the persistent storage 2404,
and by allowing buying actor 0100 to refer the dynamic offer stored in the persistent storage 2404 in subsequent interactions between the buying actor 0100 and the selling actor 0102, interactions that may happen through the exemplary DOGWS 2402 web service or through a different interface exposed to buying actor 0100, such as an exemplary HTML web page implemented by the selling actor 0102 that uses SSL protocol to communicate with buying actor 0100 and PHP scripts or ASP.NET to access 2454A the persistent storage 2404, or by giving the buying actor 0100 access to a Dynamic Offer Metadata Web Service DOMWS 2414 subsystem implemented by selling actor 0102 server, that may have access 2454E to the persistent storage 2404.

In further detail, still referring to the invention of FIG. 21 and FIG. 24, in the exemplary embodiment, the selling actor 0102 server has the means to allow buying actors to certify that transactions for dynamic offers are completed offline:
by having the selling actor 0102 server being coupled to a communication network 2400,
and by having DOGWS 2402 web service configure a general purpose microprocessor to generate a token associated with a dynamic offer,
and by having the DOGWS 2402 web service store 2452A the token in general purpose database that uses the persistent storage 2404,
and by having selling actor 0102 server provide 3^{rd} party selling actors 2122 2124 2126 access to the token via a web service, such as DOMWS 2414,
and by having a buying actor 0100 send to DOMWS 2414 the token,
and by having DOMWS 2414 configure a general purpose microprocessor to compare a token received from a buying actor 0100 with a token stored in the persistent storage 2404.

In further detail, still referring to the invention of FIG. 21 and FIG. 24, in the exemplary embodiment, the selling actor 0102 server has the means to be configured by one or more selling actors computer implemented systems, for example by implementing a web service interface, Seller Interoperability Web Service SIWS 2406, that allows 3^{rd} party selling actors 2122 2124 2126 to specify configuration, by having SIWS 2406 store 2452B the configuration using the persistent storage 2404. Note that above mentioned means are just exemplary, and in some embodiments the selling actor 0102 may allow 3^{rd} part selling actors to do manual configuration, without having selling actor 0102 server expose any external web interface, in such scenarios an operator or administrator of the selling actor 0102 server may access the persistent storage 2404 manually and perform the configuration.

In further detail, still referring to the invention of FIG. 21 and FIG. 24, in the exemplary embodiment, the selling actor 0102 server has the means to delegate parts of the process of generating dynamic offers, for example:
by having the selling actor 0102 server being coupled to a communication network 2400,
and by having DOGWS 2402 configure a general purpose microprocessor to call into external web services interfaces, like 3^{rd} party DOGWS services, during the process of generating dynamic offers and selling products and services executed by the selling actor 0102 server.

In further detail, still referring to the invention of FIG. 24, in different exemplary embodiments, different means of delegating parts of the process of generating dynamic offers may be used, such as using RPC calls, or having 3^{rd} party selling actors 2122 2124 2126 register to the selling actor 0102 dynamic libraries that expose custom functions able to generate dynamic offers on behalf of 3^{rd} party selling actors 2122 2124 2126.

In further detail, still referring to the invention of FIG. 24, in the exemplary embodiment, the selling actor 0102 server has the means to provide proximity acquired information, historical data related to proximity acquired information, and analytics resulted from proximity acquired information, to one or more 3^{rd} party selling actor 2122 2124 2126 computer implemented systems:
by having the selling actor 0102 server being coupled to a communication network 2400,
and by having the selling actor 0102 use an analytics subsystem 2410, such as OLAP server,
and by having DOGWS 2402 subsystem and the analytics subsystem 2420 store 2452C the proximity acquired information and analytics resulted from proximity acquired information into the persistent storage 2404,
and by having selling actor 0102 server implement a web service interface, Information Sharing Web Service ISWS 2416, that 3^{rd} party selling actors 2122 2124 2126 may call 2466 into to access 2454D the proximity acquired information, historical data and analytics stored 2452A, 2454C into the persistent storage 2404.

In further detail, still referring to the invention of FIG. 24, different embodiments may use different means of providing proximity acquired information, historical data and analytics, for example a different embodiment may use a HTTP server to provide 3^{rd} party selling actors 2122 2124 2126 web pages containing daily reports regarding proximity acquired information, historical data and analytics, or may offer 3^{rd} party selling actors limited access to the persisted storage 2404 through a database API, such as SQL, ODBC, OLEDB.

In further detail, still referring to the invention of FIG. 24, in the exemplary embodiment, the selling actor 0102 server has the means for communicating with the buying actor 0100 mobile device and the buying actor 0100 mobile device has the means to receive 0152 dynamic offer, by having the server and the mobile device coupled with the communication network 2400, by having the selling actor 0102 server use a general purpose operating system that has the means to transmit and receive information over a communication network, by having the buying actor 0100 use a general purpose mobile operating system that has the means to transmit 0150 and receive 0152 information over a communication network 2400.

### VI. Exemplary Operation of Invention

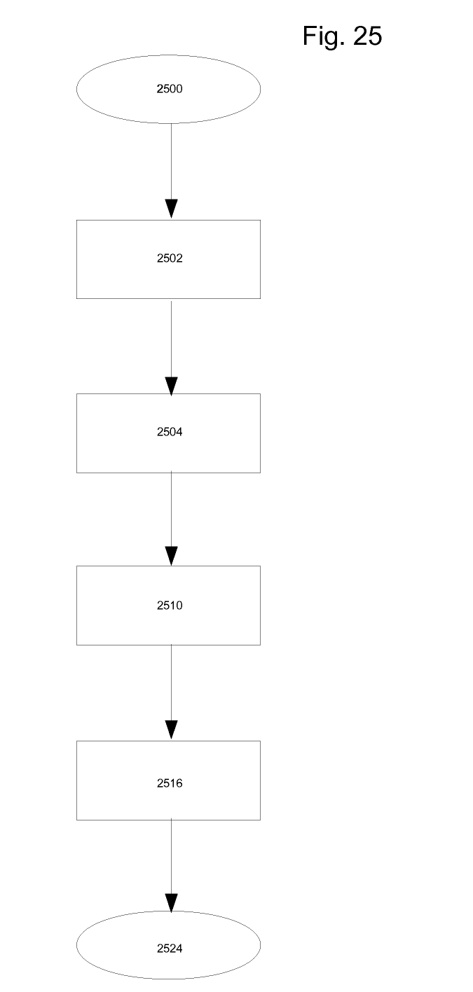

Referring now to the invention of FIG. 24 and FIG. 25 in more detail, FIG. 25 depicts an exemplary flow diagram of an exemplary process of generating dynamic offers of present invention. The exemplary process starts in state 2500. The buying actor 0100 moves the process into state 2502 by acquiring a set of data. The buying actor 0100 moves the process into state 2504 by transmitting the set of data to the selling actor 0102. The selling actor 0102 moves the process into state 2510 by generating a set of dynamic offers, using the set of data transmitted. The selling actor 0102 moves the process into state 2516 by transmitting the set of dynamic offers that the buying actor 0100 may receive 0152. The buying actor 0100 may move the process into final state 2524 by completing transactions associated with a set of dynamic offers, or the selling actor 0102 may move the process into final state 2524 after a time interval.

In more detail, still referring to the invention of FIG. 24 and FIG. 25, in the exemplary process, the buying actor 0100 may move the process in state 2500 by acquiring a set of data that may be used for generating any type of dynamic offer, including, but not limited to, direct dynamic offers, indirect dynamic offers, direct notification dynamic offers, inferred dynamic offers. As an example, in the process of generating direct dynamic offers the set of data may comprise: product or service related information, price information and location. As an example in the process of generating indirect notification dynamic offers, the set of data may comprise: location. The buying actor 0100 moves the process into the state 2504 for example by transmitting 0150 the set of data using the mobile device coupled to a communication network. The selling actor 0102 server has the means to receives the set of data transmitted 0150 by the buying actor 0100. The selling actor 0102 may use the set of data transmitted 0150 by the buying actor 0100 to generate a set of dynamic offers and move the process into state 2510. In the exemplary process of generating the dynamic offer and moving the process into state 2510, the selling actor 0102 may have the ability to execute additional steps, such as validating the set of data received from the buying actor 0100, persisting the set of data received from the buying actor 0100, using GIS subsystems to map location received from the buying actor 0100 to location of physical shops of selling actors, using configuration to decide how to generate the dynamic offers, delegating parts of the execution to 3^{rd} party selling actors, invoking a rule engine subsystem to evaluate policies regarding the process of generating dynamic offers, using analytics to modify key differentiating factors associated with the dynamic offers, calculating ranking scores for dynamic offers. In the exemplary process, the selling actor 0102 may move the process into state 2516 by transmitting through the communication network a subset of the set of dynamic offers generated. In the exemplary process, the buying actor 0100 mobile device in the state 2516 has the means to receive 0152 the set of dynamic offers transmitted by the selling actor 0102, and may presents to the buying actor 0100 the dynamic offers, for example: by displaying the dynamic offers on a hardware display, by using a projector associated with the mobile device, or by using a narrator or text to speech software. In the exemplary process, the buying actor 0100 may decide to close online or offline a set of transactions associated with the dynamic offers received 0152, and move the process into state final 2524. After a time interval the selling actor 0102 server may decide to move the process into final state 2524.

In further detail, still referring to the invention of FIG. 24 and FIG. 25, the buying actor 0100 and the selling actor 0102 have the means to execute the steps of the process to generate dynamic offers, and it should be understood that the exemplary embodiment is not provided to limit the invention, and that those of ordinary skill will understand and appreciate the existence of many suitable variations, combinations, and equivalents of the specific embodiments, methods, and examples herein. In some exemplary embodiments, some steps may be omitted, or additional steps may be included, some steps may be split across multiple states, executed recursively, or in loops, and some steps, such as delegating the execution to 3^{rd} party selling actors or generating dynamic offer may be executed in a distributed environment, asynchronous or parallel. In some embodiments of present invention, the step of generating dynamic offers may be entirely or partially precalculated, for example: by pre-generating a set of dynamic offers; by clustering the buying actors into different buckets based on information or analytics associated with buying actors such as their location or their shopping patterns; and by subsequently mapping said buckets to subsets of the pre-generated set of dynamic offers.

### VII. Exemplary Configuration for Generating Dynamic Offers

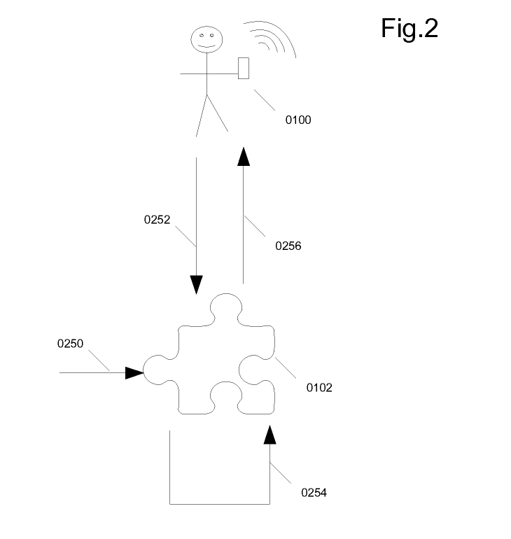

Referring now to the invention in more detail, in FIG. 2, there is shown an exemplary view of configuring 0250 the selling actor 0102. The selling actor 0102 may have the ability to use 0254 the information comprising configuration information and the information transmitted 0150 by the buying actor 0100 as well as other information available to the selling actor 0102 to generate the dynamic offers received 0152 by the buying actor 0100.

In more detail, still referring to the invention of FIG. 2, the selling actor 0102 may have the ability to be configured 0250 via various mechanism such as templates, policies, services, API on how the selling actor 0102 will use 0254 the information transmitted 0150 by the buying actor 0100 to generate dynamic offers that may eventually be received 0152 by the buying actor 0100. The selling actor 0102 may have the ability to be configured 0250 via various mechanisms such as templates, policies, Application Programming Interface API on how the selling actor 0102 may interact with buying actors or other selling actors.

In further detail, still referring to the invention of FIG. 2, the selling actor 0102 may have the ability to allow for manual human intervention to process information transmitted 0150 by the buying actor 0100, or the information configured 0250 may allow for a fully automated process. The configuration information may be stored on the selling actor 0102 computer implemented system or it may be accessed by the selling actor 0102 computer implemented system and used 0254 to generate dynamic offers. Selling actor 0102 may have the ability to use 0254 information transmitted 0150 by the buying actor 0100, configuration information 0250 and other information available to the selling actor 0102 computer implemented system to generate dynamic offers.

As an example still referring to the invention of FIG. 2, the selling actor 0102 may expose via templates the ability to be configured 0250 to generate using information transmitted 0150 a dynamic offer about the same product in the same location, for example, with a price at 10% discount for a specified time frame as long as the resulted price is greater than a specified value. Such template or policy definitions used to configure 0250 the selling actor 0102 could be implemented using any methodology and paradigms that are well known in the art such as by using a general purpose technology, a markup language such as XML, specific designed format to describe the rules, a domain specific declarative language such as XSLT, a query language such as SQL, constraint programming, logic programming such as Prolog, functional programming such as Scheme, imperative programming such as C, object oriented programming such as C++, template programming such as XL, meta-programming such as bash script, macros, reflective programming such as Lisp, attribute-oriented programming such as C# or Java, data-driven programming such AWK, or using any other programming paradigm or language know in the art, or a mix of them. The information configured 0250 may be stored using any suitable data storage device, such as magnetic hard disk drives, SAN disks, solid state drives, optical disks, zip disks, including suitable devices having ability to store information that will be developed in the future. The access to the storage may be provided by the operating system, a dedicated server application such as a database management system DBMS such as Oracle, DB2, SQL Server or MongoDB, by the platform hosting the selling actor 0102 computer implemented system such as SQL Server Azure or a EC2 service or Hadoop Distributed File System, by a big data storage system, by a dedicated storage service, by dedicated storage API such as NTFS Win32 API, Unix file system access API, JDBC, ODBC, OLEDB, or by any suitable API that provides storage services including those developed in the future.

As another example still referring to the invention of FIG. 2, configuring 0250 the selling actor 0102 may enable the selling actor 0102 to use an API to communicate with components for the purpose of generating dynamic offers, also the system may expose the ability to use 0254 the configuration an API for the purpose of generating dynamic offers. Such methods of interfacing for the purpose of configuring 0250 and for the purpose of using 0254 the configuration may take any of the forms known in the art, and can be implemented using embodiments such as database technology, general purpose or dedicated interface API, remote procedure calls, SOAP, web services, dynamic libraries.

In further detail, still referring to the invention in FIG. 2, the implementation for the components responsible for configuring 0250 and that use 0254 the configuration could be for example hosted on the selling actor 0102 computer implemented system, on other selling actors computer implemented systems connected directly or indirectly through a communication network with the selling actor 0102, on a 3^{rd} party hosting environment, in a cloud hosting environment, in dedicated hardware, or in any mix of such environments. For example, zero or more 3^{rd} party selling actors may configure 0250 the selling actor 0102 by providing though web services based implementation, through a client-server based implementation, or through a manual process, their own configuration and allowing the selling actor 0102 to generate dynamic offers that use 0254 the information configured 0250. The information configured 0250 could describe for example: how the selling actor 0102 should generate dynamic offers in various geographical areas, how the selling actor 0102 should generate dynamic offers based on historical, analytical or customer loyalty related information, how the dynamic offers should be generated at different times of day or different days of week, how the dynamic offers should be generated based on the history of previously generated dynamic offers, including the number of previously generated dynamic offers, the parameters of previously generated dynamic offers and the buying actors responses to previously generated dynamic offers. As another example, zero or more 3^{rd} party selling actors may configure 0250 the selling actor 0102, so that the selling actor 0102 will use 0254 the configuration to interact with subsystems that run on behalf of the 3^{rd} party selling actors, and delegate to those subsystems parts of the process of generating the dynamic offers, or the entire process of generating dynamic offers.

Still referring to the invention in FIG. 2, we note that the configuring 0250 and the use 0254 of the configuration are optional steps and may give the embodiment in FIG. 2 more flexibility regarding the way the selling actor 0102 generates the dynamic offers. In absence of those optional steps the selling actor 0102 could generate the dynamic offers for example by using predefined rules, methods, functions or algorithms. The selling actor 0102 computer implemented system may allow 3^{rd} party selling actors to define, store, configure templates, policies and interfacing API to describe how to generate the dynamic offers. The selling actor 0102 computer implemented system may have the ability to configure 0250 itself to take into consideration the buying actor 0100 or other buying actors historical responses to previous dynamic offers when generating new dynamic offers.

In further detail, still referring to the invention of FIG. 2, while the schematic view illustrates aspects of an exemplary process of the present invention in which the selling actor 0102 generates a direct dynamic offer that the buying actor 0100 receives 0152, the steps of configuring 0252, using 0254 the configuration, and receiving 0152 the dynamic offer are not restricted only to the process of generating direct dynamic offers. The selling actor 0102 may have the ability to be configured 0252 and use 0254 the configuration to generate the entire set or any subset of the following types of dynamic offers: direct dynamic offers, direct notification dynamic offers, indirect dynamic offers, indirect notification dynamic offers, inferred dynamic offers. The selling actor 0102 may also have the ability be configured 0252 and use 0254 the configuration to acquire proximity acquired information from mobile device holders and to provide incentives to mobile device holders.

### VIII. Exemplary Step of Modifying Dynamic Offers

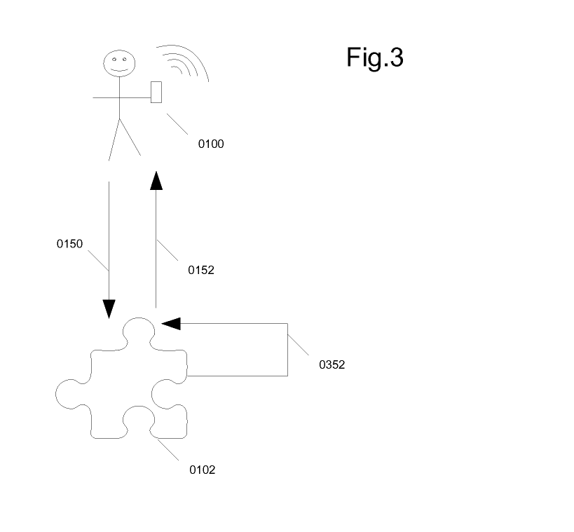

Referring now to the invention in more detail, in FIG. 3, there is shown an exemplary view of an interaction between the selling actor 0102 and the buying actor 0100 where the selling actor 0102 is modifying 0352 a set of generated dynamic offers key differentiating factors before the buying actor 0100 mobile device receives 0152 the dynamic offers.

In more detail, still referring to the invention of FIG. 3, the selling actor 0102 may have the ability to determine attributes of the set of dynamic offers that are relevant for the buying actor 0100. The selling actor 0102 may have the ability to add, remove or modify any parameters or attributes related to a dynamic offer.

In further detail, still referring to the invention of FIG. 3., the selling actor 0102 may have the ability to optimize dimensions of the dynamic offers function of selling actor 0102 interests or buying actor 0100 interest.

In further detail, still referring to the invention of FIG. 3, the step of modifying 0352 dynamic offers key differentiating factors is an optional step. If present it may be implemented by using predefined methods or algorithms, or configuration rules, methods, functions, may be part of an internal or external subsystem, may be exposed via an internal or external API. As an example implementation, the step of modifying 0352 the dynamic offers key differentiating factors may be implemented as a web service hosted on a cloud platform and exposing an internal API that the selling actor 0102 may use. The example implementation may use as input: information regarding the set of dynamic offers, information regarding the buying actor 0100, buying actor 0100 location information, configuration 0250 information, analytical information used to determine how the dynamic offers may be modified in order to optimize profit, inventory, customer loyalty.

As an example still referring to the invention of FIG. 3, for a dynamic offer having an attribute describing product warranty, selling actor 0102 may modify 0352 warranty information by extending it with 1 year, it may remove warranty information, it may add a new attribute describing free shipping, may adjust price for the product, or it may bundle it with an accessory with an additional cost of 2 dollars.

Still referring to the invention in FIG. 2 and FIG. 3, we note that modifying 0352 the generated dynamic offers before the buying actor receives 0152 the dynamic offers is an optional step. In absence of the optional steps of modifying 0352 the generated dynamic offers, the dynamic offers received 0152 by the buying actor will be the same with the dynamic offers generated by the selling actor 0102, for example as result of configuring 0250 the selling actor and using 0254 the configuration, or as result of predefined rules.

In further detail, still referring to the invention of FIG. 3, while the schematic view illustrates aspects of an exemplary process of the present invention in which the selling actor 0102 generates a direct dynamic offer that the buying actor 0100 receives 0152, the step of modifying 0352 the generated dynamic offers is not restricted only to the process of generating direct dynamic offers. The selling actor 0102 may have the ability to modify 0352 the entire set or any subset of the following types of dynamic offers: direct dynamic offers, direct notification dynamic offers, indirect dynamic offers, indirect notification dynamic offers, inferred dynamic offers.

### IX. Exemplary Step of Presenting Dynamic Offers

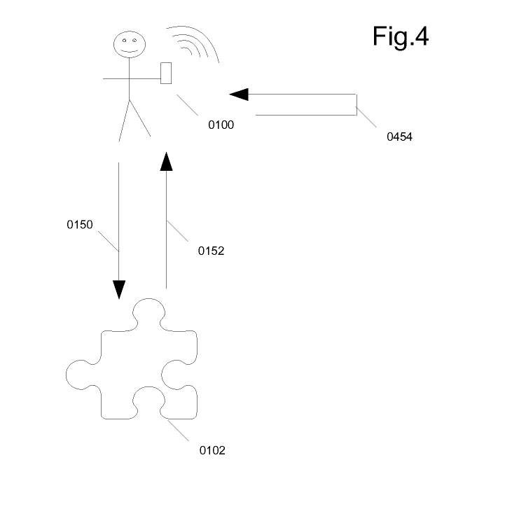

Referring now to the invention in more detail, in FIG. 4, there is shown a view of exemplary presenting 0454 the dynamic offers on the buying actor 0100 mobile device, after the buying actor 0100 receives 0152 information associated with them.

In more detail, still referring to the invention of FIG. 4, the buying actor 0100 computer implemented system may have the ability to highlight dynamic offers key differentiating factors. The buying actor 0100 computer implemented system may present 0454 a subset of one or more dynamic offers from the offers that the buying actor 0100 received 0152 from the selling actor 0102. For a dynamic offer the buying actor 0100 computer implemented system may present 0454 a subset of zero or more differentiating factors.

In further detail, still referring to the invention of FIG. 4, highlighted key differentiating factors may be presented 0454 on the buying actor 0100 mobile device using any combination of visual or audio mechanisms that distinguish them by other dynamic offer attributes. The buying actor 0100 computer implemented system may present 0454 the set of dynamic offers using a subset of key differentiating factors and dynamic offers and may give buying actor 0100 the ability to browse, search or filter dynamic offers. The set of highlighted key differentiating factors that are presented 0454 on the buying actor 0100 mobile device may be determined by the buying actor 0100 computer implemented system, could be received 0152 from the selling actor 0102 computer implemented system. The buying actor 0100 may have the ability to select a dynamic offer and present 0454 a detailed view of the selected dynamic offer. In order for the buying actor 0100 computer implemented system running on buying actor 0100 mobile device to present 0454 the key differentiating factors associated with the dynamic offers, either the key differentiating factors are received 0152 from the selling actor 0102 together with the dynamic offers or the buying actor could retrieve them for the selling actor 0102 or a 3^{rd} party computer implemented system or service connected through a communication network with the buying actor 0100 mobile device.

In further detail, still referring to the invention of FIG. 4, in a typical embodiment the buying actor 0100 computer implemented system may run as a software application on buying actor 0100 mobile device. The application may use services and API provided by the operating system or by libraries available for the mobile device to transmit 0150 the data set, to receive 0152 dynamic offers and to present 0454 the dynamic offers. The application may be implemented in any language suitable such as Java, C++, C#, Objective-C, Silverlight and may use libraries such as socket support, XNA, CFNetwork, known in the art. In different embodiments the support to transmit 0150 the data set, receive 0152 dynamic offers, or present 0454 the dynamic offers might be provided by a different layer such as firmware. Different embodiments could transmit 0150 the data set, receive 0152 dynamic offers, or present 0454 dynamic offers using modules implemented in the firmware or in the operating system or in the hardware.

In further detail, still referring to the invention of FIG. 4, the buying actor 0100 computer implemented system running on its mobile device may have the ability to present tracking, historical and statistical information associated with closed and active dynamic offers. The buying actor 0100 computer implemented system may have the ability to use the ranking associated with a dynamic offer as input for sorting and filtering operations. The buying actor 0100 computer implemented system may have the ability to use for ranking, sorting and filtering operations input, such as: location, distance between buying actor and selling actor, price, expiration date, dynamic offer attributes, key differentiating factors, product or service rating, product or service brand, selling actor rating, selling actor identity, selling actor interests. The buying actor 0100 computer implemented system may have the ability to highlight any subset of the key differentiating factors, including the entire set.

In further detail, as an example, still referring to the invention of FIG. 4, the selling actor 0102 computer implemented system may have the ability to calculate key differentiating factors, between multiple dynamic offers, or between multiple dynamic offers and products or services referred by buying actor 0100. An example below describes the attributes for two dynamic offers, their differentiating factors and the key differentiating factors that the selling actor 0102 determined through analytics:

### Dynamic Offer 1 Attributes:

Brand: ABCTV

Color: Black

Diagonal: 42

Warranty: 3 years

Shipping: included

Ship time: 7 days

Price: 275 $

Distance: 10 km

### Dynamic Offer 2 Attributes:

Brand: DFGTV

Color: Black

Diagonal: 43

Warranty: 1 year

Shipping: included

Ship time: 3 days

Price: 260 $

Distance: 3 km

### Differentiating Factors for Offer 1:

Brand: ABCTV

Diagonal: 42

Warranty: 3 years

Ship time: 7 days

Price: 275 $

Distance: 10 km

### Differentiating Factors for Offer 2:

Brand: DFGTV

Diagonal: 43

Warranty: 1 year

Ship time: 3 days

Price: 260 $

Distance: 3 km

### Key Differentiating Factors for Offer 1:

Warranty: 3 years

### Key Differentiating Factors for Offer 2:

Diagonal: 43

Price: 260 $

The key differentiating factors may be resulted from analytics. The analytics subsystem, function or service that determines the key differentiating factors may have the ability to take into consideration historical information regarding the buying actors, including information regarding buying actor behavior in response to previous dynamic offers.

In further detail, still referring to the invention of FIG. 4, while the schematic view illustrates aspects of an exemplary process of the present invention in which the selling actor 0102 generates a direct dynamic offer that the buying actor 0100 receives 0152, the step to present 0454 the dynamic offers is not restricted only to the process of generating direct dynamic offers. The buying actor 0102 computer implemented system may present 0454 the entire set or any subset of the following types of dynamic offers: direct dynamic offers, direct notification dynamic offers, indirect dynamic offers, indirect notification dynamic offers, inferred dynamic offers.

### X. Exemplary Usage of Analytics

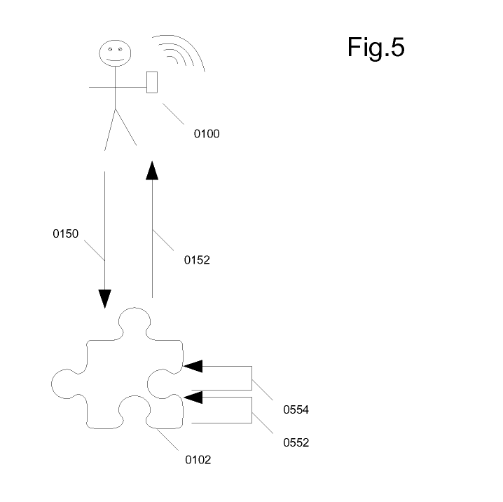

Referring now to the invention in more detail, in FIG. 5 there is shown a view of the exemplary interaction between the selling actor 0102 and the buying actor 0100 where the selling actor 0102 is calculating analytics 0552 and is using the analytics 0554 to generate dynamic offers or to modify generated dynamic offers prior to dynamic offer being presented to the buying actor 0100.

In more detail, still referring to the invention of FIG. 5, the selling actor 0102 may use the information acquired from the buying actors, such as the information that the buying actors transmitted to the selling actor 0102, the locations of buying actors, the historical responses that the buying actors made to dynamic offers that they received 0152 from the selling actor 0102. The selling actor 0102 may also use proximity acquired information that 3^{rd} party selling actors provided to the selling actor 0102. The selling actor may calculate analytics 0552 using information acquired from buying actors as well as selling actors. In different embodiments the selling actor 0102 may acquire the analytical information from external sources. The calculated analytics 0552 or the acquired analytics can be used 0554 by the selling actor 0102 to generate or modify dynamic offers, to understand historical patterns, and improve business performance. The selling actor 0102 computer implemented system may have the ability to use the analytics results in a feedback loop, in an automated or in a manual mode, for example to further tune itself.

In further detail, still referring to the invention of FIG. 5, the step of calculating analytics 0552 may be executed by the selling actor 0102 in the process of generating dynamic offers or it may be processed at a later time, for example offline. Any of a number of models known in the art for calculating analytics 0552 can be effective. As an example the selling actor 0102 may use to calculate analytics 0552 big data processing solutions such as Hadoop, Casandra, ETL, map-reduce, data warehouse, data mart, OLAP systems, business intelligence systems, decision support systems, data mining solutions and algorithms, statistical analysis and mathematics. Selling actor 0102 may have the ability to store the results of analytics and may use the analytics 0554 in the process of generating dynamic offers. The storage for analytics may use any suitable storage device, storage platform or storage API, such as hard-drives, SAN disks, solid state drives, Hadoop, DFS, NTFS, POSIX API, Win32 API, .NET API, OLEDB, ODBC, JDBC, Oracle, SQL Server, SQL Server Azure, EC2, DB2, MongoDB, relational databases, NoSQL databases, multi-dimensional databases and cubes, known in the art.

In further detail, still referring to the invention in FIG. 5, the selling actor 0102 may use the analytics 0554, to generate or to modify dynamic offers by taking into consideration marketing optimizations, customer segmentation, demographic and geographic information. As an example the selling actor 0102 may use the analytics 0554 to determine that the buying actor 0100 can be associated with a particular customer segment for which extended warranty is a key differentiating factor that may have a high probability to influence the decision to purchase the products associated with a dynamic offer, and as a result modify a dynamic offer by including extended warranty. As another example the selling actor 0102 may use the analytics 0554 to determine that at the current location of the buying actor 0100 the probability that the buying actor 0100 will accept a dynamic offer at above a threshold price is very low and as result generate dynamic offers that have prices set below the threshold.

In further detail, still referring to the invention of FIG. 5, while the schematic view illustrates aspects of an exemplary process of the present invention in which the selling actor 0102 generates a direct dynamic offer that the buying actor 0100 receives 0152, the steps of calculating analytics 0552 and using the analytics 0554 are not restricted only to the process of generating direct dynamic offers. The selling actor 0102 may have the ability to calculate analytics 0552 and use the analytics 0554 to generate the entire set or any subset of the following types of dynamic offers: direct dynamic offers, direct notification dynamic offers, indirect dynamic offers, indirect notification dynamic offers, inferred dynamic offers. The selling actor 0102 may also have the ability calculate analytics 0552 and use the analytics 0554 in the process to provide incentives to mobile device holders.

In further detail, still referring to the invention of FIG. 5, the analytics subsystem used by the selling actor 0102 to generate the dynamic offers may have the ability to use information about the buying actor 0100 historical responses to other dynamic offers, as well as historical responses that other buying actors made to dynamic offers. The selling actor 0102 may have the ability to use a feedback loop involving an analytics subsystem in order to improve metrics associated with dynamic offers, for example to maximize profit, to minimize inventory, to increase the likelihood that buying actor 0100 will complete a transaction for the dynamic offers, to increase buying actor satisfaction. The selling actor 0102 computer implemented system may have the ability to use such analytics regardless of the type of dynamic offer that the selling actor 0102 provided to the buying actor 0100.

In further detail, still referring to the invention of FIG. 5, as result of the selling actor 0102 using analytics in the process of generating dynamic offers in different contexts, different buying actors may receive 0152 different dynamic offers at the same location and at the same time for same products and services, also same buying actor 0100 may receive 0152 different dynamic offers for the same product or service at the same time but in different locations, also same buying actor 0100 may receive 0152 different dynamic offers for the same product or the same service at the same location but at different times. The dynamic offers received 0152 by buying actors in different contexts may differ in one or more aspects, such as pricing, key differentiation factors, quantity, products and services offered. The selling actor 0102 computer implemented system may have the ability to detect similarities between those scenarios and may decide based on internal policies or based on configuration to provide similar dynamic offers or different dynamic offers for the situations having the said similarities.

### XI. Exemplary Ranking

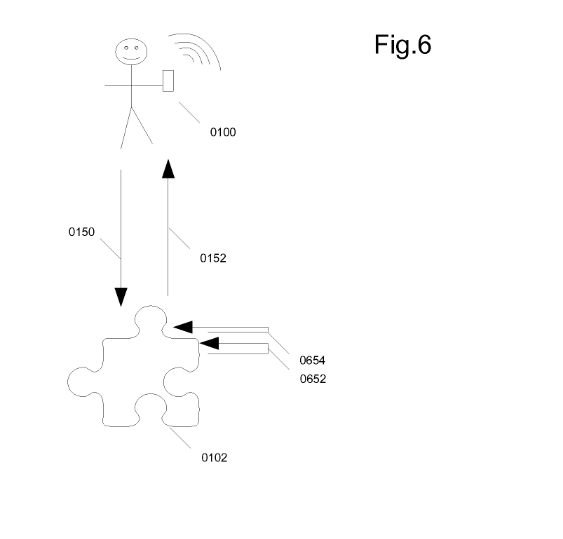

Referring now to the invention in more detail, in FIG. 6 there is shown a view of the exemplary interaction between the selling actor 0102 and the buying actor 0100 where the selling actor 0102 is calculating a ranking score 0652 and is using the ranking score 0654 to modify the set of dynamic offers that the buying actor 0100 is receiving 0152 from the selling actor 0102.

In more detail, still referring to the invention of FIG. 6, the selling actor 0102 may calculate a ranking score 0652 for all dynamic offers generated by the selling actor 0102. The functions that calculate the ranking score 0652 may take into consideration factors such as:
the selling actor 0102 interests, interests of 3^{rd} party selling actors, the buying actor 0100 interests,
historical behavior associated with the buying actor 0100, historical behavior of the interaction between the buying actor 0100 and the selling actor 0102 or other 3rd party selling actors where that information in known to the selling actor 0102,
attributes of the dynamic offers such as warranty, brand, price,
analytics about the buying actor 0100, analytics known to the selling actor 0102 about other buying actors, analytics about location, analytics about the products or services associated with the dynamic offer,
location of the buying actor 0100, time of year, time of day, key differentiating factors.

In further detail, still referring to the invention of FIG. 6, the selling actor 0102 may use the ranking score 0654 to order, filter the dynamic offers, and as result the buying actor 0100 might receive 0152 only a subset of the dynamic offers that were generated by the selling actor 0102 and might receive 0152 the dynamic offers with additional information associated with them, such a ranking score, sort order

In further detail, still referring to the invention of FIG. 6, the functions that calculate the ranking score 0652, might take into consideration factors such as:
maximizing the selling actor 0102 profit, optimizing the inventory of a 3rd party selling actor that provides the products and services offered in the dynamic offer generated by the selling actor 0102,
a matching function between the products or services that the buying actor 0100 expressed interest and the products and services that are part of the dynamic offer,
analytics describing that the buying actors in the same customer segmentation with buying actor 0100 are price driven,
analytics describing the way a key differentiating factor such as extra warranty, brand, type of shipping is perceived in the geographical area where buying actor 0100 is located.

In further detail, still referring to the invention of FIG. 6, each of the factors taken into consideration by the selling actor 0102 when calculating the ranking score 0652 may be weighted, and may have different contribution to the final ranking score associated with the dynamic offer. The weight associated with each of the factors may be statically or dynamically adjusted and configured, for example as part of a manual or automatic feedback process that takes into consideration the past performance of the weighting factors affecting the ranking score.

In further detail, still referring to the invention of FIG. 6, the selling actor 0102 computer implemented system may have the ability to use 0654 the ranking associated with a dynamic offer as input for sorting and filtering operations. The selling actor 0102 computer implemented system may have the ability to use for ranking, sorting and filtering operations input, such as: location, distance between buying actor 0100 and the selling actor 0102, distance between buying actor and a physical shop associated with the 3^{rd} party selling actor on behalf of which the selling actor 0102 may have generated the dynamic offer, price, expiration date, dynamic offer attributes, key differentiating factors, product or service rating, product or service brand, the rating for the 3^{rd} party selling actor on behalf of which the selling actor 0102 generated the dynamic offer, the identity for the 3^{rd} party selling actor on behalf of which the selling actor 0102 generated the dynamic offer, the selling actor 0102 interests.

Still referring to the details of the invention as shown in FIG. 6 the steps of calculating a ranking score 0652, and using the ranking score 0654, may be implemented using any suitable software components, and may be hosted internally as subsystems or functions part of selling actor 0102 computer implemented system, or may be exposed as separate subsystems interfacing with the selling actor 0102 computer implemented system through an interface, for example a web service interface or a public API.

In further detail, still referring to the invention of FIG. 6, while the schematic view illustrates aspects of an exemplary process of the present invention in which the selling actor 0102 generates a direct dynamic offer, the steps of calculating a ranking score 0652 and using the ranking score 0654 are not restricted only to the process of generating direct dynamic offers. The selling actor 0102 may have the ability to calculate a ranking score 0652 and to use the ranking score 0654 in the process associated with the entire set or any subset of the following types of dynamic offers: direct dynamic offers, direct notification dynamic offers, indirect dynamic offers, indirect notification dynamic offers, inferred dynamic offers.

### XII. Exemplary Completing a Transaction Online

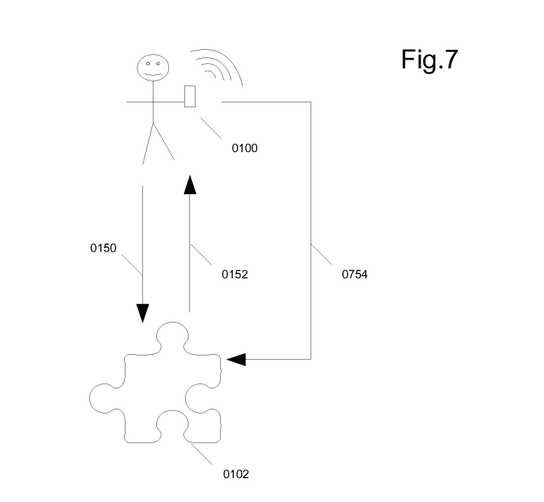

Referring now to the invention in more detail, in FIG. 7 there is shown an exemplary view of the interaction between the selling actor 0102 and the buying actor 0100 where the buying actor 0100 completes online 0754 a transaction associated with a set of dynamic offers that were part of the set of dynamic offers received 0152 from the selling actor 0102.

In more detail, still referring to the invention of FIG. 7, the selling actor 0102 may allow the buying actor 0100 to purchase online the products and services associated with zero or more dynamic offers by completing online 0754 transactions associated with the dynamic offers. The selling actor 0102 may allow the buying actor 0100 to delay the action to complete online 0754 transactions associated with a dynamic offer. The selling actor 0102 may associate a time frame with a dynamic offer, and allow the buying actor 0100 to complete online 0754 the transaction anytime within the time frame associated with the dynamic offer. The buying actor 0100 computer implemented system running on the mobile device may be able to store information associated with the dynamic offers, including the time frame, and may be able to provide notifications to the buying actor 0100 with regard to the time frame and expiration deadlines.

In further detail, still referring to the invention of FIG. 7, the buying actor 0100 may complete online 0754 the transaction using any suitable e-commerce payment system well known in the art such as traditional credit, traditional debit, traditional charge card, smart-cards, digital wallets. E-wallet, contactless near field communication (NFC) systems, e-cash (such as PayPal, WebMoney, cashU), online wallets (Amazon Payments, Google Checkout), Ripple monetary system, anonymous ecash, hard electronic currency, soft electronic currency, mobile payment, e-checks, premium SMS based transactional payments, Direct Mobile Billing, Mobile Web Payments (WAP), mobile payment clients (Java ME), direct carrier/bank co-operation, or Electronic Bill Presentment and Payment (EBPP). It may be also possible to enable 3^{rd} parties to complete online 0754 the transaction on behalf of the buying actor 0100, for example through a Payment Service Provider (PSP), prepaid cards, coupons or vouchers, or to complete online 0754 the transaction using surrogate or virtual money, or loyalty points. It may be also possible in some embodiments for the buying actor 0100 to complete online 0754 the transaction by directly registering an account with the selling actor 0102, or with the 3^{rd} party selling actor on behalf of which the selling actor 0102 generated the dynamic offer, or with any other suitable entity; debiting the account or obtaining credit on the account; and using the account to perform the payments.

In further detail, still referring to the invention of FIG. 7, the buying actor 0100 may complete online 0754 the transaction using the mobile device, or in some embodiments may use a secondary device, such as a different mobile device, a standalone NFC chip, a desktop personal computer, to complete online 0754 the transaction. This may be for example achieved by having the buying actor 0100 mobile device that received 0152 the dynamic offer share with the secondary device some information, such as buying actor 0100 account information, buying actor 0100 registration with the selling actor 0102, a code associated with the dynamic offer received 0152 by the buying actor 0100. The shared information can be transferred manually or electronically between devices.

In further detail, still referring to the invention of FIG. 7, while the schematic view illustrates aspects of an exemplary process of the present invention in which the selling actor 0102 generates a direct dynamic offer that the buying actor 0100 receives 0152, the step to complete online 0754 the transaction is not restricted only to the process involving generating direct dynamic offers. The selling actor 0102 and the buying actor 0100 may have ability to complete online 0754 the transaction for the entire set or any subset of the following types of dynamic offers: direct dynamic offers, direct notification dynamic offers, indirect dynamic offers, indirect notification dynamic offers, inferred dynamic offers. The selling actor 0102 and a mobile device holder may also have the ability complete online 0754 the transactions associated with incentives that a mobile device holder may receive from the selling actor 0102.

In further detail, still referring to the invention of FIG. 7, the selling actor 0102 computer implemented system offers to buying actor 0100, to selling actor 0102, and to 3^{rd} party selling actors interfacing with selling actor 0102 the ability to postpone the online transaction or to allow buying actor 0100 to buy the products or services only through offline transactions. Such examples could be:
Buying actor 0100 decides to postpone its buying decision;
Selling actor 0102 has low confidence in the digital proof received from the buying actor 0100 and requires buying actor 0100 physical presence in a store to present the digital proof prior to closing the purchase associated with the dynamic offer;
Selling actor 0102 prefers that buying actor 0100 physical presence in a store in order to maximize its chance of selling other products or services.

In further detail, still referring to the invention of FIG. 7, in some embodiments, the buying actor 0100 may have the ability to close online the transaction with the selling actor 0102 or with a 3^{rd} party selling actor, for example in a topology in which the selling actor 0102 interfaces directly or indirectly with the 3^{rd} party selling actor, or in a scenario in which the selling actor 0102 generated a dynamic offer on behalf of the 3^{rd} party selling actor.

### XIII. Exemplary Topologies

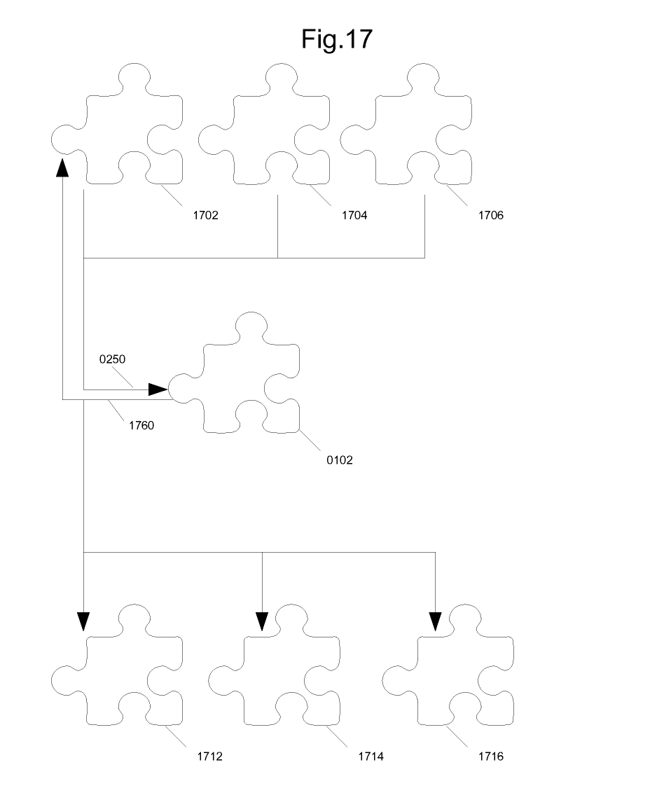

Referring now to the invention in more detail, in FIG. 17, there is shown an exemplary view of the interaction between a selling actor 0102 and other 3^{rd} party selling actors. The selling actor 0102 may have the ability to interact with zero or more 3^{rd} party selling actors 1702 1704 1706 that are configuring 0250 the selling actor 0102 to act on their behalf by generating dynamic offers and selling products and services. Also the selling actor 0102 might have the ability to configure 1760 other 3^{rd} party selling actors to act on its behalf by generating dynamic offers and selling products and services.

In more detail, still referring to the invention of FIG. 17, any 3^{rd} party selling actor such as 1702 may configure 0250 the selling actor 0102 to act on its behalf and at the same time selling actor 0102 may configure 1760 the 3^{rd} party actor 1702 to act on its behalf. The 3^{rd} party actors 1702 1704 1706 1712 1714 1716 can also interact directly with zero or more buying actors. The configuration exchanged between 3^{rd} party actors such as 1702 and 1712 and the selling actor 0102 may be statically described for example via policies, templates, or it may be dynamically exchanged or a combination of the above. Each selling actor, including the selling actor 0102 and the 3^{rd} party selling actors 1702 1704 1706 1612 1614 1716 may have the ability to store the configuration, use it and expose it to other selling actors.

In further detail, still referring to the invention of FIG. 17, the interaction between a 3^{rd} party selling actors such as 1702 and 1712 and the selling actor 0102 can be recursive and can result in any topology that suits the needs of the selling actor 0102 and 3^{rd} party selling actors such as 1702 1704 1706 and other 3^{rd} party actors such as 1712 1714 1716. The group of selling actors 0102 1702 1704 1706 1712 1714 1716 may be a selling actor, and the buying actor 0100 may perceive the group as one selling actor.

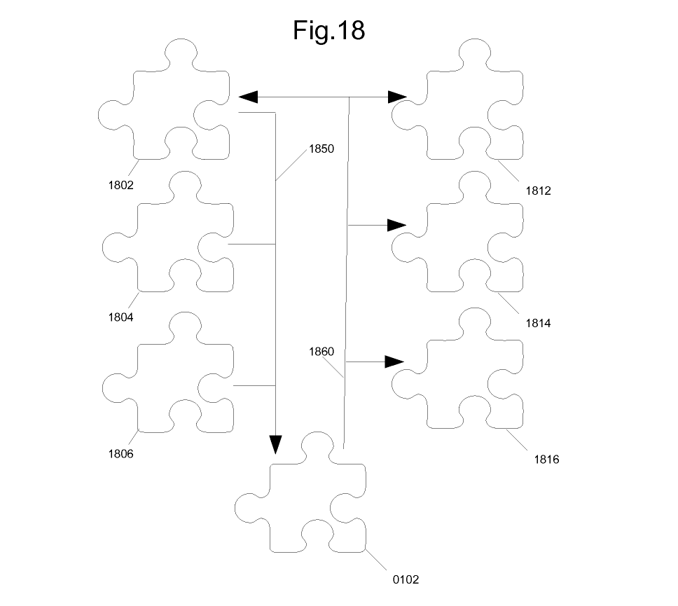

Referring now to the invention in more detail, in FIG. 18, there is shown an exemplary view of the interaction between a selling actor 0102 and other 3^{rd} party selling actors. The selling actor 0102 may have the ability to interact with zero or more 3^{rd} party selling actors 1802 1804 1806 that are delegating 1850 the selling actor 0102 to act on their behalf and execute parts or the entire process of generating dynamic offers and selling products and services. Also the selling actor 0102 may have the ability to delegate 1860 to other 3^{rd} party selling actors 1812 1814 1816 parts of the process or the entire process of generating dynamic offers and selling products and services.

In more detail, still referring to the invention of FIG. 18, any 3^{rd} party selling actor such as 1802 delegate the selling actor 0102 to act on its behalf and at the same time selling actor 0102 may delegate the 3^{rd} party actor 1802 to act on its behalf. The 3^{rd} party selling actors may also interact directly with zero or more buying actors, or with other selling actors.

In further detail, still referring to the invention of FIG. 18, the interaction between a 3^{rd} party selling actors such as 1802 and 1812 and the selling actor 0102 may be direct, may be indirect, can be recursive and can result in any topology that suits the needs of the selling actor 0102 and 3^{rd} party selling actors such as 1802 1804 1806 and other 3^{rd} party actors such as 1812 1814 1816. The group of selling actors 0102 1802 1804 1806 1812 1814 1816 may be a selling actor, and the buying actor 0100 may perceive the group as one selling actor.

### XIV. Exemplary Completing a Transaction Offline

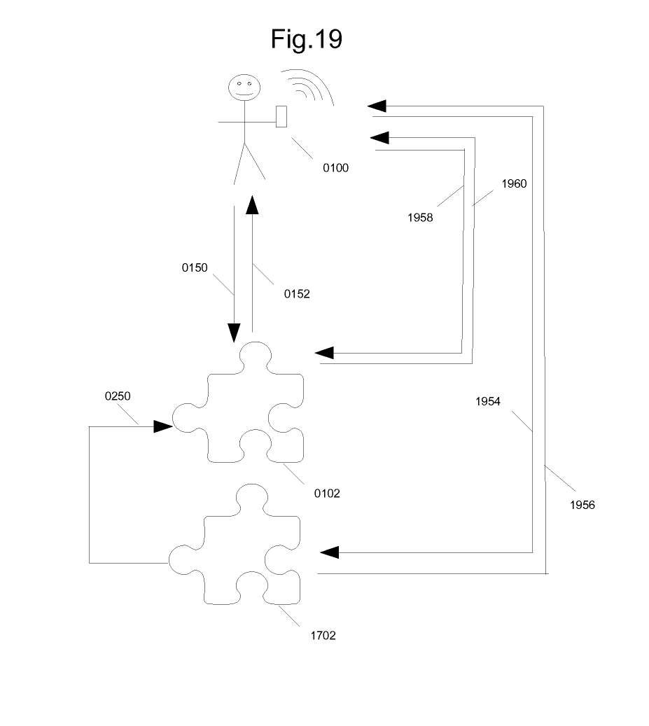

Referring now to the invention in more detail, in FIG. 19, there is shown an exemplary view of the interaction between a buying actor 0100, a selling actor 0102 and a 3^{rd} party selling actor 1702 where the buying actor 0100 may receive 1960 incentives as a result of certifying 1958 that a transaction associated with received 0152 dynamic offers was completed offline. The 3^{rd} party selling actor 1702 may have the ability to configure 0250 selling actor 0102 to act on its behalf by selling products and services and generating dynamic offers. The buying actor 0100 transmits 0150 to the selling actor 0102 a set of data comprising one or more parameters related to products or services, one or more parameters related to the products or services price, one or more parameters related to the location. The selling actor 0102 uses the set of data transmitted 0150 by the buying actor 0100 to generate a set of dynamic offers. The buying actor 0100 receives 0152 the set of dynamic offers from the selling actor 0102. The buying actor 0100 may have the ability to complete a transaction offline 1954 with the 3^{rd} party selling actor 1702 and purchase from the selling actor 1702 products or services associated with the received dynamic offers 0152. As result of completing the transaction offline 1954, the 3^{rd} party selling actor may have the ability to generate a personalized token and transmits 1956 the personalized token to the buying actor 0100. The buying actor 0100 may certify 1958 to the selling actor 0102 that the transaction was completed 1954 offline and may receive 1960 incentives from the selling actor 0102 in exchange for providing the certification information.

In more detail, still referring to the invention of FIG. 19, the buying actor 0100 may have a specified time frame on which the buying actor 0100 needs to complete the transaction offline 1954 with the 3^{rd} party selling actor 1702 to qualify to receive incentives 1960. This time frame could be configurable by the selling actor 0102 as well as the 3^{rd} party selling actor 1702. The selling actor 0102 computer implemented system may have the ability to generate dynamic offers and associate them with personalized tokens valid for specific time frames based on selling actors 0102 1702 needs. Each dynamic offer may be associated with a different personalized token or same personalized token may be used for any subset of the dynamic offers returned 0152 to the buying actor 0100. Each product or service associated with a dynamic offer may also have a different personalized token or they could be associated with the same. Each product or service and each dynamic offer may also have no personalized token associated with. Each token may be valid for same or different time frames.

In further detail, still referring to the invention of FIG. 19, the 3^{rd} party selling actor 1702 may act as the selling actor 0102. The buying actor 0100 may complete one or more transactions with one or more 3^{rd} party selling actors such as the 3^{rd} party selling actor 1072 and receive one or more transmitted 1956 personalized tokens that later the buying actor 0100 may use to certify 1958 the completion of transactions to the selling actor 0102 in order to receive 1960 incentives associated with any subset of the personalized tokens received.

As an example, still referring to the invention of FIG. 19, when a buying actor 0100 contacts the selling actor and sends information about a furniture table that the buying actor 0102 is considering to buy, the selling actor 0102 computer implemented system may have the ability to return 0152 a set of dynamic offers associated with personalized tokens. For example the selling actor 0102 may return a similar furniture table with a token valid for 24 hours, same furniture table valid for 12 hours in a specified location or a kitchen furniture set on sale for the next 48 hours in an online store. When the buying actor 0100 is purchasing the products or services associated with the dynamic offer at the selling actor 1702 physical store location, the buying actor 0100 may have the ability to retrieve from the selling actor 1702 a code, promotional key, associated with the personalized token. The buying actor 0100 may have the ability to transmit this code, promotional key, to the selling actor 0102 computer implemented system certifying 1958 that the purchase was completed, and receiving 1960 credit for the purchase, for example in form of loyalty points, promotions, additional discounts. The computer implemented system components running on buying actor 0100 mobile device or selling actor 1702 system or selling actor 0102 may have the ability to initiate the process of issuing the code, promotional key. The buying actor 0100 also may have the ability to manually enter the code, promotional key, retrieved from the 3^{rd} party selling actor 1702, and use the computer implemented system running on its mobile device to transmit it to the selling actor 0102.

As an example, still referring to the invention of FIG. 19, the selling actor 0102 computer implemented system may have the ability to associate a code, promotional key with the buying actor 0100:
by having the buying actor 0100 computer implemented system transmit a previously acquired code, promotional key, to the selling actor 0102;
by recording on a persistent storage a mapping between the code, promotional key, and the buying actor 0100.

In further detail, still referring to the invention of FIG. 19, the buying actor 0100 computer implemented system components running on the buying actor 0100 mobile device or the selling actor 0102 computer implemented system may have the ability to initiate the process of issuing the code, promotional key. The buying actor 0100 also may have the ability to acquire manually the code, promotional key, from the 3^{rd} party selling actor 1702 or the 3^{rd} party selling actor 1702 may have the ability to automatically transmit 1956 it to the buying actor 0100, for example using WiFi or NFC technology. The buying actor 0100 also may have the ability to certify 1958 to the selling actor 0102 that the transaction was completed. The buying actor 0100 may use the mobile device or a secondary device such as a desktop computer coupled to a suitable communication network in the process of completing the transaction offline. In some embodiments the 3^{rd} party selling 1702 actor might act on behalf of the buying actor 0100 and transmit the code, promotional key to the selling actor 0102 without having the requirement for the buying actor 0102 to acquire the code, promotional key to certify that the transaction was completed 1954.

As an example, still referring to the invention of FIG. 19, the selling actor 0102 computer implemented system may have the ability to:
issue a code, promotional key, to the buying actor 0100 as a result of a purchase of products or services from a dynamic offer;
issue a code, promotional key, to the buying actor 0100, through an external channel;
adjust subsequent dynamic offers, including subsequent dynamic offers provided to the buying actor 0100, by taking into consideration the code, promotional key mentioned above.

Still referring to the invention of FIG. 19, the code, promotional key, may be associated with incentives, such as a monetary discount for other dynamic offers, a rule describing a way to provide preferential treatment in one or more future dynamic offers, tracking information such as loyalty points. The selling actor 0102 computer implemented system may store the code, promotional key, may store the effects of the code, promotional key, or may not store the product key at all and instead may use an internal or external service for dynamically obtaining the incentives associated with code, promotional key that a buying actor may provide.

In further detail, still referring to the invention of FIG. 19, while the schematic view illustrates aspects of an exemplary process of the present invention in which the selling actor 0102 generates a direct dynamic offer that the buying actor 0100 receives 0152, the steps to complete a transaction offline 1954, to transmit 1956 the personalized token, to certify 1958, and to receive 1960 incentives are not restricted only to the process of generating direct dynamic offers, those steps may be used to offline transaction processes associated with any of the following types of dynamic offers: direct dynamic offers, direct notification dynamic offers, indirect dynamic offers, indirect notification dynamic offers, inferred dynamic offers. Also, the mechanism of transmitting 1956 a token from a 3^{rd} party selling actor to the buying actor, of issuing a code, promotional key, of certifying 1958 to the selling actor 0102 that a transaction was completed with a 3^{rd} party selling actor, and of receiving 1960 a code, promotional key may be used in an embodiment allowing an online transaction scenario, in which the buying actor 0100 closes online a transaction with a 3^{rd} party selling actor 1702.

### XV. Exemplary Direct Dynamic Offers

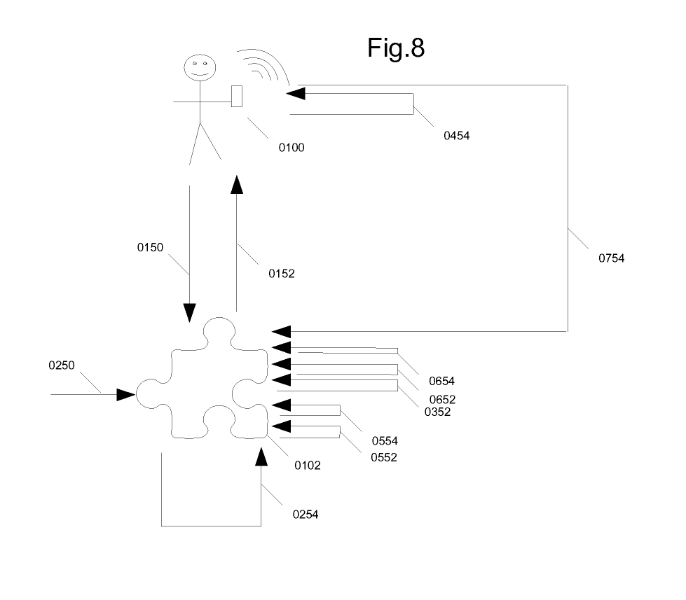

Referring now to the invention in more detail, in FIG. 8, there is shown an exemplary view of the interaction between a buying actor 0100 and a selling actor 0102 on the present invention. The buying actor 0100 transmits 0150 to the selling actor 0102 a set of data comprising one or more parameters related to products or services, one or more parameters related to the products or services price, one or more parameters related to the location. The selling actor 0102 uses the set of data transmitted 0150 by the buying actor 0100 to generate a set of dynamic offers. The buying actor 0100 receives 0152 the set of dynamic offers from the selling actor 0102. The selling actor 0102 may have the ability to allow other 3^{rd} party selling actors or itself 0102 to configure 0250 the selling actor 0102. The selling actor 0102 may use 0254 this configuration 0250 and the set of data transmitted 0150 by the buying actor 0102 to generate direct dynamic offers that the buying actor may receive 0152. The selling actor 0102 may use a subsystem to calculate analytics 0552 using any subset of configuration 0250 data transmitted 0150 and any other information available to the selling actor 0102. The selling actor 0102 may use 0554 the results of the analytics subsystem to generate the direct dynamic offers. The selling actor 0102 may use the analytics subsystem or a different subsystem to modify 0352 the direct dynamic offers key differentiating factors. The selling actor 0102 may calculate a ranking score 0652 and may use the ranking score 0654 to modify the set of direct dynamic offers. The buying actor 0100 may have the ability to present 0454 the received 0152 direct dynamic offers on the buying actor 0100 mobile device. The buying actor 0100 may have the ability to complete online 0754 a transaction associated with zero or more direct dynamic offers part of the received 0152 direct dynamic offers.

In more detail, still referring to the invention of FIG. 8, the selling actor 0102 may have the ability to be configured 0250 via various mechanisms such as templates, policies, services, API on how the selling actor 0102 will use 0254 the information transmitted 0150 by the buying actor 0100 to generate dynamic offers, that may eventually be received 0152 by the buying actor 0100. The selling actor 0102 may have the ability to be configured 0250 via various mechanisms such as templates, policies,

Application Programming Interface API on how the selling actor 0102 may interact with buying actors or 3^{rd} party selling actors. The selling actor 0102 may match the buying actor 0100 location with 3^{rd} party selling actors in the proximity of the buying actor 0100 location. In the process of generating direct dynamic offers and selling products and services the selling actor 0102 may delegate the entire process or part of the process of generating direct dynamic offers and selling products and services to 3^{rd} party selling actors.

In further detail, still referring to the invention of FIG. 8, the selling actor 0102 may have the ability to allow manual human intervention to process information transmitted 0150 by the buying actor 0100, or the information configured 0250 may allow a fully automated process. The configuration information may be stored on the selling actor 0102 computer implemented system or it may be accessed by the selling actor 0102 computer implemented system and used 0254 to generate dynamic offers. The selling actor 0102 may have the ability to use 0254 information transmitted 0150 by the buying actor 0100, configuration information 0250 and other information available to the selling actor 0102 computer implemented system to generate dynamic offers.

Still referring to the invention of FIG. 8, the selling actor 0102 may use different components and subsystems in any suitable order in the process of generating direct dynamic offers. The steps part of the process of generating direct dynamic offers and selling products and services may include:
configuring 0250 the selling actor 0102,
the selling actor 0102 using the configuration 0254,
the selling actor 0102 calculating 0552 analytics,
the selling actor 0102 using 0554 the analytics result,
   the selling actor 0102 modifying 0352 direct dynamic offers key differentiating factors,
the selling actor 0102 calculating 0652 a ranking score,
the selling actor 0102 using 0654 the ranking score,
the selling actor 0102 using resolution services such as location resolution or IP resolution,
the selling actor 0102 delegating part of the process of generating dynamic offers and selling products and services to 3^{rd} party selling actors,
the selling actor 0102 accessing databases and inventory systems,
the selling actor 0102 validating the buying actor 0100 information with external entities such as financial institutions,
the selling actor logging, auditing, reporting information.

Still referring to the invention of FIG. 8, the exemplary steps part of the process of generating direct dynamic offers and selling products and services may be executed by the selling actor 0102 or 3^{rd} party selling actors synchronous, asynchronous, in parallel. These steps may be executed recursively or in a loop where every iteration may contain zero or more steps, for every iteration the steps may be the same or different compared with previous steps, also those steps may be used as sub-steps of other steps, or may be split into sub-steps that are executed at different times.

Still referring to the invention of FIG. 8, the selling actor 0102 may generate a set of zero or more direct dynamic offers that may be sent 0152 to the buying actor 0100 in response to the transmitted set of data 0150 or may be sent at a different time without requiring the buying actor 0100 to transmit 0150 any data to the selling actor 0102. The direct dynamic offers may be received 0152 by the buying actor 0100, together in a single batch, or they may be received 0152 in multiple batches, each batch containing partial information. The buying actor 0100 may have the ability to complete transactions associated with received 0152 direct dynamic offers with the selling actor 0102 online or offline, or with a 3^{rd} party selling actor online or offline. If the transaction was completed with a 3^{rd} party selling actor, the buying actor 0100 may have the ability to certify to the selling actor 0102 that the transaction was completed, the 3^{rd} party selling actor involved in the transaction may itself have the ability to certify to the selling actor 0102 that the transaction was completed. In such cases the selling actor 0102 may offer incentives to the buying actor 0102 or 3^{rd} party selling actor. The selling actor 0102 may have the ability to execute in parallel multiple processes of generating direct dynamic offers and selling products and services for buying actors. The process of generating direct dynamic offers may happen on a single physical machine or in a distributed system possibly spanning across multiple geographic locations, cloud platforms or data centers, diverse hosting platforms.

Still referring to the invention of FIG. 8, as an example, we may consider a scenario when the buying actor 0100 holding a mobile device is in the ACME TV SHOP. The buying actor 0100 is interested in purchasing a TV. The buying actor 0100 browses the offers provided by the ACME TV SHOP selling actor, and decides for ABC TV product. The ABC TV product is offered by the ACME TV SHOP at the price of 299 $ bundled with a free 1 month MOVIEOFLIX subscription, an estimated perceived buying actor value of 8 $. The buying actor 0100 at this point may have an estimated baseline for ABC TV at the price of 291 $. The buying actor 0100 contacts the selling actor 0102 computer implemented system via its mobile device, transmitting 0150 information such as, but not restricted to, location, product info, product name, product bar-code, and the price baseline, in our example 299 $ or 291 $. The selling actor 0102 computer implemented system receives this information, and may have the ability to calculate a trust score based on it, current and historical information about the product, about the buying actor 0100 and about the buying actor 0100 location. The selling actor 0102 computer implemented system may have the ability to use the location received from the buying actor 0100 to determine if a set of dynamic offers could be made for that location, and if so it may generate a set of dynamic offers, for example based on information configured 0250 by 3^{rd} party selling actors. For example in our case the generated set of dynamic offers may contain an exact product match, the ABCTV bundled with extended warranty. For example, a 3^{rd} party selling actor may have the ability to define a policy for selling actor 0102, describing how to generate offers for ABCTV for 260 $ in Washington state and 280 $ in California on behalf of the 3^{rd} party selling actor. The 3^{rd} party selling actor may have the ability to configure the selling actor 0102 computer implemented system to generate offers with 10% discount for the ABCTV price specified by the buying actor 0100 if that price transmitted 0150 by the buying actor 0100 is above 300 $.

### XVI. Exemplary Direct Notification Dynamic Offers

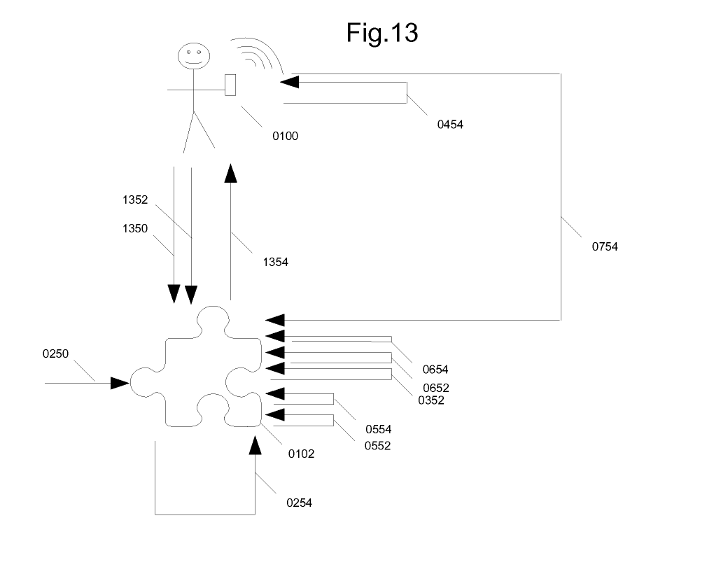

Referring now to the invention in more detail, in FIG. 13, there is shown an exemplary view of the interaction between a buying actor 0100 and a selling actor 0102 on the present invention. The buying actor 0100 predefine a set of conditions 1350 used by the selling actor 0102 to notify 1354 the buying actor 0100. The buying actor 0100 may transmit 1352 to the selling actor 0102 a set of data comprising one or more parameters related to buying actor 0100 location. The selling actor 0102 uses the set of data transmitted 1352 by the buying actor 0100 and the predefined set of conditions 1350 to generate a set of direct notification dynamic offers. The selling actor 0102 notifies 1354 the buying actor 0100 about the set of dynamic offers. The selling actor 0102 may have the ability to allow other 3^{rd} party selling actors or itself 0102 to configure 0250 the selling actor 0102. The selling actor 0102 may use 0254 this configuration 0250 and the set of data transmitted 1352 by the buying actor 0102 to generate direct notification dynamic offers that the buying actor may be notified 1354. The selling actor 0102 may use a subsystem to calculate analytics 0552 using any subset of configuration 0250, data transmitted 1352, any other information available to the selling actor 0102. The selling actor 0102 may use 0554 the results of the analytics subsystem to generate the direct notification dynamic offers. The selling actor 0102 may use the analytics subsystem or a different subsystem to modify 0352 the direct notification dynamic offers key differentiating factors. The selling actor 0102 may calculate a ranking score 0652 and may be using the ranking score 0654 to modify the set of direct notification dynamic offers. The buying actor 0100 may have the ability to present 0454 the direct notification dynamic offers on its mobile device. The buying actor 0100 may have the ability to complete online 0754 a transaction associated with zero or more direct notification dynamic offers part of the received notifications 1354.

In more detail, still referring to the invention of FIG. 13, the selling actor 0102 may have the ability to be configured 0250 via various mechanism such as templates, policies, services, API on how the selling actor 0102 will use 0254 the information transmitted 1352 by the buying actor 0100 to generate direct notification dynamic offers, that may be used to notify 1354 the buying actor 0100. The selling actor 0102 may have the ability to be configured 0250 via various mechanisms such as templates, policies, Application Programming Interface API on how the selling actor 0102 will interact with buying actors or other selling actors. The selling actor 0102 may match buying actor 0100 location with 3^{rd} party selling actors in the proximity of buying actor 0100 location. In the process of generating direct notification dynamic offers and selling products and services the selling actor 0102 may delegate the entire process or part of the process to 3^{rd} party selling actors. The buying actor 0100 may have the ability to configure 1350 the selling actor 0102 via various mechanisms such as templates, policies, services, API describing its interests. The configuration 1350 information may be stored on the selling actor 0102 computer implemented system or it may be accessed by the selling actor 0102 computer implemented system and used 0254 to generate direct notification dynamic offers. The buying actor 0100 transmits 1352 to the selling actor 0102 a set of data comprising one or more parameters related to buying actor 0100 location and the selling actor 102 may use this information to generate the set of direct notification dynamic offers. The selling actor 0102 may notify 1354 the buying actor 0100 as a response to information 1352 transmitted by the buying actor 0100. The selling actor 0102 may notify 1354 the buying actor 0100 without the buying actor 0100 transmitting 1352 any set of data. The selling actor 0102 may have the ability to store information related to location received 1352 from the buying actor 0100. The selling actor 0102 may have the ability use, for example, a subset of the last location information related to the buying actor 0100 to generate the set of direct notification dynamic offers. The selling actor 0102 may also have the ability to notify 1354 the buying actor even on situations where buying actor 0100 didn't transmit any information related to location to the selling actor 0102.

In further detail, still referring to the invention of FIG. 13, the selling actor 0102 may have the ability to allow manual human intervention to process information transmitted 1352 by the buying actor 0100, or the information configured 0250 may allow a fully automated process. The configuration information may be stored on the selling actor 0102 computer implemented system or it may be accessed by the selling actor 0102 computer implemented system and used 0254 to generate dynamic offers. Selling actor 0102 may have the ability to use 0254 information transmitted 1352 by the buying actor 0100, configuration information 0250 and other information available to the selling actor 0102 computer implemented system to generate direct notification dynamic offers.

Still referring to the invention of FIG. 13, the selling actor 0102 may use different components and subsystems in any suitable order in the process of generating direct notification dynamic offers. The set of steps part of the process of generating direct notification dynamic offers and selling products and services may include:
configuring 0250 the selling actor 0102,
the selling actor 0102 using the configuration 0254,
the selling actor 0102 using the configuration 1350,
the selling actor 0102 calculating 0552 analytics,
the selling actor 0102 using 0554 the analytics result,
the selling actor 0102 modifying 0352 direct notification dynamic offers key differentiating factors,
the selling actor 0102 calculating 0652 a ranking score,
the selling actor 0102 using 0654 the ranking score,
the selling actors 0102 using resolution services such as location resolution or IP resolution,
the selling actor 0102 delegating part of execution to 3^{rd} party selling actors,
the selling actor 0102 accessing databases and inventory systems,
the selling actor 0102 validating buying actor information with external entities such as financial institutions,
logging, auditing, reporting.

Still referring to the invention of FIG. 13, the exemplary steps part of the process of generating direct notification dynamic offers and selling products and services may be executed by the selling actor 0102 or 3^{rd} party selling actors synchronous, asynchronous, in parallel. These steps may be executed recursively or in a loop where every iteration may contain zero or more steps, for every iteration the steps may be the same or different compared with previous steps, also those steps may be used as sub-steps of other steps, or may be split into sub-steps that are executed at different times. The selling actor 0102 may generate a set of zero or more direct notification dynamic offers that may be notified 1354 to the buying actor 0100 in response to the transmitted set of data 1352 or may be sent at a different time without requiring the buying actor 0100 to transmit 1352 any data to the selling actor 0102. The direct notification dynamic offers may be notified 1354 by the buying actor 0100, together in a single batch, or they may be received 0152 in multiple batches. Each batch containing partial information. The buying actor 0100 may have the ability to complete transactions associated with notified 1354 direct notification dynamic offers with the selling actor 0102 online or offline, or with a 3^{rd} party selling actor online or offline. In case the buying actor 0100 completed with a 3^{rd} party selling actor a transaction online or offline the buying actor 0100 may have the ability to certify to the selling actor 0102 that the transaction was completed, the 3^{rd} party selling actor involved in the transaction may itself have the ability to certify to the selling actor 0102 that the transaction was completed. In such cases the selling actor 0102 may offer incentives to the buying actor 0102 or 3^{rd} party selling actor. The selling actor 0102 may have the ability to execute in parallel multiple processes of generating direct notification dynamic offers and selling products and services for buying actors. The process of generating direct notification dynamic offers may happen on a single physical machine or in a distributed system possibly spanning across multiple geographic locations, cloud platforms or data centers, diverse hosting platforms.

### XVII. Exemplary Indirect Dynamic Offer Scenarios

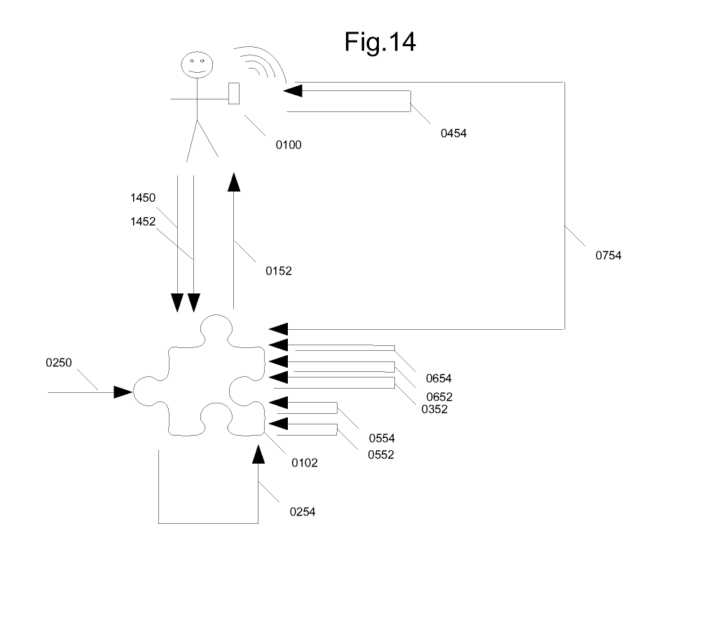

Referring now to the invention in more detail, in FIG. 14, there is shown an exemplary view of the interaction between a buying actor 0100 and the selling actor 0102 on the present invention. The buying actor 0100 expresses indirect interest by predefining conditions 1450 used by selling actor 0102 to match products or services provided by the selling actor 0102. The buying actor 0100 may transmit 1452 to the selling actor 0102 a set of data, wherein the set of data comprises of one or more parameters related to location. The selling actor 0102 uses the set of data transmitted 1452 by the buying actor 0100 to generate a set of indirect dynamic offers. The buying actor 0100 receives 0152 the set of indirect dynamic offers from the selling actor 0102. The selling actor 0102 may have the ability to allow other 3^{rd} party selling actors or itself 0102 to configure 0250 the selling actor 0102. The selling actor 0102 may use 0254 this configuration 0250 and the predefined conditions 1450 and the set of data transmitted 1452 by the buying actor 0102 to generate indirect dynamic offers that the buying actor may receive 0152. The selling actor 0102 may use a subsystem to calculate analytics 0552 using any subset of configuration 0250 predefined conditions 1450 data transmitted 1452 and any other information available to the selling actor 0102. The selling actor 0102 may use 0554 the results of the analytics subsystem to generate the indirect dynamic offers. The selling actor 0102 may use the analytics subsystem or a different subsystem to modify 0352 the indirect dynamic offers key differentiating factors. The selling actor 0102 may calculate a ranking score 0652 and may be using the ranking score 0654 to modify the set of indirect dynamic offers. The buying actor 0100 may have the ability to present 0454 the received 0152 indirect dynamic offers on the buying actor 0100 mobile device. The buying actor 0100 may have the ability to complete online 0754 a transaction associated with zero or more indirect dynamic offers part of the received 0152 indirect dynamic offers.

In more detail, still referring to the invention of FIG. 14, the buying actor 0100 may have the ability to configure 1450 the selling actor 0102 via various mechanisms such as templates, policies, services, API describing its indirect interests. The configuration 1450 information may be stored on the selling actor 0102 computer implemented system or it may be accessed by the selling actor 0102 computer implemented system and used 0254 to generate indirect dynamic offers. The selling actor 0102 may match buying actor 0100 location with 3^{rd} party selling actors in the proximity of buying actor 0100 location. In the process of generating indirect dynamic offers and selling products and services the selling actor 0102 may delegate the entire process or part of the process to 3^{rd} party selling actors.

In further detail, still referring to the invention of FIG. 14, the buying actor 0102 may transmit the predefined conditions 1450 together with the transmitted set of data 1452 however the buying actor may transmit the predefined set of conditions at a different time. For example the buying actor 0100 may configure 1450 the selling actor 0100 prior to transmitting 1452 the set of data. The buying actor 0100 may configure 1450 the selling actor 0102 subsystems using other means instead of its mobile device such as but not restricted to desktop computers, laptops or any other hardware or software system capable of interacting with the selling actor 0102 subsystems.

Still referring to the invention of FIG. 14, the selling actor 0102 may use different components and subsystems in any suitable order in the process of generating indirect dynamic offers. The steps part of the process of generating indirect dynamic offers and selling products and services may include:
configuring 0250 the selling actor 0102,
selling actor 0102 using the configuration 0254,
selling actor 0102 calculating 0552 analytics,
selling actor 0102 using 0554 the analytics result,
selling actor 0102 modifying 0352 indirect dynamic offers key differentiating factors,
selling actor 0102 calculating 0652 a ranking score, using 0654 the ranking score,
using resolution services such as location resolution or IP resolution,
delegating part of execution to 3^{rd} party selling actors,
accessing databases and inventory systems,
validating buying actor information with external entities such as financial institutions,
logging, auditing, reporting.

Still referring to the invention of FIG. 14, the exemplary steps part of the process of generating indirect dynamic offers and selling products and services by the selling actor 0102 or 3^{rd} party selling actors may be executed synchronous, asynchronous, in parallel. These steps may be executed recursively or in a loop where every iteration may contain zero or more steps, for every iteration the steps may be the same or different compared with previous steps, also those steps may be used as sub-steps of other steps, or may be split into sub-steps that are executed at different times. The selling actor 0102 may generate a set of zero or more indirect dynamic offers that may be received 0152 by the buying actor 0100 in response to the transmitted set of data 1452 or may be sent at a different time without requiring the buying actor 0100 to transmit 1450 any data to the selling actor 0102. The indirect dynamic offers may be received 0152 by the buying actor 0100, together in a single batch, or they may be received 0152 in multiple batches, each batch containing partial information. The buying actor 0100 may have the ability to complete transactions associated with received 0152 indirect dynamic offers with the selling actor 0102 online or offline, or with a 3^{rd} party selling actor online or offline. In case the buying actor 0100 completed a transaction with a 3^{rd} party selling actor, the buying actor 0100 may have the ability to certify to the selling actor 0102 that the transaction was completed, the 3^{rd} party selling actor involved in the transaction may itself have the ability to certify to the selling actor 0102 that the transaction was completed. In such cases the selling actor 0102 may offer incentives to the buying actor 0102 or 3^{rd} party selling actor. The selling actor 0102 may have the ability to execute in parallel multiple processes of generating indirect dynamic offers and selling products and services. The process of generating indirect dynamic offers may happen on a single physical machine or in a distributed system possibly spanning across multiple geographic locations, cloud platforms or data centers, diverse hosting platforms.

As an example, still referring to the invention of FIG. 14, the buying actor 0100 may configure 1450 the selling actor 0102 expressing indirect interest such as “Hiking boots under 20$ preferably brand X”. When the buying actor 0100 transmits 1452 to the selling actor a set of data comprising information about hiking boots or comprising information about brand X, or comprising information about location where products of brand X are available, or comprising any information the selling actor 0102 analytics subsystems may associate with configuration information 1450, the buying actor may receive 0152 from the selling actor 0102 indirect dynamic offers related to items the selling actor 0102 is interested in selling such as “Hiking boots for 15$”, “Hiking boots brand X for 17$”, “Hiking pants brand X 20$”.

### XVIII. Exemplary Indirect Notification Dynamic Offers

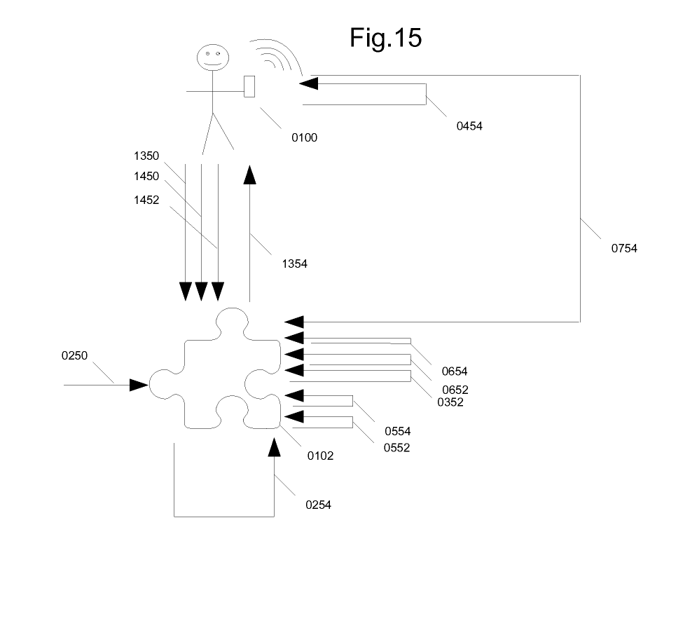

Referring now to the invention in more detail, in FIG. 15, there is shown an exemplary view of the interaction between a buying actor 0100 and a selling actor 0102 on the present invention. The buying actor 0100 predefines a set of conditions 1350 used by the selling actor 0102 to notify 1354 the buying actor 0100. The buying actor 0100 expresses indirect interest by predefining conditions 1450 used by selling actor 0102 to match products or services provided by the selling actor 0102. The buying actor 0100 may transmit 1452 to the selling actor 0102 a set of data, wherein the set of data comprises of one or more parameters related to location. The selling actor 0102 uses the set of data transmitted 1452 by the buying actor 0100 to generate a set of indirect notification dynamic offers. The selling actor 0102 uses the set of data transmitted 1452 by the buying actor 0100 and the predefined set of conditions 1450 and the predefined set of conditions 1350 to generate a set of indirect notification dynamic offers. The buying actor 0100 is notified 1354 about the set of indirect notification dynamic offers by the selling actor 0102. The selling actor 0102 may have the ability to allow itself or other 3^{rd} party selling actors to configure 0250 the selling actor 0102. The selling actor 0102 may use 0254 this configuration 0250, the predefined conditions 1450, and the set of data transmitted 1452 by the buying actor 0102 to generate indirect notification dynamic offers that the buying actor may be notified 1354 about. The selling actor 0102 may use a subsystem to calculate analytics 0552 using any subset of configuration 0250, data transmitted 1452, and any other information available to the selling actor 0102. The selling actor 0102 may use 0554 the results of the analytics subsystem to generate the indirect notification dynamic offers. The selling actor 0102 may use the analytics subsystem or a different subsystem to modify 0352 the indirect notification dynamic offers key differentiating factors. The selling actor 0102 may calculate a ranking score 0652 and may be using the ranking score 0654 to modify the set of indirect notification dynamic offers. The buying actor 0100 may have the ability to present 0454 the notified 1354 indirect notification dynamic offers on its mobile device. The buying actor 0100 may have the ability to complete online 0754 a transaction associated with zero or more indirect notification dynamic offers part of the notified 1354 indirect notification dynamic offers.

In more detail, still referring to the invention of FIG. 15, the buying actor 0100 may have the ability to configure the selling actor 0102 1450 via various mechanisms such as templates, policies, services, API describing its indirect interests. The configuration information 1450 may be stored on the selling actor 0102 computer implemented system or it may be accessed by the selling actor 0102 computer implemented system and used 0254 to generate indirect notification dynamic offers. In the process of generating indirect notification dynamic offers and selling products and services the selling actor 0102 may delegate the entire process or part of the process to 3^{rd} party selling actors. The selling actor 0102 may match the buying actor 0100 location with 3^{rd} party selling actors in the proximity of buying actor 0100 location. The buying actor 0100 may have the ability to configure 1350 via various mechanisms such as templates, policies, services, API the selling actor 0102 describing its interests to be notified. The configuration 1350 information may be stored on the selling actor 0102 computer implemented system or it may be accessed by the selling actor 0102 computer implemented system and used 0254 to generate indirect notification dynamic offers. The buying actor 0100 transmits 1452 to the selling actor 0102 a set of data comprising one or more parameters related to buying actor 0100 location and the selling actor 102 may use this information to generate the set of indirect notification dynamic offers. The selling actor 0102 may notify 1354 the buying actor 0100 in response to information transmitted 1452 by the buying actor 0100. The selling actor 0102 may notify 1354 the buying actor 0100 without the buying actor 0100 transmitting 1452 any set of data. The selling actor 0102 may have the ability to store the information transmitted 1452 related to location. The selling actor 0102 may use for example a subset of the last location information related to the buying actor 0100 in the process of generating the set of indirect notification dynamic offers. The selling actor 0102 may also have the ability to notify 01354 the buying actor even on situations where buying actor 0100 didn't transmit any information related to location to the selling actor 0102.

In further detail, still referring to the invention of FIG. 15, the selling actor 0102 may have the ability to allow manual human intervention to process information transmitted 1452 by the buying actor 0100, or the information configured 0250, the selling actor 0102 may allow a fully automated process. The configuration information may be stored on the selling actor 0102 computer implemented system or it may be accessed by the selling actor 0102 computer implemented system and used 0254 to generate dynamic offers. The selling actor 0102 may have the ability to use 0254 information transmitted 1452 by the buying actor 0100, configuration information 0250, configuration information 1350, configuration information 1450 and other information available to the selling actor 0102 computer implemented system in the process of generating indirect notification dynamic offers. The buying actor 0100 may transmit the predefined conditions 1450 together with the transmitted set of data 1452 however the buying actor may transmit the predefined set of conditions at a different time for example the buying actor 0100 may configure 1450 the selling actor 0100 prior to transmitting 1452 the set of data. The buying actor 0100 may configure 1450 the selling actor 0102 subsystems using other means instead of its mobile device such as but not restricted to desktop computers, laptops or any other hardware or software system capable of interacting with the selling actor 0102 subsystems.

Still referring to the invention of FIG. 15, the selling actor 0102 may use different components and subsystems in any suitable order in the process of generating indirect notification dynamic offers. The steps part of the process of generating indirect notification dynamic offers and selling products and services may include:
configuring 0250 the selling actor 0102,
the selling actor 0102 using the configuration 0254,
the selling actor 0102 using the configuration 1350,
the selling actor 0102 using the configuration 1450,
the selling actor using the transmitted data 1452,
the selling actor 0102 calculating 0552 analytics,
the selling actor 0102 using 0554 the analytics result,
the selling actor 0102 modifying 0352 indirect notification dynamic offers key differentiating factors,
the selling actor 0102 calculating 0652 a ranking score,
the selling actor 0102 using 0654 the ranking score,
the selling actor 0102 using resolution services such as location resolution or IP resolution,
the selling actor 0102 delegating part or the entire process of generating dynamic offers and selling products and services to 3^{rd} party selling actors,
accessing databases and inventory systems,
validating buying actor information with external entities such as financial institutions,
logging, auditing, reporting.

Still referring to the invention of FIG. 15, the exemplary steps part of the process of generating indirect notification dynamic offers and selling products and services by the selling actor 0102 or 3^{rd} party selling actors may be executed synchronous, asynchronous, in parallel. These steps may be executed recursively or in a loop where every iteration may contain zero or more steps, for every iteration the steps may be the same or different compared with previous steps, also these steps may be used as sub-steps of other steps, or may be split into sub-steps that are executed at different times. The selling actor 0102 may generate a set of zero or more indirect notification dynamic offers that may be notified 1354 to the buying actor 0100 in response to the transmitted set of data 1452 or may be sent at a different time without requiring the buying actor 0100 to transmit 1452 any data to the selling actor 0102. The selling actor 0102 may notify 1354 the buying actor 0100 about the indirect notification dynamic offers, in a single batch, or the information may be sent as notification in multiple batches, each batch containing partial information. The buying actor 0100 may have the ability to complete transactions associated with indirect notification dynamic offers with the selling actor 0102 online or offline, or with a 3^{rd} party selling actor online or offline. In case the buying actor 0100 completed a transaction with a 3^{rd} party selling actor, the buying actor 0100 may have the ability to certify to the selling actor 0102 that the transaction was completed, the 3^{rd} party selling actor involved in the transaction may itself have the ability to certify to the selling actor 0102 that the transaction was completed. In such cases the selling actor 0102 may offer incentives to the buying actor 0102 or 3^{rd} party selling actor. The selling actor 0102 may have the ability to execute in parallel multiple processes of generating indirect notification dynamic offers and selling products and services for buying actors. The process of generating indirect notification dynamic offers may happen on a single physical machine or in a distributed system possibly spanning across multiple geographic locations, cloud platforms or data centers, diverse hosting platforms.

### XIX. Exemplary Inferred Dynamic Offers

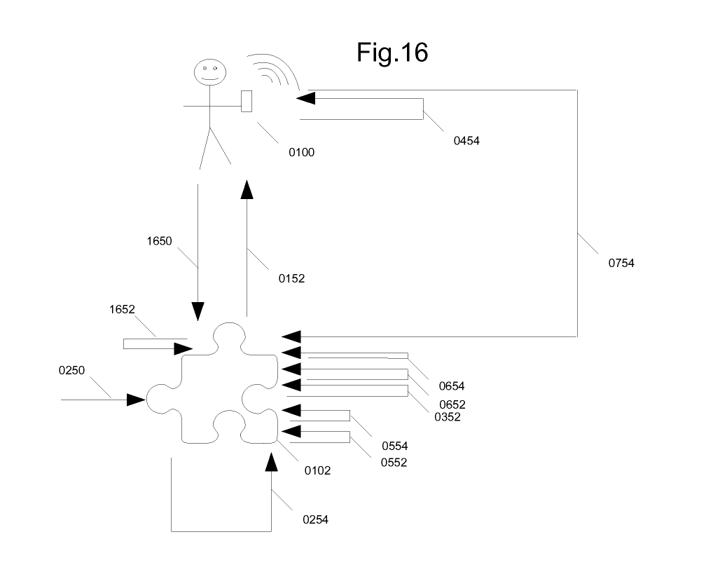

Referring now to the invention in more detail, in FIG. 16, there is shown an exemplary view of the interaction between a buying actor 0100 and a selling actor 0102 on the present invention. The buying actor 0100 transmits 1650 to the selling actor 0102 a set of data comprising one or more parameters related to products or services, one or more parameters related to the location. The selling actor 0102 may have the ability to infer 1652 price information for products and services associated with the inferred dynamic offers. The selling actor 0102 is using the data transmitted 1650 and the inferred 1652 price information to generate a set of inferred dynamic offers. The buying actor 0100 receives 0152 the set of inferred dynamic offers from the selling actor 0102. The selling actor 0102 may have the ability to allow other 3^{rd} party selling actors or itself 0102 to configure 0250 the selling actor 0102. The selling actor 0102 may use 0254 this configuration 0250 and the set of data transmitted 1650 by the buying actor 0102 to generate inferred dynamic offers that the buying actor may receive 0152. The selling actor 0102 may use a subsystem to calculate analytics 0552 using any subset of configuration 0250, data transmitted 1650, and any other information available to the selling actor 0102. The selling actor 0102 may use 0554 the results of the analytics subsystem to generate the inferred dynamic offers. The selling actor 0102 may use the analytics subsystem or a different subsystem to modify 0352 the inferred dynamic offers key differentiating factors. The selling actor 0102 may calculate a ranking score 0652 and may use the ranking score 0654 to modify the set of inferred dynamic offers that the buying actor 0100 is receiving 0152 from the selling actor 0102. The buying actor 0100 may have the ability to present 0454 the received 0152 inferred dynamic offers on its mobile device. The buying actor 0100 may have the ability to complete online 0754 a transaction associated with zero or more inferred dynamic offers part of the received 0152 inferred dynamic offers.

In more detail, still referring to the invention of FIG. 16, the selling actor 0102 may have the ability to be configured 0250 via various mechanism such as templates, policies, services, API on how the selling actor 0102 will use 0254 the information transmitted 1650 by the buying actor 0100 and the information inferred 1652 to generate inferred dynamic offers. The selling actor 0102 may have the ability to be configured 0250 via various mechanisms such as templates, policies, Application Programming Interface API on how the selling actor 0102 will interact with buying actors or other selling actors. The selling actor 0102 may match buying actor 0100 location with 3^{rd} party selling actors in the proximity of buying actor 0100 location. In the process of generating inferred dynamic offers and selling products and services the selling actor 0102 may delegate the entire process or part of the process of generating inferred dynamic offers to 3^{rd} party selling actors. The selling actor 0102 may use other information about price information available to the selling actor 0102 related to information transmitted 1650. For example such information may be information received by the selling actor 0102 from mobile device holders related to price information about products or services associated with information transmitted 1650 by the buying actor 0100. The selling actor 0102 also may use various subsystems and components such as an analytical subsystem to infer 1652 price information for products and services related to information transmitted 1650 by the buying actor 0100. The selling actor 0102 may also use previously acquired proximity acquired information, historical information regarding accepted or rejected dynamic offers. The selling actor 0102 may use 3^{rd} party subsystems, including subsystems associated 3^{rd} party selling actors that interface with the selling actor 0102 to infer 1652 the price information related to information transmitted 1650 by the buying actor 0100. Also the selling actor 0102 may use a combination of methods such as the above to infer 1652 price information. The quality of the inferred 1652 price information may vary, and the inferred 1652 price information may be an estimated price, or it may be an exact price. Also the degree of confidence that the selling actor 0102 mat have in the inferred 1652 price information may vary, and for example may reach very high levels of confidence when the buying actor 0100 is in the physical store of a 3^{rd} party selling actor that interfaces with the selling actor 0102. The selling actor 0102 may have the ability to take into account the quality of the inferred 1652 price information, the degree of confidence and analytical and statistical information, such as mean values and standard deviation, in the process of generating inferred dynamic offers.

In further detail, still referring to the invention of FIG. 16, the selling actor 0102 may have the ability to allow manual human intervention to process information transmitted 1650 by the buying actor 0100 and infer 1652 price information, or the information configured 0250 may allow a fully automated process. The configuration information may be stored on the selling actor 0102 computer implemented system or it may be accessed by the selling actor 0102 computer implemented system and used 0254 to generate inferred dynamic offers. The selling actor 0102 may have the ability to use 0254 information transmitted 1650 by the buying actor 0100, configuration information 0250 and other information available to the selling actor 0102 computer implemented system to generate inferred dynamic offers.

Still referring to the invention of FIG. 16, the selling actor 0102 may use different components and subsystems in any suitable order in the process of generating inferred dynamic offers. The steps part of the process of generating inferred dynamic offers and selling products and services may include:
configuring 0250 the selling actor 0102,
selling actor 0102 using the configuration 0254,
the selling actor 0102 inferring 1652 price information,
the selling actor 0102 calculating 0552 analytics,
the selling actor 0102 using 0554 the analytics result,
the selling actor 0102 modifying 0352 inferred dynamic offers key differentiating factors,
the selling actor 0102 calculating 0652 a ranking score,
the selling actor 0102 using 0654 the ranking score,
the selling actor 0102 using resolution services such as location resolution or IP resolution,
the selling actor 0102 delegating part of execution to 3^{rd} party selling actors,
the selling actor 0102 accessing databases and inventory systems,
the selling actor 0102 validating buying actor information with external entities such as financial institutions,
logging, auditing, reporting.

Still referring to the invention of FIG. 16, the exemplary steps part of the process of generating inferred dynamic offers and selling products and services may be executed synchronous, asynchronous, in parallel, these steps may be executed recursively or in a loop where every iteration may contain zero or more steps, for every iteration the steps may be the same or different compared with previous steps. These steps may be used as sub-steps of other steps, or may be split into sub-steps that are executed at different times. The selling actor 0102 may generate a set of zero or more inferred dynamic offers that may be sent 0152 to the buying actor 0100 in response to the transmitted set of data 1650 or may be sent at a different time without requiring the buying actor 0100 to transmit 1650 any data to the selling actor 0102. The inferred dynamic offers may be received 0152 by the buying actor 0100, together in a single batch, or they may be received 0152 in multiple batches, each batch containing partial information. The buying actor 0100 may have the ability to complete transactions associated with received 0152 inferred dynamic offers with the selling actor 0102 online or offline, or with a 3^{rd} party selling actor online or offline. In case the buying actor 0100 completed a transaction with a 3^{rd} party selling actor the buying actor may have the ability to certify to the selling actor 0102 that the transaction was completed, the 3^{rd} party selling actor involved in the transaction may itself have the ability to certify to the selling actor 0102 that the transaction was completed. In such cases the selling actor 0102 may offer incentives to the buying actor 0102 or 3^{rd} party selling actor. The selling actor 0102 may have the ability to execute in parallel multiple processes of generating inferred dynamic offers and selling products and services for buying actors. The execution of generating inferred dynamic offers may happen on a single physical machine or in a distributed system possibly spanning across multiple geographic locations, cloud platforms or data centers, diverse hosting platforms.

Still referring to the invention of FIG. 16, as an example, let's consider the scenario where the buying actor 0100 may be in the proximity of, or in a physical shop that is represented by a 3rd party selling actor that interfaces with the selling actor 0102. The selling actor 0102 may have the ability to generate dynamic offers on behalf of the 3^{rd} party selling actors representing the physical shop, based on buying actor 0100 interest and present them on buying actor 0100 mobile device. The following steps may be used as an exemplary scenario:
The buying actor 0100 holding mobile device is in a physical store, owned or operated by a 3rd party selling actor, for example Office-O-Mart, that interfaces with selling actor 0102;
The buying actor 0100 expresses direct interest in a product or service offered at that location by the 3^{rd} party selling actor, for example the Pic-O-Printer product;
The buying actor 0100 transmits 1650 via the mobile device product information to the selling actor 0102, for example in “location, Pic-O-Printer”.
The selling actor 0102 infers the price information for Pic-O-Printer in this location based on proximity acquired information received from mobile device holders.
The selling actor 0102 generates a dynamic offer, using configuration provided by the 3^{rd} party selling actor and matching buying actor 0100 interests, for example a dynamic offer to “buy Bundle Pic-O-Printer with a glossy paper package and get a 5% discount”.
   The selling actor 0102 computer implemented system may have the ability to return:
Dynamic offers for exact product or service match that buying actor 0100 expressed interest on. For example Pic-O-Printer at a discounted price;
Dynamic offers bundling products or services that buying actor 0100 expressed interest on. For example Pic-O-Printer with glossy paper bundle offered to loyal customers;
Dynamic offers for products or services related with the product or service that buying actor 0100 expressed interest on. For example “cartridge ink for Pic-O-Printer 10% off”;
Coupons for products or services.

Still referring to the exemplary scenario above, the selling actor 0102 in this exemplary scenario may have the ability to infer the price for the Pic-O-Printer in the proximity of Office-O-Mart through an interface between the selling actor 0102 and the 3^{rd} party selling actor. In a different scenario the selling actor 0102 may infer the price for a product or service by analyzing historical information about the product or service in the proximity of buying actor 0100 location, for example by noticing that other buying actors accepted dynamic offers for the product or service in the proximity of the buying actor 0100 at a certain price, but rejected dynamic offers for the same product or service in the proximity of buying actor at a higher price. In a different scenario the selling actor 0102 may infer the price for a product or service by accessing proximity acquired information from mobile device holders that received incentives from selling actor 0102 in exchange for information regarding the price of the product or service at buying actor 0100 location. In a different scenario the selling actor 0102 may infer the price for products or services by accessing an external subsystem provided by a 3^{rd} party that offers information regarding estimated prices for products or services in the proximity of the buying actor 0100 location.

### XX. Exemplary Proximity Acquired Information and Incentives

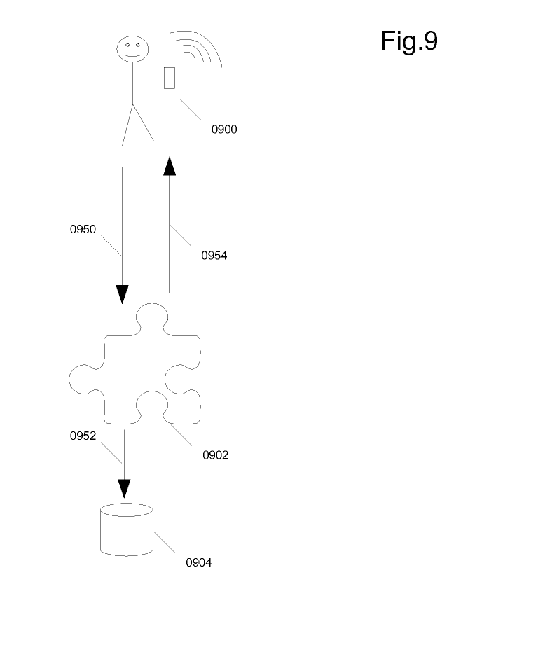

Referring now to the invention in more detail, in FIG. 9 there is shown an exemplary view of the interaction between a mobile device holder 0900 and a selling actor 0902 of the present invention. The mobile device holder 0900 transmits 0950 to the selling actor 0902 a set of data comprising one or more parameters related to products or services, one or more parameters related to the products or services price, one or more parameters related to location. The selling actor 0902 receives the set of data transmitted 0950 and may have the ability to store 0952 it on a persistent storage 0904. The selling actor 0902 may have the ability to transmit 0954 incentives to mobile device holder 0900.

In more detail, still referring to the invention of FIG. 9, the mobile device holder 0900 is using its mobile device to acquire information about products and services in its proximity. The mobile device holder 0900 may have the ability to transmit 0950 via its mobile device a set of data comprising one or more parameters related to products or services, one or more parameters related to products or services price, one or more parameters related to location. The information transmitted 0950 may comprise one or more parameters related to selling actor 0902 competition, however this information may be related to products and services unrelated to products and services selling actor or its competition are interested in. The selling actor 0902 computer implemented system may have the ability to receive the information and further may decide to store 0952 it on a persistent storage 0904. The selling actor 0902 may have the ability to transmit 0954 to mobile device holder 0902 incentives usually in response to information transmitted 0950 by the mobile device holder 0900. The selling actor 0902 may have the ability to transmit 0954 incentives to the mobile device holder 0900 not only in response to the information 0950 sent by the mobile device holder 0900 but also on situations where there is no requirement for the mobile device holder 0900 to transmit 0954 any data. For example, such a scenario may be: on occurrences of mobile device holder 0900 transmitting 0950 information, the selling actor may award mobile device holder 0900 points, track how many points a mobile device holder was awarded and transmit 0954 incentive information to the mobile device holder 0900. The selling actor 0902 may have the ability to provide mobile device holder 0900 information about products or services the selling actor 0902 is interested in acquiring information.
the selling actor 0902 may send to the mobile device holder 0900 this information as part of the responses to the information transmitted 0950 by the mobile device holder 0900,
the mobile device holder 0900 may ask the selling actor 0902 to transmit this information,
the selling actor 0902 may notify the mobile device holder and transmit this information
the selling actor 0902 may provide this information to mobile device holder 0900 together with incentives transmitted 0954

In further detail, still referring to the invention of FIG. 9, the selling actor 0902 may have the ability to associate with this information or a subset of it information related to incentives and present it to the mobile device holder 0900.

In further detail, still referring to the invention of FIG. 9, the mobile device holder 0900 may have the ability to acquire products or service information using mobile device sensors, hardware or software components running on its mobile device. For example such sensors could be related to location detection, image capturing, audio capturing, such hardware components could be but are not restricted to NFC chip, Bluetooth, WiFi, Data wireless, Data Connection, Radio, RF, CDMA, GSM, UMTS, TDMA, WCDMA, GPRS, WiFi, 802.11. The selling actor 0902 may have the ability to store 0952 the information sent 0950. For example the selling actor 0952 may use any suitable persistent storage 0904 components such as cloud services or web services that may persist this information, hardware persistent storage devices, flat files, database systems, including but not limited to relational databases, object-oriented databases, NoSQL databases, key-value stores, document oriented databases, XML databases. The selling actor 0902 may have the ability to transmit 0954 incentives to mobile device holder 0900 comprising dynamic offers. The selling actor 0902 may have the ability to transmit 0954 incentives related with financial advantages such as payments, coupons, deals, discounts, points, monetary or financial rewards, bundles, credit, loyalty points, and preferential access to products or services, recurring payments, salary. The selling actor 0902 may have the ability to use information sent 0950 and transmit 0954 incentives to multiple mobile device holders. In some embodiments the selling actor 0902 may offer incentives to the mobile device holder 0900 without sending the incentives over a communication network, instead the mobile device holder 0900 may have an account registered with the selling actor 0902, to which the selling actor may transfer the incentives, such as flat pay, credit, loyalty points, salary.

In further detail, still referring to the invention of FIG. 9, the incentives may be transmitted 0954 by the selling actor 0902 to the mobile device holder 0900, prior to the mobile device holder 0900 sending 0950 the proximity acquired information, as well as after the mobile device holder 0900 sent 0950 the proximity acquired information. The incentives may be vested over time, or vested subject to preconditions.

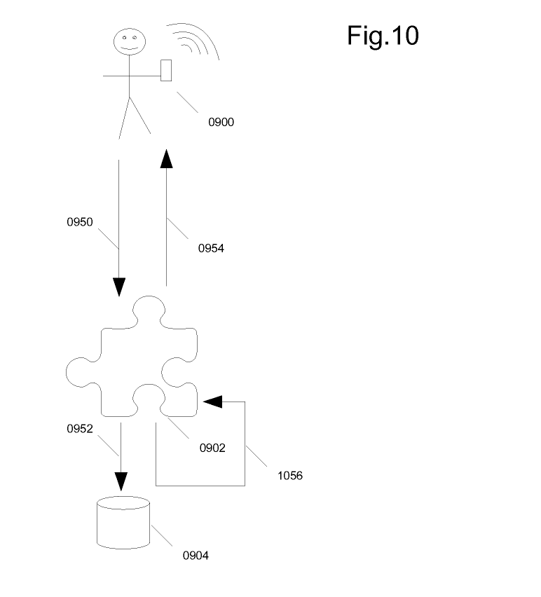

Referring now to the invention in more detail, in FIG. 10 there is shown an exemplary view of the interaction between a mobile device holder 0900 and a selling actor 0902 of the present invention. The mobile device holder 0900 transmits 0950 to the selling actor 0902 a set of data comprising one or more parameters related to products or services, one or more parameters related to the products or services price, one or more parameters related to location. The selling actor 0902 receives the set of data transmitted 0950 and may have the ability to store 0952 it on a persistent storage component 0904. The selling actor 0902 may have the ability to transmit 0954 incentives to mobile device holder 0900. The selling actor 0902 may have the ability to use the information comprising the set of data sent 0950 and information available 0904 and other available information to calculate a trust score 1056. The selling actor 0902 may use the calculated trust score 1056 and use it to decide if the information sent 0950 should be trusted. The selling actor 0902 may use the calculated trust score 1056 to decide if incentives should be sent 1054 to the mobile device holder 0902 and also to determine what incentives should be sent.

In more detail, still referring to the invention of FIG. 10, the calculated trust score 1056 may be associated with the information sent 0950. The selling actor 902 may have the ability to associate the calculated trust score 1056 with a trust score associated with the mobile device holder 0900.

In further detail, still referring to the invention of FIG. 10, the calculated trust score 1056 may be calculated by selling actor 0902 components using historical information about products and services in the proximity of the mobile device holders available to the system such as information received from 3^{rd} party selling actors or information received from other systems and processed further by analytic subsystems. The calculated trust score 1056 may be stored on a persistent storage by the selling actor 0902, may be used subsequently as input for other components. For example the selling actor 0902 may decide if incentives should be transmitted 0954 to the mobile device holder 0900, and what incentives should be transmitted 0954, based on the trust score. The calculated trust score 1056 and the information transmitted 0950 by the mobile device holder 0900 may be used in an analytics process or may be shared with 3^{rd} party selling actors.

In further detail, still referring to the invention of FIG. 10, the selling actor 0902 computer implemented system may have the ability to use information received from mobile devices holder 0900 to detect anomalies and outliers and calculate a trust score 1056. Trust scores can be absolute as well as relative and may be associated with a buying actor, a mobile device holder, a set of information transmitted 0950 by a mobile device holder, as well as with a product or service. The current trust score associated with a mobile device holder 0900 may affect subsequent trust scores for information transmitted 0950 by the mobile device holder 0900.

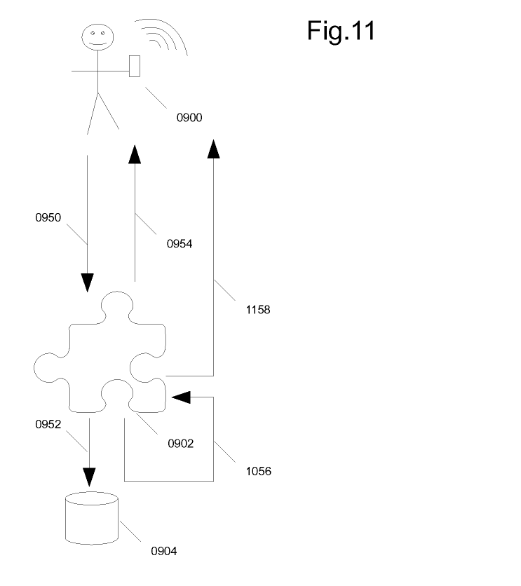

Referring now to the invention in more detail, in FIG. 11 there is shown an exemplary view of the interaction between a mobile device holder 0900 and a selling actor 0902 of the present invention. The mobile device holder 0900 transmits 0950 to the selling actor 0902 a set of data comprising one or more parameters related to products or services, one or more parameters related to the products or services price, one or more parameters related to location. The selling actor 0902 receives the set of data transmitted 0950 and may have the ability to store 0952 it on a persistent storage component 0904. The selling actor 0902 may have the ability to transmit 0954 incentives to mobile device holder 0900. The selling actor 0902 may have the ability to use the information comprising the set of data transmitted 0950 and information available such as information already stored 0904 and other information such as information from 3^{rd} party selling actors to calculate a trust score 1056. The selling actor 0902 may use the calculated trust score 1056 to decide if the information transmitted 0950 by the mobile device holder 0900 should be trusted. The selling actor 0902 may use the trust score to decide if incentives should be transmit 0954 to the mobile device holder 0902 and also to determine what incentives should be sent 0902. The selling actor 0902 may have the ability to ask 1158 the mobile device holder 0900 to provide digital proof.

In more detail, still referring to the invention of FIG. 11, the selling actor 0902 may have the ability to evaluate the calculated trust score 1056 and use the result of this evaluation to decide if digital proof is required. The mobile device holder 0900 may have the ability to transmit to the selling actor 0902 the digital information acquired either online using its mobile device or offline. The selling actor 0902 may have the ability to process automatically the digital proof information received or to allow manual evaluation. The selling actor 0902 may store on a persistent storage 0904 the calculated trust score 1056 and the digital proof received and use it to infer information related to the selling actor 0902 interests.

In further detail, still referring to the invention of FIG. 11, the digital proof could be a picture of the product or item associated with the service, a picture comprising price information, a serial code or a tag number, or any other digital source that the selling actor 0902 may decide to trust, such as information acquired with the mobile device using NFC technology. The selling actor 0902 may have the ability to inform the mobile device holder 0900 on what are the digital sources the selling actor 0902 is trusting. The selling actor 0902 may have the ability to associate coefficient factors with various digital proof sources. The mobile device holder 0900 may have the ability to acquire digital proof information automatically using its mobile device, sensors, and hardware, firmware or software components. The mobile device holder 0900 may have the ability to acquire the digital proof information interacting with other computer implemented systems, for example computer implemented systems run by a selling actor on its proximity with ability to provide digital proof information. The mobile device holder 0900 may have the ability to manually input information. The selling actor 0902 may have the ability to ask mobile device holder 0900 to provide digital proof information in various scenarios such as but not restricted to: for each information transmitted 0950, for sampled information transmitted 0950, for example every 1 in 10 information transmitted 0950 as an illustration. Other examples when digital proof is asked for every information transmitted 0950 or sampled information transmitted 0950 are: for information transmitted 0950 for which the calculated trust score 1156 is too low, for information transmitted 0950 by mobile device holders 0900 with a low trust score.

In further detail, still referring to the invention of FIG. 11, the selling actor 0902 may have the ability to cancel the incentives of dynamic offer subject to digital proof. For example if the mobile device holder 0900 transmits 0950 information about a refrigeration brand X, parameters Y with a price Z and the system may have data received from a plurality of other mobile device holders or buying actors in the proximity of that location about the same product but with a price 20% higher, the selling actor 0902 may ask the mobile device holder 0900 to provide a digital proof such as a picture of the item or a price tag or any other digital source the selling actor 0902 may decide to trust. The selling actor 0902 computer implemented system may have the ability to validate and examine automatically the digital proofs or allow for human supervised verification.

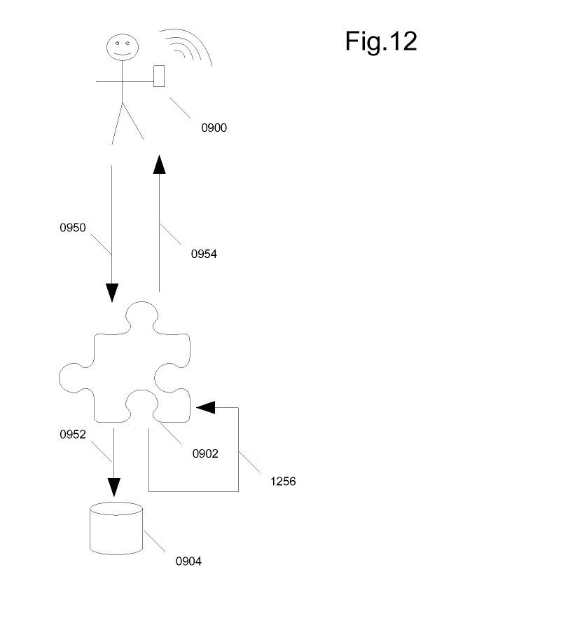

Referring now to the invention in more detail, in FIG. 12 there is shown an exemplary view of the interaction between a mobile device holder 0900 and a selling actor 0902 of the present invention. The mobile device holder 0900 transmits 0950 to the selling actor 0902 a set of data comprising one or more parameters related to products or services, one or more parameters related to the products or services price, one or more parameters related to location. The selling actor 0902 receives the information comprising the set of data transmitted 0950 and may have the ability to store 0952 it on a persistent storage 0904. The selling actor 0902 may have the ability to use the information transmitted 0950 by the mobile device holder 0900 and the information available in the persistent storage 0904, and other information such as analytics or information provided by external entities. The selling actor 0902 may use any subset of these information to validate 1256 the proximity acquired information. The selling actor 0902 may use the validation process to decide if the information transmitted 0950 by the mobile device holder 0900 should be trusted.

In further detail, still referring to the invention of FIG. 12, the validation 1256 process may be executed immediately by the selling actor 0902 computer implemented system or it may be processed at a later time, for example offline. The validation 1256 process may evaluate information transmitted 0950 by multiple mobile device holders. As an example big data processing solutions such as Hadoop, Casandra, ETL, map-reduce, data warehouse and data mining solutions could be used to validate the information transmitted 0950 by the mobile device holder 0900. The selling actor 0902 may have the ability to store 0952 the results of the validation process and use them at a later time in a feedback loop or process them for other purposes by different subsystems.

As an example, still referring to the invention of FIG. 12, the selling actor 0902 may have the ability to share proximity acquired information and analytics with 3^{rd} party information users. The selling actor 0902 may have the ability sell products or services to buying actors. The selling actor 0902 may have the ability to sell to other entities such as other selling actors: proximity acquired information, analytics, historical data, and other byproducts of proximity acquired information. The selling actor 0902 may have the ability to provide information automatically or dynamically to 3^{rd} party selling actors, for example by interfacing with 3^{rd} party selling actors via a server or web service interface so that the 3^{rd} party selling actors can use the information in their own process of generating dynamic offers or of selling products or services. The selling actor 0902 is not restricted to selling products and services to buying actors, in some exemplary embodiments the selling actor 0902 may not sell any products and services to buying actors or may only sell to other entities proximity acquired information or byproducts of proximity acquired information such as historical data and analytics in a processed or unprocessed form. In some embodiments the selling actor 0902 may only collect the proximity acquired information in order to subsequently use it in subsequent processes or businesses unrelated with selling products or services through dynamic offers.

In some exemplary scenarios the selling actor 0902 may have the ability to acquire proximity acquired information from mobile device holders 0900 acting as buying actors, for example if the selling actor 0900 is providing dynamic offers the selling actor 0902 may be able to acquire information about mobile device holder 0900 interests, and mobile device holder 0900 behavior. The selling actor 0900 may have the ability to use this information to optimize any dimensions of their business, such as, but not restricted to, margin, inventory, targeting for marketing campaigns, market share. The selling actor 0900 may have the ability to use this information in the process of generating other dynamic offers, or may sell or may provide this information, analytics, history or byproducts of this information to other selling actors.

### XXI. Exemplary Pricing for Dynamic Offers

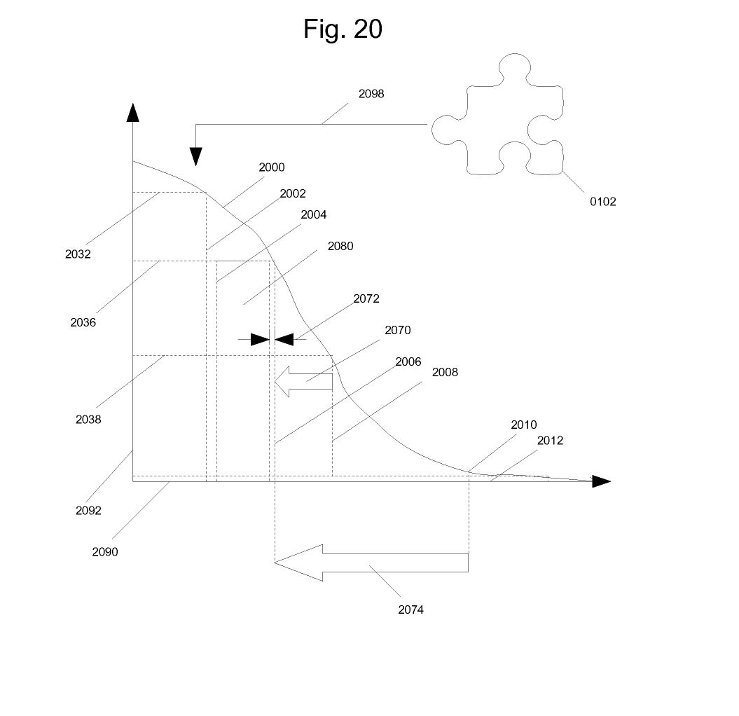

Referring now to the invention in more detail, in FIG. 20, there is shown an exemplary view of the selling actor 0102 using 2098 an exemplary function 2000 in the process of generating price information associated with a dynamic offer. The exemplary function 2000 in this case may be a likelihood function, having as domain 2090 a cost and as co-domain 2092 a score describing the estimated likelihood that a buying actor would eventually purchase a dynamic offer.

In more detail, still referring to the invention of FIG. 20, the exemplary likelihood function 2000 is dynamic offer specific and buying actor specific, meaning that the likelihood functions 2000 is subject of buying actor, of dynamic offer, of location. The likelihood function 2000 may be determined by the selling actor 0102 for example as a result of a step that may be computing analytics, such as data mining or as result of a big data computation. It should be noted that the invention is not restricted at using a dynamically computed likelihood function 2000 to compute the price for products and services associated with a dynamic offer, and that different embodiments may use different methods, including preconfigured functions, or any other suitable algorithm or heuristic, including systems relaying on neural networks, genetic programming, rule engines, simulations or historical information, such as historical prices for which similar dynamic offers were accepted by buying actors in the proximity of buying actor location.

In further detail, still referring to the invention of FIG. 20, the following elements may be identified:
the likelihood function 2000,
the domain 2090 of the likelihood function 2000 represents the cost axis,
the co-domain 2092 represents the likelihood to buy axis,
Buyer Baseline Price BBP 2012,
Buyer Estimated Perceived Baseline Price BEPBP 2010,
Seller Baseline Price 2004, Buyer Estimated Perceived Price BEPP 2002,
Dynamic Offer Price DOP 2006,
Optimized Price For Dynamic Offer OPFDO 2008,
Estimated probability 2032 for buying actor to purchase the dynamic offer at BEPP 2002 price,
Estimated probability 2036 for buying actor to purchase the dynamic offer at DOP 2006 price,
Estimated probability 2038 for buying actor to purchase the dynamic offer at OPFDO 2008 price,
Adjustment 2070,
Operational costs 2072 for generating dynamic offers,
Estimated perceived savings 2074 for buying actor resulted from accepting the dynamic offer over the buying actor baseline,
Potential gain 2080 for selling actor 0102 acting as channeling actor and for 3^{rd} party selling actor on behalf of which the dynamic offer is generated.

In further detail, still referring to the invention of FIG. 20, for the purpose of understanding how the selling actor 0102 may generate a price for a dynamic offer the following definitions will be used:

In further detail, still referring to the invention of FIG. 20, Buyer Baseline Price, BBP 2012, is defined as the price of a product or service that a buying actor is considering buying in the proximity of the buying actor location. For example when a buying actor is considering to buy an ABCTV bundled with MOVIEOFLIX subscription, BBP 2012 is the price of the ABCTV bundled with MOVIEOFLIX subscription. In our example this price may be 299 $

In further detail, still referring to the invention of FIG. 20, Buyer Estimated Perceived Baseline Price, BEPBP 2010, is defined as BBP 2012 adjusted for key differentiating factors associated with the product or service. For example BEPBP 2010 may be 291 $ and would account for adjustments associated with the estimated buying actor perceived value of the MOVIEOFLIX bundle associated with the TV set that the buying actor is considering buying.

In further detail, still referring to the invention of FIG. 20, Seller Baseline Price, SBP 2004, is defined as the minimum price of product or service, including its key differentiating factors, that the 3^{rd} party selling actor on behalf of whom the dynamic offer is generated may offer through the selling actor 0102 computer implemented system. For example SBP 2004 may be 260 $ if the 3^{rd} party selling actor may be able to provide a dynamic offer comprising a ABCTV with extra warranty, at a minimum price of 260 $.

In further detail, still referring to the invention of FIG. 20, the selling actor 0102 computer implemented system calculates a Buyer Estimated Perceived Price, BEPP 2002, by adjusting SBP 2004 for key differentiating factors and calculating analytics. For example BEPP 2002 may be 250 $ if a SBP 2004 is 260 $ for a dynamic offer comprising ABCTV with extra warranty and the extra warranty may have an estimated perceived buying actor value of 10 $.

In further detail, still referring to the invention of FIG. 20, examples of key differentiating factors may include: buying actor location, distance between buying actor location and selling actors' physical store location, bundles, warranties, coupons, differences in service or product properties such as color or size

In further detail, still referring to the invention of FIG. 20, examples of analytics used to calculate BEPP 2002 may include: historical information and analytics regarding buying actor likelihood to buy at a given price, historical information and analytics regarding buying actor, historical information and analytics regarding the product, historical information and analytics regarding competition, historical information and analytics regarding buying actor location

In further detail, still referring to the invention of FIG. 20, the selling actor 0102 computer implemented system may have the ability to use 2098 an offer specific, likelihood function 2000, that correlates the price of products or services associated with the dynamic offer, with an estimated chance that a buying actor will accept the offer.

In further detail, still referring to the invention of FIG. 20, the likelihood function 2000 may be used to find an Optimized Price For the Dynamic Offer, OPFDO 2008, that may have the goal to optimize different dimensions such as, but not restricted to: volume of sales, inventory, profit targets of the selling actor, profit targets of the channeling actor, buying actor loyalty or satisfaction

In further detail, still referring to the invention of FIG. 20, the optimization algorithms may have the ability to take into account factors, each associated with its own weight, such as, but not restricted to:
Marketing strategies
Policies set by selling actors, to optimize volume, profit, inventory metrics
Policies set by channeling actors, to optimize volume, profit, buying actor loyalty
Key differentiating factors and buying actor estimated probability of being influenced by them
Location of buying actor, time of day, time of year

In further detail, still referring to the invention of FIG. 20, for example, in the case of the dynamic offer comprising ABCTV with extra warranty the OPFDO 2008 might be 280 $.

In further detail, still referring to the invention of FIG. 20, the selling actor 0102 computer implemented system may have the ability to modify the dynamic offer by adjusting key differentiating factors and price before presenting the dynamic offer to a buying actor. The resulting price of this operation is the Dynamic Offer Price, DOP 2006. For example the DOP 2006 might be 275 $ for the dynamic offer comprising ABCTV with extra warranty after an adjustment 2070 of 5 $ based on a marketing a campaign targeting loyal buying actors.

In further detail, still referring to the invention of FIG. 20, the selling actor 0102 computer implemented system may have the ability to adjust 2070 the price for the products or services associated with the dynamic offer. For example, the price could be lowered by using resources associated with a marketing budget or by using selling incentives. The selling actor 0102 computer implemented system may have the ability to generate bundles associated with the dynamic offer, or to improve the dynamic offer with key differentiating factors that enhance the loyalty of buying actor towards the selling actor 0102, or increase the likelihood of purchase.

In further detail, still referring to the invention of FIG. 20, the selling actor 0102 computer implemented system may have the ability to generate multiple dynamic offers, as a result of interaction with multiple 3^{rd} party selling actors computer implemented systems. The 3^{rd} party selling actors interacting with the selling actor 0102 are not restricted to have physical stores.

In further detail, still referring to the invention of FIG. 20, the selling actor computer 0102 implemented system may have the ability to filter, sort and rank the dynamic offers set considering factors such as likelihood to buy, key differentiating factors, interests of selling actor 0102 or of 3^{rd} party selling actors connected to the selling actor, such as, but not restricted to, optimizing profit, volume, marketing strategies, or loyalty base rewarding.

In further detail, still referring to the invention of FIG. 20, the selling actor 0102 computer implemented system may have the ability to tune its internal algorithms for deciding optimal price by taking into account factors such as, but not restricted to, buying actor behavior, the time frame in which the dynamic offer is accepted or rejected, which offer was selected from the set of dynamic offers. The selling actor 0102 may use this information to tune its internal algorithms.

Still referring to the invention of FIG. 20, the selling actor 0102 may use any pricing mechanisms for pricing products and services associated with a dynamic offer, including pricing mechanisms that may allow for manual or automatic process of associating pricing information with dynamic offers. Such pricing mechanisms may be based on factors such as the inventory, quantity purchased, promotions, sales and marketing campaigns, sales quotes, product or service included in the dynamic offers, the presence or quality of key differentiating factors, geographic area, proximity to competitors, administrative considerations (such as sales tax at a particular location), proximity to landmarks, proximity to landforms, time of day, time of year, shipment, capacity to sell, estimated value of dynamic offer, pricing objectives, profit maximization, demand, rate of return, competitor indexing, historical and analytical information regarding pricing for similar products, historical and analytical information regarding pricing in the proximity of buying actor, historical and analytical information regarding the buying actor, quantity discounts, competitor pricing, price skimming, penetration pricing strategies, psychological pricing factors, the image that pricing may convey, attributes of the products and service that are part of the dynamic offer, estimated price sensitivity, elasticity, existence of price points associated with the products or services part of the dynamic offer, production costs, non-price costs associated with purchasing the products or services included in the dynamic offer, types of payment accepted, financial goals for the selling actor 0102, financial goals for 3^{rd} party selling actors for which the selling actor 0102 acts as a channeling actor, product positioning, potential for future new sales or up-sales, multidimensional pricing considerations such as monthly payments, buying actor loyalty.

### XXII. Exemplary Subsystems

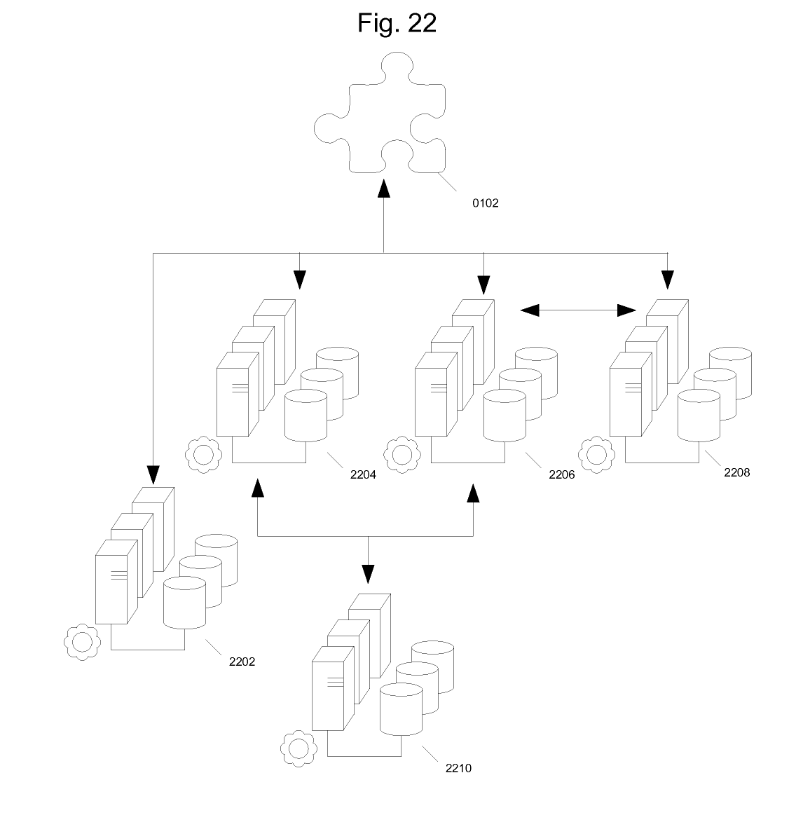

Referring now to the invention of FIG. 22 in more detail, the exemplary selling actor 0102 computer system, for the purpose of generating dynamic offers and selling products and services, may interact directly or indirectly with any number of suitable internal or external subsystems 2202 2204 2206 2208 2210 such as cloud services, web services, functions, methods, procedures, services, servers, databases, entities, program components.

Examples of subsystems used by the selling actor 0102, may be subsystems for:
configuring 0250 the selling actor 0102,
using the configuration, for calculating analytics,
generating dynamic offers,
using results of analytics in generating or modifying dynamic offers,
modifying dynamic offers key differentiating factors,
calculating a ranking score,
filtering or ordering the dynamic offers,
performing resolution services such as location resolution or IP resolution,
delegating to 3^{rd} party selling actors parts of the process of generating dynamic offers,
accessing databases and persistent storage,
accessing inventory systems,
validating buying actor information with external entities such as financial institutions,
logging, for auditing,
generating reports,
auto-tuning the system,
accessing incentives associated with codes, promotional keys.

In further detail, still referring to the invention of FIG. 22, each of this subsystems may be optional, each of this subsystems may use other systems in various suitable loops or recursive patterns.

In further detail, still referring to the invention of FIG. 22, as an example, a subsystem 2202, such as a DBMS or a web service, may be able to provide to the selling actor 0102 information about a product or service. The selling actor 0102 computer implemented system may have the ability to automatically interact with the subsystem 2202, by providing as input to the subsystem 2202 information for a product or service, and obtaining as output from the subsystem 2202 more detailed information associated with the product or service, including related products or services, attributes, historical information, pricing strategies associated with the product, reviews. The selling actor 0102 may have the ability to use the subsystem 2202 to determine for an input product or service a set of related products or services, and subsequently generate dynamic offers for related products and services.

In further detail, still referring to the invention of FIG. 22, as an example, a subsystem 2204 may provide to the selling actor 0102 the ability to determine for an input location the set of available selling actors that may provide dynamic offers in the proximity of that location. For example the subsystem 2204 may provide an ability to determine the set of physical stores in the proximity of a location, or the ability to determine the set of products available on a physical shop isle in the proximity of a location, or the ability to determine products and services that may be sold in the proximity of landmarks and landforms. Exemplary implementations of subsystem 2204 may include a Geographic Information System (GIS) known in the art, a DBMS, a location database system, a web service, a map server, a catalog server, a GIS library, a map cache, use the buying actor 0100 device for HTML5 location support, a rule engine for detecting spacial conditions, or a mathematical function coupled with preconfigured information about physical stores.

Still referring to the invention of FIG. 22, the selling actor 0102 may have the ability to reuse the entire set or any subset of the subsystems 2202 2204 2206 2208 2210 across the processes involving generating different types of dynamic offers, such as direct dynamic offer, direct notification dynamic offer, indirect dynamic offer, indirect notification dynamic offer, inferred dynamic offer, as well as across the processes involving acquiring proximity acquired information from mobile device holders and providing incentives to mobile device holders.

### XXIII. Exemplary Distributed Selling Topology

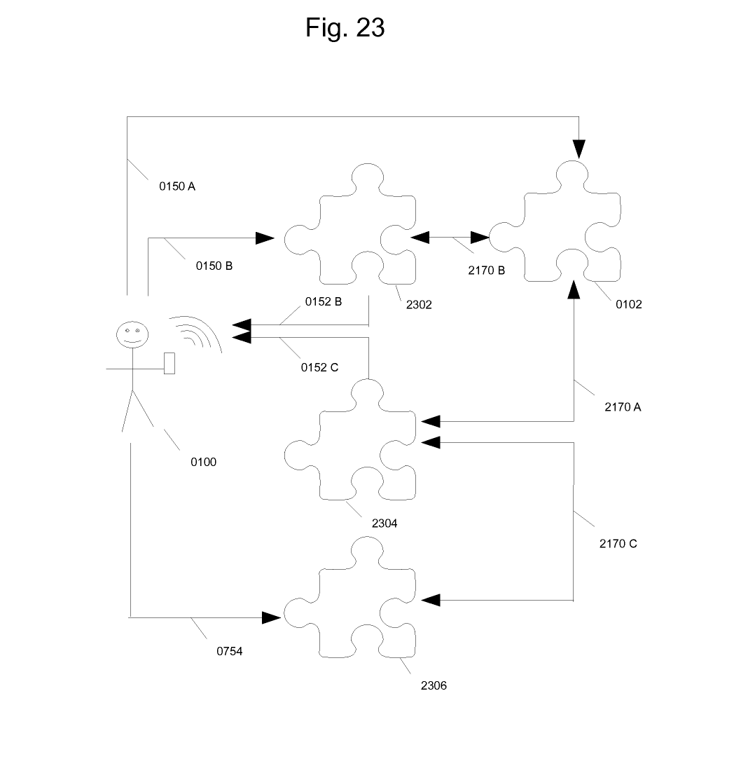

Referring now to the invention of FIG. 23 in more detail, there is shown a view describing an exemplary topology of present invention in where the buying actor 0100 may interface with one or more selling actors 0102 2302 2304 2306. The buying actor 0100 may transmit 0150A information to the selling actor 0102 and also it may transmit 0150B information to another 3^{rd} party actor 2302. The selling actor 0102 and the 3^{rd} party selling actor 2302 may interface 2170B directly or indirectly and may share information that buying actor 0100 transmitted 0150A 0150B. The buying actor 0100 may receive 0152B dynamic offers generated by the selling actor 2302 on its own behalf or on behalf of any other selling actor 0102 2304 2306 that interfaces 2170B 2170A 2170C directly or indirectly with the selling actor 2302. The selling actor 0102 may interface 2170A directly or indirectly with a 3^{rd} party selling actor 2304. The 3^{rd} party selling actor 2304 may also interface 2170C directly or indirectly with another 3^{rd} party selling actor 2306. The 3^{rd} party selling actor 2304 may generate a dynamic offer on behalf of the other 3^{rd} party selling actor 2306 that may use as input information transmitted 0150A by the buying actor 0100 to the selling actor 0102. The buying actor 0100 may receive 0152C a set of dynamic offers from the 3^{rd} party selling actor 2304, zero or more of the received 0152C dynamic offers being generated on behalf of the selling actor 2304, zero or more of the dynamic offers received 0152C being generated on behalf of the other 3^{rd} party selling actor 2306, zero or more of the received 0152C dynamic offers being generated on behalf of the selling actor 0102, zero or more of the received 0152C dynamic offers being generated on behalf of the selling actor 2302. Different parts of the dynamic offers may be generated by any selling actor such as 0102 2302 2304 or 2306 and may use as input any subset of the information transmitted 0150A by the buying actor 0100 to the selling actor 0102 and the information transmitted 0150B by the buying actor 0100 to the selling actor 2302. The information transmitted 0150B to by the buying actor 0100 the selling actor 2302 may be available to any subset of the selling actors 0102 2302 2304 2306 that are directly or indirectly interfacing 2170B 2170A 2170C with the selling actor 2302 and may be used by the process of generating dynamic offers by any of the selling actors 0102 2302 2304 2306. The buying actor 0100 may complete online 0754 a transaction associated with a dynamic offer, by contacting directly the other 3^{rd} party selling actor 2306 on behalf of which the 3^{rd} party selling actor 2304 generated the dynamic offer.

In more detail, referring to the invention of FIG. 23, a selling actor 0102 2302 2304 2306 may interface 2170A 2170B 2170C with zero or more other 3^{rd} party selling actors directly and indirectly and may have the ability to delegate any part of the process of generating dynamic offers and selling products and services, including the communication with the buying actor 0100, such us, but not restricted to, communication for the purpose of: acquiring information transmitted 0150A 0150B by the buying actor 0100, sending dynamic offers that buying actor 0100 receives 0152B 0152C, and completing online 0754 transactions. Any selling actor such as 0102 2302 2304 2306 may receive information transmitted 0150A 0150B by the buying actor 0100 and the buying actor 0100 may receive 0152B 0152C a set of zero or more dynamic offers from any selling actor 0102 2302 2304 2306.

In further detail, referring to the invention of FIG. 23, the interfacing 2170A 2170B 2170C between selling actors 0102 2302 2304 2306 may allow information to be exchanged directly or indirectly between selling actors, for example information regarding the buying actor 0100, the aspects of the information transmitted 0150A 0150B, information regarding current state of the process to generate dynamic offers and sell products and services in response to the information transmitted 0150A or the information transmitted 0150B by the buying actor 0100, as well as information regarding the way the selling actors 0102 2302 2304 2306 may establish communication with the buying actor 0100, such as an identifier for the buying actor 0100, the buying actor 0100 network address, an unique identifier for the instance of the process to generate dynamic offers and sell products services. In different embodiments the information that would allow multiple selling actors 0102 2302 2304 2306 to communicate directly or indirectly with the buying actor 0100 may be shared between the selling actors through an intermediate entity such as a subsystem providing session information associated with the instance of the process of generating dynamic offers and sell products and services.

In further detail, still referring to the invention of FIG. 23, the exemplary topology in which multiple selling actors 0102 2302 2304 2306 communicate with a buying actor 0100 may be used for any type of dynamic offers, including direct dynamic offers, direct notification dynamic offers, indirect dynamic offers, indirect notification dynamic offers, inferred dynamic offers. In addition the buying actor 0100 may communicate with multiple selling actors 0102 2302 2304 2306 for other parts of the process of generating dynamic offers and selling products and services, and is not limited to the communication depicted in FIG. 23. For example: the buying actor 0100 may ask one of the selling actors 0102 2302 2304 2306 for additional information regarding products and services, or the buying actor 0100 may acquire one or more tokens from the 3^{rd} party selling actor 2306, and use the tokens to certify to the selling actor 0102 and to the 3^{rd} party selling actor 2304 that a transaction between the buying actor 0100 and the 3^{rd} party selling actor 2306 was completed online or offline.

The group of selling actors 0102 2302 2304 2306 may be a selling actor itself, and the buying actor may perceive the group as one selling actor.

### XXIV. Ending Statements

The advantages of the present invention include, without limitations, advantages associated with selling actors, buying actors, mobile device holders, e-commerce industry and consumers.

Using this invention, the selling actors will have advantages that include, without limitation:
the selling actors may have access to a broad market segment represented by mobile device holders;
the selling actors may become much more responsive to market opportunities by acquiring information about products and services price, buying actors interest and behavior;
the selling actors will have a great opportunity to sell their products and services to buying actors even when those buying actors will be physically present in a shop run by their competition;
the selling actors will have the ability to dynamically adjust their pricing and the products and services that they offer subject to competition pricing, buying actor location, buying actor segments, time;
the selling actors will have the ability to configure and optimize the interaction with buying actors maximizing their revenue, profit, volume of sales.

Using this invention, the buying actors will have advantages that include, without limitation:
the buying actors may receive a better price for products and services they are interested in from selling actors;
the buying actors may receive additional products or services based on key differentiating factors that may be important for the buying actors, therefore having access to much broader options;
the buying actors may enjoy the experience to learn about a variety of products and services in their proximity and may enjoy the ability to buy them without having to travel.

Using this invention, the mobile device holders acquiring information with their mobile device about products and services present on their location will have advantages that include, without limitation:
the mobile device holders may receive incentives from selling actors;
the mobile device holders could capitalize on this financial incentives and integrate this behavior with their shopping experience.

Using this invention, the consumers in general will benefit from this invention by having advantages that include, without limitation:
consumers will have the ability to use their mobile devices to buy products and services at a better price
consumers will have the ability to or find out and to purchase products or services more suitable for their needs that are available in their proximity offered by a variety of selling actors;
the industry landscape will change and become more competitive.

This invention will help, without limitation, selling actors to:
optimize dimensions of their business such as volume of sales, profit and revenue targets,
acquire information from buying actors and mobile device holders and become much more agile and responsive to selling opportunities, expanding further their business in the mobile landscape,
sell products and services even in or near the proximity of their competition offering them unparalleled advantages.

It is to be noted that, without limitation, all parties involved in this process will experience benefits, therefore we believe this invention will have a rapid adoption that could transform the e-commerce landscape.

In broad embodiment, the present invention is a method for a group of one or more servers, having suitable means, to acquire proximity acquired information from a multitude of devices connected to a communication network and to return dynamic offers wherein a dynamic offer comprises one or more price related attributes.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be constructed as preferred or advantageous over other aspects or designs, not is it meant to preclude equivalent exemplary structures and techniques known to those of ordinary skill in the art. Furthermore, to the extent that the terms “includes”, “has”, “contains” and other similar words are used in either detailed description or the claims, for the avoidance of doubt, such terms are intended to be inclusive in a manner similar to the term “comprising” as an open transition word without precluding any additional or other elements.

As mentioned, the various techniques described herein may be implemented in connection with hardware or software or, when appropriate, with a combination of both. As used herein, the terms “component”, “system” and the like are likewise intended to refer to a computer related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a computer and the computer can be a component. One or more components may reside within a process or thread of execution and a component may be localized on one computer and/or distributed between two or more computers.

The aforementioned systems have been described with respect to interaction between several components It can be appreciated that such systems and components can include those components or specified sub-components, some of the specified component or sub-components, and/or additional components, and according to various permutations and combinations of the foregoing. Sub-components can also be implemented as components communicatively coupled to other components rather then included within parent components (hierarchical). Additionally it should be noted that one or more components may be combined into a single component providing aggregate functionality or divided into several separate sub-components, and that any one or more middle layers, such as management layer, may be provided to communicatively couple such sub-components in order to provide integrated functionality. Any components described herein may also interact with one or more other components not specifically described herein but generally known by those of skill in the art.

In view of the exemplary systems described supra, methodologies that may be implemented in accordance with the described subject matter will be better appreciated with reference to the flowcharts of the various figures. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Where non-sequential or branched, flow is illustrated via a flowchart, it can be appreciated that various other branches, flow paths, and orders of the blocks, may be implemented which achieve the same or a similar result. Moreover, not all illustrated blocks may be required to implement the methodologies described herein-after.

In addition to the various embodiments described herein, it is to be understood that other similar embodiments can be used or modifications and additions can be made to the described embodiment(s) for performing the same or equivalent function of the corresponding embodiment(s) without deviating therefrom. Still further, multiple processing chips or multiple devices can share the performance of one or more functions described herein, and similarly, storage can be effected across a plurality of devices. Accordingly, the invention should not be limited to any single embodiment, but rather should be construed in breath, spirit and scope in accordance with the appended claims.

While the foregoing written description of the present invention enables one of ordinary skill to make and use what is considered presently to be the best mode thereof, those of ordinary skill will understand and appreciate the existence of variations, combinations, and equivalents of the specific embodiments, methods, and examples herein. The invention should therefore not be limited by the above described embodiments, methods, and examples, but by all embodiments and methods within the scope and spirit of the invention.

1. A method of selling products or services comprising:
(a) a buying actor transmitting to a selling actor a set of data, wherein the set of data comprises of one or more parameters related to products or services, one or more parameters related to location;
(b) the selling actor inferring the prices for products or services;
(c) the buying actor receiving from the selling actor a set of one or more dynamic offers, wherein a dynamic offer comprise a set of data, wherein the set of data comprises one or more parameters related to price.

2. The method of claim 1, further comprising: configuring the selling actor; the selling actor using the configuration to generate the dynamic offers.

3. The method of claim 1, wherein the received dynamic offers comprise a set of data wherein the set of data comprises one or more parameters related to the products or services specified in the input parameters.

4. The method of claim 1, wherein the received dynamic offers comprise a set of data wherein the set of data comprises one or more parameters related to products or services related to the products or services specified in the input parameters.

5. The method of claim 1, further comprising: the selling actor modifying the dynamic offers key differentiation factors.

6. The method of claim 15, wherein modifying the dynamic offers optimizes dimensions of selling actor interests.

7. The method of claim 1, further comprising: presenting the dynamic offers on the buying actor device.

8. The method of claim 7, wherein presenting the dynamic offers on the buying actor device comprises highlighting key differentiating factors.

9. The method of claim 1, further comprising: the buying actor using a mobile device to complete a transaction associated with the dynamic offers after receiving the dynamic offers.

10. The method of claim 1, further comprising: the selling actor modifying prices associated with the dynamic offers.

11. The method of claim 1, further comprising: the selling actor calculating a ranking score for the dynamic offers; the selling actor using the ranking score to modify the dynamic offers.

12. The method of claim 1, further comprising: the selling actor calculating analytics using input parameters comprising any subset of data of the set of data transmitted by the buying actor; the selling actor using the analytics to generate the dynamic offers.

13. The method of claim 1, further comprising the selling actor calculating analytics using as input parameters the responses of the buying actors for the dynamic offers; the selling actor using the analytics to generate the dynamic offers.

14. The method of claim 1, further comprising the selling actor acquiring information about buying actors.

15. The method of claim 14, further comprising the selling actor providing incentives to the buying actor to transmit acquired information.

16. The method of claim 1, further comprising the selling actor associating dynamic offers with a personalized token.

17. The method of claim 16, further comprising the buying actor using the personalized token to purchase the products or services associated with the dynamic offers in a specified time frame.

18. The method of claim 17, further comprising the buying actor using information associated with the personalized token to certify that a transaction for a dynamic offer was completed offline.

19. The method of claim 17, further comprising the buying actor receiving incentives for certifying to the selling actor that a transaction associated with a dynamic offer was completed offline.

20. The method of claim 1, wherein the selling actor is a composed entity, comprising one or more selling actors.
